(19) United States
(12) Patent Application Publication
(10) Pub. No.: US 2011/0123756 A1
(43) Pub. Date: May 26, 2011

(54) INFORMATION RECORDING MEDIUM

(75) Inventors: Rie Kojima, Osaka (JP); Takashi Nishihara, Osaka (JP); Akio Tsuchino, Osaka (JP); Noboru Yamada, Osaka (JP)

(73) Assignee: PANASONIC CORPORATION, Kadoma-shi, Osaka (JP)

(21) Appl. No.: 13/054,551

(22) PCT Filed: Feb. 22, 2010
(86) PCT No.: PCT/JP2010/001147

§ 371 Date: Jan. 17, 2011

(30) Foreign Application Priority Data
Feb. 23, 2009 (JP) 2009-038882

(51) Int. Cl. B32B 3/02

(52) U.S. Cl. 428/64.5; 428/64.4

(57) ABSTRACT

An information recording medium (300) of the present invention is an information recording medium on or from which information can be recorded or reproduced by irradiation with an optical beam (10), and includes a dielectric layer b, a recording layer (335), and a dielectric layer a in this order from an optical beam (10) incident side. The dielectric layer a and the dielectric layer b are layers disposed in contact with the recording layer (335), and an interface layer (334) corresponds to the dielectric layer a and an interface layer (336) corresponds to the dielectric layer b. The dielectric layer a contains Cr, O, and at least one element M selected from Al, Dy, Nb, Si, Ti and Y. The dielectric layer b contains Cr, O, and at least one element A selected from Zr and Hf.

### TECHNICAL FIELD

The present invention relates to an information recording medium with respect to which information can be optically recorded, erased, rewritten, and/or reproduced.

### BACKGROUND ART

An example of the basic structure of an optical information recording medium is such that a second dielectric layer, a recording layer, a first dielectric layer, and a reflective layer are disposed in this order from the optical beam incident side. Conventionally, (ZnS)₈₀(SiO₂)₂₀ (mol %), for example, has been used as a material for the first and second dielectric layers. This material is an amorphous material, and has a low thermal conductivity, a high transparency, and a high refractive index. In addition, this material can be deposited at a high rate to form a film thereof, and has excellent mechanical properties and moisture resistance. Therefore, this material has been used as a material suitable for forming dielectric layers in practical applications.

However, if this material is used for dielectric layers of a rewritable information recording medium, when a recording layer is irradiated with a laser beam to perform repeated rewriting, S in (ZnS)₈₀(SiO₂)₂₀ (mol %) diffuses in the recording layer and thus the repeated rewriting performance is degraded significantly. In order to overcome this problem, there has been adopted a structure in which dielectric layers (interface layers) each with a thickness of about 5 nm are provided additionally between the first dielectric layer and the recording layer and between the recording layer and the second dielectric layer (see, for example, Patent Literature 1).

For example, in Blu-ray Disc (hereinafter abbreviated as BD) media that have been developed for practical use as recording media for high definition video images, a material containing ZrO₂—Cr₂O₂ (hereinafter referred to as Zr—Cr—O) is used for interface layers to achieve 10,000 or more repeated rewritings (see, for example, Patent Literature 2). Since this material is free from S, and has excellent heat resistance because of its high melting point, and has good adhesion to the recording layer, it is a material suitable for interface layers. In a BD medium including a plurality of information layers, which are referred to as L0, L1, . . . sequentially from the side opposite to the optical beam incident side, particularly in a dual layer BD medium with a capacity of 50 gigabytes (GB), a translucent information layer (L1) located on the optical beam incident side has a layered structure of very thin recording layer with a thickness of about 6 nm and reflective layer with a thickness of about 10 nm. In this BD medium, interface layers formed of Zr—Cr—O are added to achieve the performance of 10,000 cycles.

### CITATION LIST

### Patent Literature

Patent Literature 1 JP 3707797 B2

Patent Literature 2 JP 3961411 B2

### SUMMARY OF INVENTION

### Technical Problem

Since the BD became the industry standard for the next-generation DVD (Digital Versatile Disc) a few years ago, BD recorders with large capacity hard disks and large screen televisions with BD recorders have been marketed, and such BD recorders and BD media have been spreading at an accelerated rate. Under these circumstances, the next challenge is to increase the storage capacity of BD media. BD media with increased capacity can extend the recording time of high definition video images, or can be used as removable media as substitutes for hard disks.

There are two approaches to increase the storage capacity. One is to increase the recording capacity per information layer, and another is to increase the number of layers (information layers). If these two approaches are used in combination, the storage capacity can be increased further. With the combined use of these two approaches, the present inventors have devoted themselves to the development of BID media with a capacity of 100 GB. Specifically, they have developed a three-layer structure in which each information layer has a capacity of 33.4 GB (conventionally 25 GB). The increase in the recording capacity from 25 GB to 33.4 GB means an increase in the recording density by 1.34 times, resulting in smaller recording marks. Accordingly, the technical challenge is to increase the signal amplitude of such small recording marks to the conventional level or higher. In order to increase the signal amplitude, it is effective to increase the reflectance ratio Rc/Ra between the amorphous phase (marks) and the crystalline phase (spaces between marks) of the recording layer (where Rc is the specular reflectance of a BD medium in which a recording layer is in the crystalline phase, and Ra is the specular reflectance of the BD medium in which the recording layer is in the amorphous phase).

In order to increase the number of information layers from two to three, the optical transmittance of the information layer (L2) located closest to the optical beam incident side in a three-layer structure must be higher than that in the case of a two-layer structure. In the case of the two-layer structure, the transmittance of the information layer L1 is optically designed to be 50%. In the case of the three-layer structure, it is preferable that the transmittances of the information layers L2 and L1 be optically designed to be at least 56% and at least 50% respectively (where the information layers are referred to as L2, L1, and L0 from the optical beam incident side). In L2, the recording layer and the reflective layer, which absorb an optical beam, must be thinner than those of L1 in the two-layer structure. This reduction in the thickness is, however, a cause of decreasing Rc/Ra, and the transmittance and Rc/Ra are in a trade-off relationship. Since L1 in the three-layer structure must ensure a transmittance of at least 50% and obtain good signal quality using the optical beam that has passed through L2, it is required to have a higher Rc than L2. Due to design limitations, Ra tends to increase as Rc increases, and as a result. Rc/Ra of L1 also tends to decrease as in the case of L2. Therefore, in order to increase the storage capacity, it is required to obtain an information layer that allows both a high transmittance and a high reflectance ratio to be obtained. In other words, it is required to develop a layer structure that allows such an information layer to be obtained. Specifically, it is required to develop a dielectric material used for a layer to be disposed in contact with the recording layer.

Furthermore, the information layer is required to have not only the above-mentioned optical properties but also good repeated rewriting performance, etc. Therefore, the layer to be disposed in contact with the recording layer also is required to have good adhesion to the recording layer.

The present invention has been made to solve the above-mentioned conventional problems. It is an object of the present invention to provide an information layer that allows a high transmittance and a high reflectance ratio to be obtained and further allows good repeated rewriting performance to be obtained, and thereby to provide an information recording medium whose capacity can be increased.

### Solution to Problem

The information recording medium of the present invention is an information recording medium on or from which information can be recorded or reproduced by irradiation with an optical beam, and includes a dielectric layer b, a recording layer, and a dielectric layer a in this order from an optical beam incident side. In this information recording medium, the dielectric layer a contains Cr, O, and at least one element M selected from Al, Dy, Nb, Si, Ti, and Y, the dielectric layer b contains Cr, O, and at least one element A selected from Zr and Hf, and the dielectric layer a and the dielectric layer b are disposed in contact with the recording layer.

### ADVANTAGEOUS EFFECTS OF INVENTION

According to the information recording medium of the present invention, a multi-layer rewritable recording medium, for example, with a capacity of 33.4 GB or more per information layer, can be obtained. Thereby, an information recording medium with a large capacity of 100 GB or more can be obtained.

### BRIEF DESCRIPTION OF DRAWINGS

FIG. 1 is a partial sectional view showing an example of the information recording medium of the present invention.

FIG. 2 is a partial sectional view showing another example of the information recording medium of the present invention.

FIG. 3 is a partial sectional view showing still another example of the information recording medium of the present invention.

FIG. 4 is a partial sectional view showing yet another example of the information recording medium of the present invention.

### DESCRIPTION OF EMBODIMENTS

The information recording medium of the present invention is the invention that has been made to provide an information layer that allows a high transmittance and a high reflectance ratio to be obtained and further allows good moisture resistance and repeated rewriting performance to be obtained, and thereby to provide an information recording medium whose capacity can be increased.

In order to achieve a high transmittance and a high reflectance ratio among these challenges, the present inventors focused on the information layer (L2) located closest to the optical beam incident side and the information layer ID located in the middle in a three-layer BD medium. For an information layer having a structure in which a second dielectric layer, a second interface layer, a recording layer, a first interface layer, a first dielectric layer, a reflective layer, and a high refractive index layer are disposed in this order from the optical beam incident side, the optical design (i.e., calculations) was (were) carried out. As a result, it was found that if a relatively transparent material was used for the first interface layer, Rc/Ra could be increased further. It was also found that if a material having a relatively lower refractive index than the second interface layer was used for the first interface layer, Rc/Ra could be increased still further.

An information layer L2 (test sample 1), in which Zr—Cr—O was used for the first interface layer and the second interface layer, and an information layer L2 (test sample 2), in which a material having a higher transparency and a lower refractive index than Zr—Cr—O was used for the first interface layer and Zr—Cr—O was used for the second interface layer, were prepared experimentally, and their Rc/Ra values were measured actually. As a result, the test sample 2 had a higher Rc/Rc. The Zr—Cr—O interface layer has an extinction coefficient of about 0.1 for an optical beam with a wavelength of 405 nm. Therefore, it was confirmed experimentally that Rc/Ra could be increased when a dielectric material having a lower extinction coefficient than Zr—Cr—O was used for the first interface layer.

The thermal calculations performed by the present inventors show that when the recording layer is irradiated with a laser beam to perform recording thereon in a translucent information layer like L2 and L1, it is not the recording layer that increases in temperature most significantly, but the temperature of the second interface layer disposed closer to the laser beam incident side than the recording layer increases most significantly (since the area where a recording mark is formed is heated to the melting point or higher and melted during recording, the interface layer is subjected to the highest temperature during recording in a series of recording and erasing operations). Therefore, it seems that the second interface layer is subjected to the highest thermal load during repeated rewriting. In order to ensure excellent repeated rewriting performance, an interface layer that can withstand high thermal load is needed as the second interface layer. The experiments of the present inventors resulted in that the Zr—Cr—O interface layer had the highest heat resistance, as expected. The experiments resulted in that an interface layer composed of HfO₂—Cr₂O₃ (hereinafter referred to as Hf—Cr—O) containing Hf having chemical properties similar to Zr also had good heat resistance.

The Zr—Cr—O interface layer is an interface layer having excellent moisture resistance and repeated rewriting performance. ZrO₂ is a transparent and thermally stable material, and Cr₂O₃ is a material having excellent adhesion to a chalcogen-containing recording layer. However, since Cr₂O₃ has a high extinction coefficient of about 0.2 for the optical beam with a wavelength of 405 nm, it cannot be used alone although its adhesion is excellent. Cr₂O₃ is added to compensate for the poor adhesion of ZrO₂. Therefore, if Cr₂O₃ is merely reduced to increase the transparency, the adhesion is degraded, and thus such a measure cannot be taken. This is also the case with the Hf—Cr—O interface layer. There are very few dielectric materials exhibiting excellent adhesion to the chalcogen-containing recording layer. According to the experiments of the present inventors, examples of such materials include SIC, ZnS, Ge—N, Ga₂O₃, and In₂O₃, in addition to Cr₂O₃. However, SiC has an extinction coefficient of more than 0.3, which is higher than that of Cr₂O₃, for the optical beam with a wavelength of 405 nm. ZnS has a problem in that S diffuses, as described above. Ge—N has a decomposition temperature of about 700° C. and cannot withstand repeated recording with a blue-violet laser beam. Ga₂O₃ and In₂O₃ are transparent and have excellent adhesion, but they are expensive. Therefore, the present inventors have reached a conclusion that Cr₂O₃ is the most preferable material as a material to be used to ensure the adhesion to the recording layer.

As a result of the above studies, the present inventors have arrived at the structure of the information recording medium of the present invention, that is, an information recording medium on or from which information can be recorded or reproduced by irradiation with an optical beam, including a dielectric layer b, a recording layer, and a dielectric layer a in this order from an optical beam incident side, wherein the dielectric layer a contains Cr, O, and at least one element M selected from Al, Dy, Nb, Si, Ti, and Y, the dielectric layer b contains Cr, O, and at least one element A selected from Zr and Hf, and the dielectric layer a and the dielectric layer b are disposed in contact with the recording layer.

In the information recording medium of the present invention, a dielectric material containing Cr, O, and at least one element A selected from Zr and Hf, and having both high heat resistance and excellent adhesion to the recording layer is used for the interface layer (dielectric layer b) located on the optical beam incident side with respect to the recording layer, and a dielectric material containing Cr, O, and at least one element M selected from Al, Dy, Nb, Si, Ti, and Y, and having both high transparency and excellent adhesion to the recording layer is used for the interface layer (dielectric layer a) located on the side opposite to the optical beam incident side with respect to the recording layer. If these dielectric materials are used for the interface layers, a translucent information layer having not only a high reflectance ratio and a high transmittance but also high repeated rewriting performance can be provided. Furthermore, if a multi-layer information recording medium having this translucent information layer is provided, an information recording medium with a capacity of 100 GB or more also can be obtained.

In the information recording medium of the present invention, the dielectric layer a may contain a material represented by M_{c}Cr_{d}O_{100-c-d} (atom %), where subscripts c, d, and 100-c-d denote composition ratios of M, Cr, and O in atom %, respectively, and c and d satisfy 12<c<40, 0<d≦25, and 20<(c+d.)<50. In this case, the element M contained, in the dielectric layer a may be at least one element selected from Al, Si, and Ti. As used in this description, “M_{c}Cr_{d}O_{100-c-d} (atom %)” is a composition formula represented when the sum total of “M” atoms, “Cr” atoms, and “O” atoms are taken as a reference (100 atom %).

In the information recording medium of the present invention, the dielectric layer a may contain a material composed of Cr₂O₃ and at least one oxide D selected from Al₂O₃, Dy₂O₃, Nb₂O₅, SiO₂, TiO₂, and Y₂O₃ and represented by (D)ₕ(Cr₂O₃)₁₀₀₋ₕ (mol %), where subscripts h and 100-h denote composition ratios of D and Cr₂O₃ in mol %, respectively, and h satisfies 50≦h<100. In this case, the oxide D contained in the dielectric layer a may be at least one oxide selected from Al₂O₃, SiO₂, and TiO₂. As used in this description, “(D)ₕ(Cr₂O₃)₁₀₀₋ₕ (mol %)” indicates a mixture of h mol % of the compound D and 100-h mol % of Cr₂O₃. Hereinafter, the same expression is used in the same manner.

In the information recording medium of the present invention, the dielectric layer h may contain a material represented by A_{f}Cr_{g}O_{100-f-g} (atom %), where subscripts f, g, and 100-f-g denote composition ratios of A, Cr, and O in atom %, respectively, and f and g satisfy 4<f<16, 21<g<35, and 30<(f+g)<50, In this case, the dielectric layer b may further contain at least one element X selected from Dy, Nb, Si, Ti, and Y, and the material is represented by AₖCrₘXₙO₁₀₀₋ₖ₋ₘ₋ₙ (atom %), where subscripts k, m, n, and 100-k-m-n denote composition ratios of A, Cr, X, and O in atom %, respectively, and k, m, and n satisfy 1<k<18, 3<in <35, 0<n<31, and 25<(k+m+n)<50. In this case, the element A contained in the dielectric layer b may be Zr. The element X may be at least one element selected from Al, Dy, Si, and Ti.

In the information recording medium of the present invention, the dielectric layer h may contain a material composed of Cr₂O₃ and at least one oxide AO₂ selected from ZrO₂ and HfO₂ and represented by (AO₂)ⱼ(Cr₂O₃)₁₀₀₋ⱼ (mol %), where subscripts j and 100-j denote composition ratios of AO₂ and Cr₂O₃ in mol %, respectively, and j satisfies 20≦j≦60. In this case, the dielectric layer b may further contain at least one oxide L selected from Al₂O₃, Dy₂O₃, Nb₂O₅, SiO₂, TiO₂, and Y₂O₃, and the material is represented by (AO₂)ₚ(Cr₂O₃)ₜ(L)₁₀₀₋ₚ₋ₜ (mol %), where subscripts p, t, and 100-p-t denote composition ratios of AO₂, Cr₂O₃, and L in mol %, respectively, and p and t satisfy 20≦p≦60, 20≦t<80, and 60≦(p+t)<100. In this case, the oxide L contained in the dielectric layer b may be at least one oxide selected from Al₂O₃, Dy₂O₃, SiO₂ and TiO₂.

In the information recording medium of the present invention, a part of Cr contained in the dielectric layer a may be substituted by at least one element selected from Ga and In. In the case where the dielectric layer a contains Cr in the form of Cr₂O₃, a part of Cr₂O₃ contained in the dielectric layer a may be substituted by at least one oxide selected from Ga₂O₃ and In₂O₃.

A part of Cr contained in the dielectric layer b may be substituted by at least one element selected from Ga and In. In the case where the dielectric layer b contains Cr in the form of Cr₂O₃, a part of Cr₂O₃ contained in the dielectric layer b may be substituted by at least one oxide selected from Ga₂O₃ and In₂O₃.

Preferably, the information recording medium of the present invention satisfies na<nb, when a refractive index of the dielectric layer a and a refractive index of the dielectric layer b are denoted as na and nb respectively.

The information recording medium of the present invention may include N information layers, where N is an integer of 2 or more. In this information recording medium, when the N information layers are referred to as a first information layer to an N-th information layer sequentially from a side opposite to the optical beam incident side, an L-th information layer (where L is at least one integer that satisfies 1≦L≦N) included in the N information layers includes the dielectric layer b, the recording layer, and the dielectric layer a in this order from the optical beam incident side. The N may be 3.

In the information recording medium of the present invention, the recording layer may be formed of a material that undergoes a phase change by irradiation with the optical beam. In this case, the recording layer may contain Ge—Te, and contain 40 atom % or more of Ge. The recording layer may contain at least one material selected from Sb—Ge and Sb—Te, and may contain 70 atom % or more of Sb.

Hereinafter, embodiments of the present invention will be described with reference to the accompanying drawings. The following embodiments are merely examples, and the present invention is not limited to the following embodiments. In the following embodiments, the same parts are designated with the same reference numerals and overlapping descriptions may be omitted.

### First Embodiment

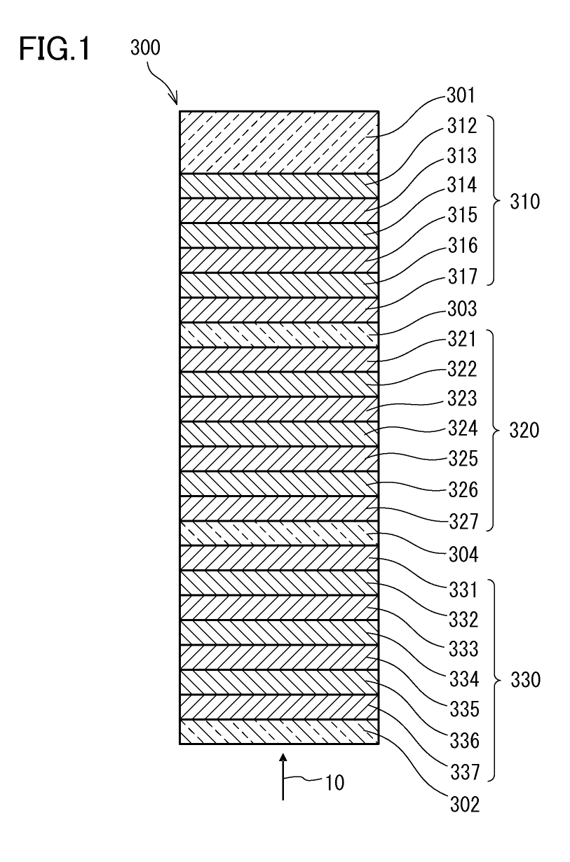

As the first embodiment of the present invention, an example of the information recording medium will be described. FIG. 1 shows a partial sectional view of the information recording medium 300. In the information recording medium 300, a first information layer 310, an interlayer 303, a second information layer 320, an interlayer 304, a third information layer 330, and a transparent layer 302 are disposed in this order on a substrate 301. That is, the information recording medium 300 according to the present embodiment is an information recording medium including N (where N is an integer of 2 or more) information layers, and N is 3 in this case. In the present embodiment, since the dielectric layer a and the dielectric layer b of the present invention are used in all of the first to third information layers 310 to 330, all of these information layers correspond to the L-th information layer of the information recording medium of the present invention. But the present invention is not limited to this case, and at least one of the first to third information layers 310 to 330 may correspond to the L-th information layer.

The first information layer 310 is formed by disposing a reflective layer 312, a dielectric layer 313, an interface layer 314, a recording layer 315, an interface layer 316, and a dielectric layer 317 in this order on one surface of the substrate 301. The second information layer 320 is formed by disposing a dielectric layer 321, a reflective layer 322, a dielectric layer 323, an interface layer 324, a recording layer 325, an interface layer 326, and a dielectric layer 327 in this order on one surface of the interlayer 303. The third information layer 330 is formed by disposing a dielectric layer 331, a reflective layer 332, a dielectric layer 333, an interface layer 334, a recording layer 335, an interface layer 336, and a dielectric layer 337 in this order on one surface of the interlayer 304.

In the information recording medium 300, information is recorded and reproduced by a laser beam 10 with a wavelength of about 405 nm in the blue-violet region. The laser beam 10 is allowed to be incident from the transparent layer 302 side. Information is recorded and reproduced on and from the first information layer 310 by the laser beam 10 that has passed through the third information layer 330 and the second information layer 320. Information is recorded and reproduced on and from the second information layer 320 by the laser beam 10 that has passed through the third information layer 330. Thus, in the information recording medium 300, information can be recorded and reproduced on and from these three information layers. Therefore, an information recording medium with a capacity of 100 GB can be obtained using these information layers, each with a capacity of 33.4 GB, for example.

Optically, it is preferable that these three information layers each have approximately the same effective reflectance. This is achieved by adjusting the reflectance of each of the first, second and third information layers and the transmittance of each of the second and third information layers. As an example, this embodiment describes a structure that is designed so as to satisfy an effective Rc of 2.2% and an effective Ra of 0.3%. In this description, the effective reflectance is defined as the reflectance of each information layer that is measured when the three information layers are stacked. Without the word “effective”, the reflectance means the reflectance of each unstacked information layer, unless otherwise specified. Rc denotes the specular reflectance of the information layer when the recording layer is in the crystalline phase, and Ra denotes the specular reflectance of the information layer when the recording layer is in the amorphous phase. As stated herein, if the reflectance of the groove of the information layer when the recording layer is in the crystalline phase is denoted as Rc-g, the effective Rc-g is, for example, 1.8%.

As an example, in the case where the average transmittance ((Tc+Ta)/2) of the third information layer 330 is 56% and the average transmittance ((Tc+Ta)/2) of the second information layer 320 is 50%, the first information layer 310 can be designed to have an Rc of 28% and an Ra of 4%, the second information layer 320 can be designed to have an Rc of 7% and an Ra of 1%, and the third information layer 330 can be designed to have an Rc of 2.2% and an Ra of 0.3%. As stated herein, Tc denotes the transmittance of the information layer when the recording layer is in the crystalline phase, and Ta denotes the transmittance of the information layer when the recording layer is in the amorphous phase. When (Tc+Ta)/2 is 56%, the Tc and Ta may be, as an example, 55% and 57% respectively, or 56% and 57% respectively. The Tc and Ta preferably are approximate values, but they do not have to be equal to each other. Hereinafter, the transmittance of the information layer means the average transmittance ((Tc+Ta)/2), unless specified as Tc or Ta.

Hereinafter, the function, material, and thickness of each of the substrate 301, the interlayer 303, the interlayer 304, and the transparent layer 302 are described.

The substrate 301 functions mainly as a support body. A disc-shaped transparent substrate with a smooth surface is used for the substrate 301. Examples of the material for the substrate 301 include resins, such as polycarbonate, amorphous polyolefin, and polymethylmethacrylate (PMMA), and glass. Taking formability, price, and mechanical strength into consideration, polycarbonate is used preferably. In the illustrated embodiment, the substrate 301 with a thickness of about 1.1 mm and a diameter of about 120 mm is used preferably.

Guide grooves (projections and depressions) for guiding the laser beam 10 may be formed on the surface of the substrate 301 on which the information layer 310 is to be formed. In this description, when the guide grooves are formed on the substrate 301, the surface of the guide groove closer to the laser beam 10 incident side is referred to as a “groove surface”, and the surface of the guide groove farther from the laser beam 10 incident side is referred to as a “land surface” for convenience. For example, when the information recording medium 300 is used as a Blu-ray Disc, the level difference between the groove surface and the land surface preferably is at least 10 nm but not more than 30 nm. In the Blu-ray Disc, recording is performed only on the groove surfaces, and a groove-to-groove distance (a distance from the center of one groove surface to the center of the adjacent groove surface) preferably is about 0.32 μm.

The interlayer 303 has a function of separating the focal point of the laser beam 10 on the second information layer 320 from the focal point thereof on the first information layer 310, and may be formed with guide grooves for the second information layer 320, as needed. Likewise, the interlayer 304 has a function of separating the focal point of the laser beam 10 on the third information layer 330 from the focal point thereof on the second information layer 320, and may be formed with guide grooves for the third information layer 330, as needed. The interlayers 303 and 304 can be formed of an ultraviolet curable resin. The interlayers 303 and 304 each may have a layered structure of a plurality of resin layers. For example, the interlayer 303 may have a structure of two or more layers including a layer for protecting the dielectric layer 317 and a layer formed with guide grooves.

It is desirable that the interlayers 303 and 304 be transparent for an optical beam with a wavelength λ used for recording and reproduction so as to allow the laser beam 10 to reach the first information layer 310 and the second information layer 320 efficiently. It is preferable that the interlayers 303 and 304 each have: (1) a thickness equal to or larger than the focal depth determined by the numerical aperture of an objective lens and the wavelength of the laser beam; (2) a thickness such that the distance between the recording layer 315 and the recording layer 335 falls within the range where the laser beam can be focused through the objective lens; and (3) a thickness such that the total thickness of the interlayers 303 and 304 and the transparent layer 302 falls within the tolerance of the substrate thickness allowed by the objective lens to be used.

Preferably, the distance from the surface of the transparent layer 302 to the recording layer 315 of the first information layer 310 is at least 80 μm but not more than 120 μm. Furthermore, it is preferable that the interlayer 303 and the interlayer 304 have different thicknesses so as to perform the reproduction of signals from the first information layer 310, the second information layer 320, and the third information layer 330, and to perform the recording, erasing, and rewriting of the signals with respect to these information layers well, with the information layers unaffected by each other. The thickness of each of these interlayers is preferably chosen in the range of at least 3 μm but not more than 30 p.m. More preferably, the thickness is chosen in the range of at least 10 μm but not more than 30 μm. For example, the thickness of each of the interlayer 303, the interlayer 304, and the transparent layer 302 may be determined so that the distance from the surface of the transparent layer 302 to the recording layer 315 is 100 μm. As an example, the thicknesses of the interlayer 303, the interlayer 304, and the transparent layer 302 can be determined to be 25 μm, 18 μm, and 57 μm, respectively. Or they also can be determined to be 16 pin, 24 μm, and 60 μm, respectively.

The transparent layer 302 is described. A method for increasing the recording density of the information recording medium is to use a laser beam with a short wavelength, and to increase the numerical aperture NA of the objective lens so that the laser beam can be focused on a smaller spot. In this case, the focal length is reduced, and thus the transparent layer 302 located on the incident side of the laser beam 10 is designed to be thinner than the substrate 301. With this structure, the information recording medium 300 with a large capacity, on which information can be recorded at a higher density, can be obtained.

A disc-shaped transparent layer with a smooth surface is used for the transparent layer 302, as used for the substrate 301. The transparent layer 302 may be composed of a disc-shaped sheet and an adhesive layer, or may be composed of an ultraviolet curable resin, for example. Guide grooves (projections and depressions) for guiding the laser beam 10 may be formed on the transparent layer 302, as needed. It also is possible to form a protective layer on the surface of the dielectric layer 337 and form the transparent layer 302 thereon. Although any of these structures may be used, the total thickness for example, the sheet thickness+the adhesive layer thickness+the protective layer thickness, or the thickness of only the ultraviolet curable resin) preferably is at least 20 μm but not more than 100 μm, and more preferably at least 30 μm but not more than 80 μm. Preferably, the sheet is formed of a resin, such as polycarbonate, amorphous polyolefin, or PMMA, and the polycarbonate is particularly preferable. Since the transparent layer 302 is located on the laser beam 10 incident side, it is optically preferable that the transparent layer 302 have a low birefringence in a short wavelength region.

Next, each of the information layers is described. First, the structure of the third information layer 330 is described.

As described above, the third information layer 330 is formed by disposing the dielectric layer 331, the reflective layer 332, the dielectric layer 333, the interface layer 334, the recording layer 335, the interface layer 336, and the dielectric layer 337 in this order on one surface of the interlayer 304.

The third information layer 330 is designed to have a high transmittance so that the laser beam 10 can reach the first information layer 310 and the second information layer 320. Specifically, if the optical transmittance of the third information layer 330 when the recording layer 335 is in the crystalline phase is denoted as Tc (%) and the optical transmittance of the third information layer 330 when the recording layer 335 is in the amorphous phase is denoted as Ta (%), 53%≦(Ta+Tc)/2 preferably holds. More preferably, 56%≦(Ta+Tc)/2 holds.

The dielectric layer 331 has a function of increasing the optical transmittance of the third information layer 330. Preferably, the material of the dielectric layer 331 is transparent and has a refractive index of 2.4 or more with respect to the laser beam 10 with a wavelength of 405 nm. As the refractive index of the dielectric layer 331 decreases, the reflectance ratio Rc/Ra of the third information layer 330 increases, while the optical transmittance thereof decreases. Preferably, the dielectric layer 331 has a refractive index of at least 2.4, which allows a reflectance ratio of at least 4 and an optical transmittance of at least 53% to be obtained. Accordingly, if the refractive index is less than 2.4, there may be a case where the optical transmittance of the third information layer 330 decreases, and a sufficient amount of the laser beam 10 cannot reach the first information layer 310 and the second information layer 320.

As the material for the dielectric layer 331, a material containing at least one of, for example, ZrO₂, Nb₂O₅, Bi₂O₃, CeO₂, TiO₂, and WO₃ may be used. Among these, TiO₂ having a high refractive index of 2.7 and excellent moisture resistance is used preferably. Or, a material containing 50 mol % or more of at least one of ZrO₂, Nb₂O₅, Bi₂O₃, CeO₂, TiO₂, and WO₃ may be used. For example, (ZrO₂)₈₀(Cr₂O₃)₂₀ (mol %), (Bi₂O₃)₆₀(SiO₂)₄₀ (mol %), (Bi₂O₃)₆₀(TeO₂)₄₀ (mol %), (CeO₂)₅₀(SnO₂)₅₀ (mol %), (TiO₂)₅₀(HfO₂)₅₀ (mol %), (WO₃)₇₅(Y₂O₃)₂₅ (mol %), (Nb₂O₅)₅₀(MnO)₅₀ (mol %), (Al₂O₃)₅₀(TiO₂)₅₀ (mol %), or the like may be used. Or, a mixed material of at least two of ZrO₂, Nb₂O₅, Bi₂O₃, CeO₂, TiO₂, and WO₃ also may be used. For example, Bi₄Ti₃O₁₂ ((Bi₂O₃)₄₀(TiO₂)₆₀ (mol %)), Bi₂Ti₄O₁₁ ((Bi₂O₃)₈₀ (mol %), ((Bi₂O₃)_{85.7}(TiO₂)_{14.3} (mol %)), (WO₃)₅₀(Bi₂O₃)₅₀ (mol %), (TiO₂)₅₀(Nb₂O₅)₅₀ (mol %), (CeO₂)₅₀(TiO₂)₅₀ (mol %), (ZrO₂)₅₀(TiO₂)₅₀ (mol %), (WO₃)₆₇(ZrO₂)₃₃ (mol %), or the like may be used.

According to optical calculations, the transmittance of the third information layer 330 has a maximum value when the dielectric layer 331 has a thickness of λ/(8n₁) (nm) or a value approximate thereto (where λ denotes the wavelength of the laser beam 10, and n₁ denotes the refractive index of the dielectric layer 331). The reflectance contrast (Rc−Ra)/(Rc+Ra) has a maximum value when the thickness of the dielectric layer 331 is in the range of at least λ(16n₁) but not more than λ/(4n₁). Thus, the thickness of the dielectric layer 331 can be chosen so as to obtain both of the maximum transmittance and the maximum reflectance contrast. Preferably, the thickness is at least 9 nm but not more than 42 nm, and more preferably at least 8 nm but not more than 30 nm. The dielectric layer 331 may be formed of two or more layers.

Optically, the reflective layer 332 has a function of increasing the amount of optical beam to be absorbed by the recording layer 335 and a function of increasing the reflectance difference of the third information layer 330 between when the recording layer 335 is amorphous and when the recording layer 335 is crystalline. Thermally, the reflective layer 332 has a function of diffusing heat generated in the recording layer 335 rapidly to cool the recording layer 335 rapidly and transform it into an amorphous state more easily. Furthermore, the reflective layer 332 also has a function of protecting the multilayer film including the layers from the dielectric layer 333 to the dielectric layer 337 from the environment in which it is used.

The reflective layer 332 has a function of rapidly diffusing the heat of the recording layer 335. Since the third information layer 330 is required to have a high optical transmittance as mentioned above, it is desirable that the reflective layer 332 have low optical absorption. Therefore, preferably, the reflective layer 332 is designed to be thinner, and thus is composed of a material having high thermal conductivity so that it can diffuse heat rapidly in spite of its small thickness.

Specifically, Ag or an Ag alloy preferably is used for the reflective layer 332. Examples of the Ag alloy include alloy materials such as Ag—Pd, Ag—Pd—Cu, Ag—Ga, Ag—Ga—Cu, Ag—Cu, and Ag—In—Cu. A material containing Ag or Ag—Cu and additionally containing a rare earth metal may be used. Among these materials, Ag—Pd—Cu, Ag—Ga—Cu, Ag—Cu, and Ag—In—Cu are used preferably because they have low optical absorption, high thermal conductivity, and excellent moisture resistance. The thickness of the reflective layer 332 is adjusted taking the thickness of the recording layer into consideration. Preferably, it is at least 3 nm but not more than 15 nm. The thickness of less than 3 nm makes it difficult to form a uniform thin film. As a result, the function of diffusing the heat deteriorates, which makes it difficult to form marks on the recording layer 335. On the other hand, the thickness of more than 15 nm decreases the optical transmittance of the third information layer 330 to less than 53%.

The dielectric layers 333 and 337 each have a function of adjusting the optical distance to adjust the Rc, Ra, Tc, and Ta of the third information layer 330. The dielectric layers 333 and 337 each have both a function of enhancing the optical absorption efficiency of the recording layer 335 and a function of protecting the recording layer 335 from moisture or the like. Preferably, the dielectric layers 333 and 337 have, as their properties, high transparency at the wavelength of the laser to be used, and excellent heat resistance as well as excellent moisture resistance.

As the material for the dielectric layers 333 and 337, oxides, sulfides, nitrides, carbides, and fluorides, and mixtures of these can be used. Examples of the oxides that can be used include Al₂O₃, Al₂TiO₅, Al₆Si₂O₁₃, Bi₂O₃, CaO, CeO₂, Cr₂O₃, Dy₂O₃, Ga₂O₃, Gd₂O₃, GeO₂, HfO₂, Ho₂O₃, In₂O₃, La₂O₃, MgO, MgSiO₃, Nb₂O₅, Nd₉O₃, Sb₉O₃, Sc₂O₃, SiO₂, Sm₂O₃, SnO₂, Ta₂O₅, TeO₂, TiO₂, WO₃, Y₂O₃, Yb₂O₃, ZnO, ZrO₂, and ZrSiO₄. Examples of the sulfides that can be used include ZnS. Examples of the nitrides that can be used include AlN, BN, CrN, Ge₃N₄, HfN, NbN, Si₃N₄, TaN, TiN, VN, and ZrN. Examples of the carbides that can be used include Al₄C₃, B₄C, CaC₂, Cr₃C₂, MC, Mo₂C, NbC, SiC, TaC, TiC, VC, W₂C, WC, and ZrC. Examples of the fluorides that can be used include CaF₂, CeF₃, DyF₃, ErF₃, GdF₃, HoF₃, LaF₃, MgF₂, NdF₃, YF₃, and YbF₃.

Examples of the mixtures that can be used include ZnS—SiO₂, ZnS—SiO₂—Ta₂O₅, ZnS—SiO₂—LaF₃, ZrO₂—SiO₂, ZrO₂—Cr₂O₃, ZrO₂—SiO₂—Cr₂O₃, ZrO₂—Ga₂O₃, ZrO₂—SiO₂—Ga₂O₃, ZrO₂—In₂O₃, and ZrO₂—SiO₂—In₂O₃.

The third information layer 330 is required to have a high transmittance of at least 53%. Therefore, it is more preferable that the material of the dielectric layers 333 and 337 contain 90 mol % or more of at least one selected from an oxide, a sulfide, and a fluoride. For example, composite materials or mixed materials containing ZrO₂ have high transparency at a wavelength of about 405 nm and also have excellent heat resistance. For the material containing ZrO₂, partially-stabilized zirconia or stabilized zirconia obtained by adding CaO, MgO, or Y₂O₃ to ZrO₂ so as to substitute for a part of ZrO₂ may be used. HfO₂ having similar chemical properties may be used instead of ZrO₂.

Preferably, the dielectric layer 333 adjacent to the reflective layer 332 does not contain a sulfide because Ag or an Ag alloy preferably is used for the reflective layer 332. On the other hand, a more transparent material preferably is used for the dielectric layer 337 located on the laser beam 10 incident side. For example, ZnS—SiO₂ is a preferable material for the dielectric layer 337 because it is amorphous, and has a low thermal conductivity a high transparency, a high refractive index, a high deposition rate when forming a film, excellent mechanical properties, and excellent moisture resistance. (ZnS)₈₀(SiO₂)₂₀ (mol %) is used particularly preferably as the dielectric layer 337. Alternatively the dielectric layer 333 or the dielectric layer 337 may be formed of two or more layers each made of the oxide, etc. or the mixture as mentioned above.

The optical path length is a product nd of the refractive index n of a dielectric layer and the thickness d of the dielectric layer, and is represented by nd=aλ (where λ is the wavelength of the laser beam 10, and a is an positive integer). The optical path length can be determined accurately by, for example, calculations based on a matrix method (see, for example, Hiroshi Kubota, “Wave Optics”, Iwanarni Shinsho, 1971, Chapter 3). The thickness d can be determined from the optical path length nd.

In the present embodiment, as an example, the third information layer 330 is designed to have a transmittance ((Ta+Tc)/2) of 56%, a reflectance Rc of 2.2%, and a reflectance Ra of 0.3%. When a dielectric material having a refractive index of 1.5 to 3 is used for the dielectric layers 333 and 337, the thickness of the dielectric layer 333 preferably is 20 nm or less, and more preferably at least 5 nm but not more than 15 nm. The thickness of the dielectric layer 337 preferably is at least 15 nm but not more than 60 nm, and more preferably at least 20 nm but not more than 50 nm.

The dielectric layer 333 and the dielectric layer 337 may be provided, as needed. In the case where the interface layer 334 also has the above-mentioned functions of the dielectric layer 333, the dielectric layer 333 does not necessarily have to be provided. In the case where the interface layer 336 also has the above-mentioned functions of the dielectric layer 337, the dielectric layer 337 does not necessarily have to be provided. For example, the third information layer 330 may have a structure in which the dielectric layer 331, the reflective layer 332, the interface layer 334, the recording layer 335, the interface layer 336, and the dielectric layer 337 are disposed in this order on the interlayer 304. The third information layer 330 may have a structure in which the dielectric layer 331, the reflective layer 332, the interface layer 334, the recording layer 335, and the interface layer 336 are disposed in this order thereon. Or, the third information layer 330 may have a structure in which the dielectric layer 331, the reflective layer 332, the dielectric layer 333, the interface layer 334, the recording layer 335, and the interface layer 336 are disposed in this order on the interlayer 304.

Next, the interface layer 334 (dielectric layer a) and the interface layer 336 (dielectric layer b) are described. Both of the interface layer 334 and the interface layer 336 are provided in contact with the recording layer 335. The interface layers provided in contact with the recording layer 335 are required to have at least: (1) high melting points so that they do not melt during recording; and (2) good adhesion to the recording layer made of a chalcogenide material. As described above, since the area where a recording mark is formed is heated to the melting point or higher and melted during recording, the interface layers are subjected to the highest temperature during recording in a series of recording and erasing operations. The recording layer used in the present invention contains a material having a melting point of more than 700° C. Therefore, to prevent the interface layers 334 and 336 from melting during recording, they preferably have nominal melting points of 1000° C. or more. This is because they are thin films of several nanometer thickness and thus they may be subjected to diffusion, decomposition, and melting at a temperature lower than their nominal melting points.

The interface layer 334 is required to have high transparency in addition to the high melting point and the adhesion. In a complex refractive index (na-ika, where na is the refractive index of the interface layer 334, and ka is the extinction coefficient of the interface layer 334), as ka decreases, the reflectance ratio Rc/Ra of the third information layer 330 increases. This effect increases further as na decreases. Preferably, ka is 0.07 or less, and more preferably 0.04 or less. More preferably, na is relatively smaller than the refractive index nb of the interface layer 336.

For the interface layer 334, a material containing Cr, O, and at least one element M selected from Al, Dy, Nb, Si, Ti, and Y is used. The composition of the material can be represented by M_{c}Cr_{d}O_{100-c-d} (atom %), where subscripts c, d, and 100-c-d denote composition ratios of M, Cr, and O in atom %, respectively. In this case, it is preferable that c and d satisfy 12<c<40, 0<d≦25, and 20<(c+d)<50. The material in this composition range can have both high transparency and excellent adhesion to the chalcogenide recording layer. The interface layer 334 has only to contain Cr, O, and the element M, but preferably it contains, as a main component, Cr, O, and the element M. In order to obtain the advantageous effects of the present invention more reliably, the interface layer 334 may consist essentially of Cr, O, and the element M. In this description, “the interface layer 334 contains, as a main component, Cr, O, and the element M” means that when the sum total of all the atoms contained in the interface layer 334 is taken as 100 atom %, the sum total of all the atoms of Cr, O, and the element M is at least 90 atom %, and preferably at least 95 atom %. Furthermore, “the interface layer 334 consists essentially of Cr, O, and the element M” means that the sum total of all the atoms of Cr, O, and the element M is at least 95 atom %, and preferably at least 98 atom %, although a trace amount of other components as impurities, etc., for example, may be contained.

Specific examples of such a material include Al—Cr—O, Al—Dy—Cr—O, Al—Dy—Nb—Cr—O, Al—Dy—Si—Cr—O, Al—Dy—Ti—Cr—O, Al—Nb—Cr—O, Al—Nb—Si—Cr—O, Al—Nb—Ti—Cr—O, Al—Nb—Y—Cr—O, Al—Si—Cr—O, Al—Si—Ti—Cr—O, Al—Ti—Cr—O, Al—Ti—Y—Cr—O, Dy—Cr—O, Dy—Nb—Cr—O, Dy—Nb—Si—Cr—O, Dy—Nb—Y—Cr—O, Dy—Si—Cr—O, Dy—Si—Ti—Cr—O, Dy—Si—Y—Cr—O, Dy—Ti—Cr—O, Dy—Ti—Y—Cr—O, Dy—Y—Cr—O, Nb—Cr—O, Nb—Si—Cr—O, Nb—Si—Ti—Cr—O, Nb—Si—Y—Cr—O, Nb—Ti—Cr—O, Nb—Ti—Y—Cr—O, Nb—Y—Cr—O, Si—Cr—O, Si—Ti—Cr—O, Si—Ti—Y—Cr—O, Si—Y—Cr—O, Ti—Y—Cr—O, and Y—Cr—O.

A part of Cr contained in each of the above materials may be substituted by at least one element selected from Ga and In, although it costs a little more. For example, Al—Cr—O may be substituted to be used as Al—Cr—In—O, Al—Cr—Ga—O, or Al—Cr—In—Ga—O instead. Al—Si—Cr—O may be substituted to be used as Al—Si—Cr—In—O, Al—Si—Cr—Ga—O, or Al—Si—Cr—In—Ga—O instead. As another example, Al—Ti—Cr—O may be substituted to be used as Al—Ti—Cr—In—O, Al—Ti—Cr—Ga—O, or Al—Ti—Cr—In—Ga—O instead. When a part of Cr is substituted by at least one element selected from Ga and In, the extinction coefficient ka of the interface layer 334 can be reduced to enhance its transparency and the refractive index na thereof can be reduced without decreasing its adhesion.

Oxides of the element M are transparent and have high melting points. Therefore, preferably, the element M in the oxide form is contained in the interface layer 334. The interface layer 334 may contain, as an oxide of the element M, at least one oxide D selected from Al₂O₃, Dy₂O₃, Nb₂O₅, SiO₂, TiO₂, and Y₂O₃. These oxides have the following melting points and complex refractive indices respectively: Al₂O₃ has a melting point of about 2000° C. and a complex refractive index of Dy₂O₃ has a melting point of 2000° C. and a complex refractive index of 2.04-i0.01; Nb₂O₅ has a melting point of about 1500° C. and a complex refractive index of 2.51-i0.01; SiO₂ has a melting point of about 1700° C. and a complex refractive index of 1.47-i0.00; TiO₂ has a melting point of about 1800° C. and a complex refractive index of 2.68-i0.01; and Y₂O₃ has a melting point of about 2400° C. and a complex refractive index of 1.94-i0.01. The melting points are literature values of these materials in the solid state, and the complex refractive indices are experimental values obtained by the present inventors.

The interface layer 334 may contain a composite oxide of the element M. For example, it may contain a composite oxide of the oxide D. Examples of the composite oxide include Al₆Si₂O₁₃ [═(Al₂O₃)₆₀(SiO₂)₄₀ (mol %)], which is a composite oxide of Al₂O₃ and SiO₂, and Al₂TiO₅ [═(Al₂O₃)₅₀(TiO₂)₅₀ (mol %)]. Al₆Si₂O₁₃ has a melting point of about 1900° C. and a complex refractive index of 1.59-i0.00, and Al₂TiO₅ has a melting point of about 1900° C. and a complex refractive index of 2.17-i0.01.

Examples of the oxide of the element M that the interface layer 334 may contain include suboxides (oxides containing less oxygen than the stoichiometric compositions) and mixtures of these, in addition to the above compounds and composite oxides.

In the case where the interface layer 334 contains a suboxide of the element M, it may contain at least one selected from an Al suboxide, a Dy suboxide, a Nb suboxide, a Si suboxide, a Ti suboxide, a Y suboxide, an Al—Si suboxide, and an Al—Ti suboxide. In the case where the interface layer 334 contains a mixture of the oxide D as a mixture of an oxide of the element M, it may contain at least one selected from, for example, Al₂O₃—Dy₂O₃, Dy₂O₃—Nb₂O₅, Nb₂O₅—SiO₂, SiO₂—TiO₂, TiO₂—Y₂O₃, and the like.

As the material of the interface layer 334, a material containing any one of these oxides D and an oxide of Cr is used preferably. More preferably, the composition of the material is represented by (D)ₕ(Cr₂O₃)₁₀₀₋ₕ (mol %), where subscripts h and 100-h denote composition ratios of D and Cr₂O₃ in mol %, respectively, and h satisfies 50≦h<100. The oxide of Cr preferably is present as Cr₂O₃ in the interface layer 334, and it may be present as a suboxide of Cr₂O₃. The interface layer 334 may consist essentially of a material represented by (D)ₕ(Cr₂O₃)₁₀₀₋ₕ (mol %). “The interface layer 334 consists essentially of a material represented by (D)ₕ(Cr₂O₃)₁₀₀₋ₕ (mol %)” means that the total content of the oxide D and Cr₂O₃ in the interface layer 334 is at least 95 mol %, and preferably at least 98 mol %.

As described above, there are very few dielectric materials exhibiting excellent adhesion to the chalcogen-containing recording layer. As a result of experiments, the present inventors have concluded that Cr₂O₃ is the most preferable material. However, since Cr₂O₃ has a high extinction coefficient k of about 0.2 for the optical beam with a wavelength of 405 nm, it cannot be used alone, although its adhesion is excellent. Accordingly, to ensure high transparency, the Cr₂O₃ content is set to 50 mol % or less, and the oxide D ensuring adhesion in spite of the Cr₂O₃ content of 50 mol % or less is carefully selected.

When a mixture of the oxide D and Cr₂O₃ is used as a material for the interface layer 334, Al₂O₃—Cr₂O₃, Dy₂O₃—Cr₂O₃, Nb₂O₅—Cr₂O₃, SiO₂—Cr₂O₃, TiO₂—Cr₂O₃, or Y₂O₃—Cr₂O₃ can specifically be used. When a mixture of a composite oxide of the oxide D and Cr₂O₃ is used, for example, Al₆Si₂O₁₃—Cr₂O₃ or Al₂TiO₅—Cr₂O₃ can specifically be used. A mixture of a suboxide of the element M and Cr₂O₃ also may be used.

A mixture of a mixture of the oxide D and Cr₂O₃ also can be used. Specifically, at least one selected from Al₂O₃—Dy₂O₃—Cr₂O₃, Al₂O₃—Nb₂O₅—Cr₂O₃, Al₂O₃—SiO₂—Cr₂O₃, Al₂O₃—TiO₂—Cr₂O₃, Al₂O₃—Y₂O₃—Cr₂O₃, Dy₉O₃—Nb₂O₅—Cr₂O₃, Dy₂O₃—SiO₂—Cr₂O₃, Dy₂O₃—TiO₂—Cr₂O₃, Dy₂O₃—Y₂O₃—Cr₂O₃, Nb₂O₅—SiO₂—Cr₂O₃, Nb₂O₅—TiO₂—Cr₂O₃, Nb₂O₅—Y₂O₃—Cr₂O₃, SiO₂—TiO₂—Cr₂O₃, SiO₂—Y₂O₃—Cr₂O₃, TiO₂—Y₂O₃—Cr₂O₃, Al₂O₃—Dy₂O₃—Nb₂O₅—Cr₂O₃, Al₂O₃—Dy₂O₃—SiO₂—Cr₂O₃, Al₂O₃—Dy₂O₃—TiO₂—Cr₂O₃, Al₂O₃—Dy₂O₃—Y₂O₃—Cr₂O₃, Al₂O₃—Nb₂O₅—SiO₂—Cr₂O₃, Al₂O₃—Nb₂O₅—TiO₂—Cr₂O₃, Al₂O₃—Nb₂O₅—Y₂O₃—Cr₂O₃, Al₂O₃—SiO₂—TiO₂—Cr₂O₃, Al₂O₃—SiO₂—Y₂O₃—Cr₂O₃, Al₂O₃—TiO₂—Y₂O₃—Cr₂O₃, Dy₂O₃—Nb₂O₅—SiO₂—Cr₂O₃, Dy₂O₃—Nb₂O₅—TiO₂—Cr₂O₃, Dy₂O₃—Nb₂O₅—Y₂O₃—Cr₂O₃, Dy₂O₃—SiO₂—TiO₂—Cr₂O₃, Dy₂O₃—SiO₂—Y₂O₃—Cr₂O₃, Dy₂O₃—TiO₂—Y₂O₃—Cr₂O₃, Nb₂O₅—SiO₂—TiO₂—Cr₂O₃, Nb₂O₅—SiO₂—Y₂O₃—Cr₂O₃, Nb₂O₅—TiO₂—Y₂O₃—Cr₂O₃, SiO₂—TiO₂—Y₂O₃—Cr₂O₃, Al₂TiO₅—Dy₂O₃—Cr₂O₃, Al₂TiO₅—Nb₂O₅—Cr₂O₃, Al₂TiO₅—SiO₂—Cr₂O₃, Al₂TiO₅—Y₂O₃—Cr₂O₃, Al₆Si₂O₁₃—Dy₂O₃—Cr₂O₃, Al₆Si₂O₁₃—Nb₂O₅—Cr₂O₃, Al₆Si₂O₁₃—TiO₂—Cr₂O₃, Al₆Si₂O₁₃—Y₂O₃—Cr₂O₃, and the like can be used.

Preferably, the oxide D contains an oxide of Al or a composite oxide of Al that is less susceptible to oxygen deficiency during the formation of a thin film. Specific examples thereof include Al₂O₃, Al₆Si₂O₁₃, and Al₂TiO₅.

A part of Cr₂O₃ contained in the above materials may be substituted by at least one oxide selected from Ga₂O₃ and In₂O₃, although it costs a little more. For example, Al₂O₃—Cr₂O₃ may be substituted to be used as Al₂O₃—Cr₂O₃In₂O₃, Al₂O₃—Cr₂O₃—Ga₂O₃, or Al₂O₃—Cr₂O₃—In₂O₃—Ga₂O₃ instead. Al₂O₃—SiO₂—Cr₂O₃ may be substituted to be used as Al₂O₃—SiO₂—Cr₂O—In₂O₃, Al₂O₃—SiO₂—Cr₂O₃—Ga₂O₃, or Al₂O₃—SiO₂—Cr₂O₂—In₂O₃—Ga₂O₃ instead. As another example, Al₂O₃—TiO₂—Cr₂O₃ may be substituted to be used as Al₂O₃—TiO₂—Cr₂O₃—In₂O₃, Al₂O₃—TiO₂—Cr₂O₃—Ga₂O₃, or Al₂O₃—TiO₂—Cr₂O₃—In₂O₃—Ga₂O₃ instead. When a part of Cr₂O₃ is substituted by at least one oxide selected from Ga₂O₃ and In₂O₃, the extinction coefficient ka of the interface layer 334 can be reduced to enhance its transparency, and the refractive index na thereof can be reduced without decreasing its adhesion. In this case, the total content of Ga₂O₃ and In₂O₃ in the interface layer 334 preferably is 30 mol % or less. This is because if the content of Ga₂O₃ and In₂O₃ is too high, the content of Cr₂O₃ becomes too low, which may cause a decrease in the heat resistance of the interface layer 334 and thereby cause a decrease in the number of repeated rewritings. Cr₂O₃ has a melting point of about 2300° C. and a complex refractive index of 2.70-i0.20, Ga₂O₃ has a melting point of about 1700° C. and a complex refractive index of 1.93-i0.01, and In₂O₃ has a melting point of about 1900° C. and a complex refractive index of 2.12-i0.06. The melting points are literature values of these materials in the solid state, and the complex refractive indices are experimental values obtained by the present inventors.

The interface layer 336 (dielectric layer b) is required to have high heat resistance in addition to the high melting point and the adhesion. As described above, the thermal calculations performed by the present inventors show that when the recording layer is irradiated with a laser beam to perform recording thereon in a translucent information layer Like the third information layer 330 and the second information layer 320, it is not the recording layer that increases in temperature most significantly, but the interface layer (dielectric layer b) disposed closer to the laser beam incident side than the recording layer does. Therefore, a material having higher heat resistance than the interface layer 334 must be used for the interface layer 336. The interface layer 336 is formed after the recording layer 335 is formed, although the order of forming thin film layers will be described later. Therefore, the interface layer 336 also is required to have structural stability to prevent the components of the interface layer 336 from being decomposed or diffused and mixed into the recording layer 335 during the formation of the interface layer 336. Preferably, the interface layer 336 not only has a high melting point but also is neither diffused nor decomposed at least at a temperature lower than 1000° C.

As the material for the interface layer 336, a material containing Cr, O, and at least one element A selected from Zr and Hf is used. The composition of the material can be represented by A_{f}Cr_{g}O_{100-f-g} (atom %), where subscripts f, g, and 100-f-g denote composition ratios of A, Cr, and O in atom %, respectively. In this case, it is preferable that f and g satisfy 4<f<16, 21<g<35, and 30<(f+g)<50. The material in this composition range can have both high heat resistance and excellent adhesion to the chalcogenide recording layer. Specifically, Zr—Cr—O, Hf—Cr—O, or Zr—Hf—Cr—O may be used. The interface layer 336 has only to contain Cr, O, and the element A, but preferably it contains, as a main component, Cr, O, and the element A. In order to obtain the advantageous effects of the present invention more reliably, the interface layer 336 may consist essentially of Cr, O, and the element A. In this description, “the interface layer 336 contains, as a main component, Cr, O, and the element A” means that when the sum total of all the atoms contained in the interface layer 336 is taken as 100 atom %, the sum total of all the atoms of Cr, O, and the element A is at least 90 atom %, and preferably at least 95 atom %. Furthermore, “the interface layer 336 consists essentially of Cr, O, and the element A” means that the sum total of all the atoms of Cr, O, and the element A is at least 95 atom %, and preferably at least 98 atom %, although a trace amount of other components as impurities, etc., for example, may be contained.

The interface layer 336 may further contain at least one element X selected from Al, Dy, Nb, Si, Ti, and Y. In this case, it is preferable that the interface layer 336 contain a material represented by AₖCrₘXₙO₁₀₀₋ₖ₋ₘ₋ₙ (atom %), where subscripts k, m, n, and 100-k-m-n denote composition ratios of A, Cr, X, and O in atom %, respectively, and k, m, and n satisfy 1<k<18, 3<m<35, 0<n<31, and 25<(k+m+n)<50. The refractive index nb of the interface layer 336 containing the element X can be adjusted. Among the elements X, Ti is significantly effective in increasing the refractive index. In this case, the interface layer 336 has only to contain the element A, Cr, the element X, and O but it may contain, as a main component, the element A, Cr, the element X, and O (the sum total of all the atoms of the element A, Cr, the element X, and O is at least 90 atom %, and preferably at least 95 atom %), or it may consist essentially of the element A, Cr, the element X, and O (the sum total of all the atoms of the element A, Cr, the element X, and O is at least 95 atom %, and preferably at least 98 atom %).

Specific examples of such a material that can be used include Zr—Al—Cr—O, Zr—Al—Dy—Cr—O, Zr—Al—Nb—Cr—O, Zr—Al—Si—Cr—O, Zr—Dy—Cr—O, Zr—Dy—Nb—Cr—O, Zr—Dy—Si—Cr—O, Zr—Dy—Ti—Cr—O, Zr—Dy—Y—Cr—O, Zr—Nb—Cr—O, Zr—Nb—Si—Cr—O, Zr—Nb—Ti—Cr—O, Zr—Nb—Y—Cr—O, Zr—Si—Cr—O, Zr—Si—Ti—Cr—O, Zr—Ti—Cr—O, Zr—Ti—Y—Cr—O, Zr—Y—Cr—O, Hf—Al—Cr—O, Hf—Al—Dy—Cr—O, Hf—Al—Nb—Cr—O, Hf—Al—Si—Cr—O, Hf—Al—Ti—Cr—O, Hf—Al—Y—Cr—O, Hf—Dy—Cr—O, Hf—Dy—Nb—Cr—O, Hf—Dy—Si—Cr—O, Hf—Dy—Ti—Cr—O, Hf—Dy—Y—Cr—O, Hf—Nb—Cr—O, Hf—Nb—Si—Cr—O, Hf—Nb—Ti—Cr—O, Hf—Nb—Y—Cr—O, Hf—Si—Cr—O, Hf—Si—Ti—Cr—O, Hf—Si—Y—Cr—O, Hf—Ti—Cr—O, Hf—Ti—Y—Cr—O, Hf—Y—Cr—O, Hf—Si—Ti—Cr—O, Zr—Hf—Al—Dy—Cr—O, Zr—Hf—Al—Nb—Cr—O, Zr—Hf—Al—Si—Cr—O, Zr—Hf—Al—Ti—Cr—O, Zr—Hf—Al—Y—Cr—O, Zr—Hf—Dy—Cr—O, Zr—Hf—Dy—Nb—Cr—O, Zr—Hf—Dy—Si—Cr—O, Zr—Hf—Dy—Ti—Cr—O, Zr—Hf—Dy—Y—Cr—O, Zr—Hf—Nb—Cr—O, Zr—Hf—Nb—Si—Cr—O, Zr—Hf—Nb—Ti—Cr—O, Zr—Hf—Nb—Y—Cr—O, Zr—Hf—Si—Cr—O, Zr—Hf—Si—Ti—Cr—O, Zr—Hf—Si—Y—Cr—O, Zr—Hf—Ti—Cr—O, Zr—Hf—Ti—Y—Cr—O, Zr—Hf—Y—Cr—O, and the like.

A part of Cr contained in the above materials may be substituted by at least one element selected from Ga and In, although it costs a little more. For example, Zr—Al—Cr—O may be substituted to be used as Zr—Al—Cr—In—O, Zr—Al—Cr—Ga—O, or Zr—Al—Cr—In—Ga—O instead. Zr—Al—Si—Cr—O may be substituted to be used as Zr—Al—Si—Cr—In—O, Zr—Al—Si—Cr—Ga—O, or Zr—Al—Si—Cr—In—Ga—O instead. As another example, Zr—Al—Ti—CrO may be substituted to be used as Zr—Al—Ti—Cr—In—O, Zr—Al—Ti—Cr—Ga—O, or Zr—Al—Ti—Cr—In—Ga—O instead. When a part of Cr is substituted by at least one element selected from Ga and In, the extinction coefficient kb of the interface layer 336 can be reduced to enhance its transparency without decreasing its adhesion and heat resistance.

Oxides of the element A are transparent and have high melting points. Therefore, preferably, the element A in the oxide form is contained in the interface layer 336. The interface layer 336 may contain, as an oxide of the element A, at least one oxide AO₂ selected from ZrO₂ and HfO₂. Examples of the oxide AO₂ include ZrO₂, HfO₂, and ZrO₂—HfO₂. ZrO₂ has a melting point of about 2700° C. and a complex refractive index of 2.18-i0.01, and HfO₂ has a melting point of about 2800° C. and a complex refractive index of 2.14-i0.00. The melting points are literature values of these materials in the solid state, and the complex refractive indices are experimental values obtained by the present inventors.

As the material of the interface layer 336, a material containing any one of these oxides AO₂ and an oxide of Cr is used preferably. More preferably, the composition of the material is represented by (AO₂)ⱼ(Cr₂O₃)₁₀₀₋ⱼ (mol %), where subscripts j and 100-j denote composition ratios of AO₂ and Cr₂O₃ in mol %, respectively, and j satisfies 20≦j≦60. In this material, Cr₂O₃ can compensate for the poor adhesion of ZrO₂ or HfO₂. In this case, the interface layer 336 has only to contain a material represented by (AO₂)ⱼ(Cr₂O₃)₁₀₀₋ⱼ (mol %), but it may consist essentially of a material represented by (AO₂)ⱼ(Cr₂O₃)₁₀₀₋ⱼ (mol %). “The interface layer 334 consists essentially of a material represented by (AO₂)ⱼ(Cr₂O₃)₁₀₀₋ⱼ (mol %)” means that the total content of the oxide AO₂ and Cr₂O₃ in the interface layer 336 is at least 95 mol %, and preferably at least 98 mol %.

The oxide of Cr preferably is present as Cr₂O₃ in the interface layer 336, and it may be present as a suboxide of Cr₂O₃. ZrO₂ is transparent, and has structural stability to prevent it from being diffused and decomposed at least at a temperature lower than 1000° C., according to the analysis of the present inventors. HfO₂ having similar chemical properties to ZrO₂ also has structural stability. However, since HfO₂ is expensive, ZrO₂ is used more preferably.

As the material for the interface layer 336, a mixture of the oxide of the element A and the oxide of Cr can be used. Specifically, ZrO₂—Cr₂O₃, HfO₂—C₁₂O₃, or ZrO₂—HfO₂—Cr₂O₃ can be used.

Oxides of the element X are transparent and have high melting points. The interface layer 336 may contain, as an oxide of the element X, at least one oxide L selected from Al₂O₃, Dy₂O₃, Nb₂O₅, SiO₂, TiO₂, and Y₂O₃ (the melting points and the complex refractive indices of these oxides are the same as those of the oxide D described above). More preferably, the composition of the material is represented by (AO₂)ₚ(Cr₂O₃)ₜ(L)₁₀₀₋ₚ₋ₜ (mol %), where subscripts p, t, and 100-p-t denote composition ratios of AO₂, Cr₂O₃, and L in mol %, respectively, and p and t satisfy 20≦p≦60, 20≦t<80, and 60≦(p<100. The refractive index nb of the interface layer 336 containing the oxide L can be adjusted. Among the oxides L, TiO₂ is significantly effective in increasing the refractive index. In this case, the interface layer 336 has only to contain a material represented by (AO₂)ₚ(Cr₂O₃)₁₀₀₋ₚ₋ₜ (mol %), but it may consist essentially of a material represented by (AO₂)ₚ(Cr₂O₃)ₜ(L)₁₀₀₋ₚ₋ₜ (mol %). “The interface layer 336 consists essentially of a material represented by (AO₂)ₚ(Cr₂O₃)ₜ(L)₁₀₀₋ₚ₋ₜ (mol %)” means that the total content of the oxide AO₂, Cr₂O₃, and the oxide L in the interface layer 336 is at least 95 mol %, and preferably at least 98 mol %.

Specific examples of such a material include ZrO₂—Al₂O₃—Cr₂O₃, ZrO₂—Al₂O₃—Dy₂O₃—Cr₂—O₃, ZrO₂—Al₂O₃—Nb₂O₅—Cr₂O₃, ZrO₂—Al₂O₃—SiO₂—Cr₂O₃, ZrO₂—Al₂O₃—TiO₂—Cr₂O₃, ZrO₂—Al₂O₃—Y₂O₃—Cr₂O₃, ZrO₂—Dy₂O₃—Cr₂O₃, ZrO₂—Dy₂O₃—Nb₂O₅—Cr₂O₃, ZrO₂—Dy₂O₃—SiO₂—Cr₂O₃, ZrO₂—Dy₂O₃—TiO₂—CnO₃, ZrO₂—Dy₂O₃—Y₂O₃—Cr₂O₃, ZrO₂—Nb₂O₅—Cr₂O₃, ZrO₂—Nb₂O₅—SiO₂—Cr₂O₃, ZrO₂—Nb₂O₅—TiO₂—Cr₂O₃, ZrO₂—Nb₂O₅—Y₂O₃—Cr₂O₃, ZrO₂—SiO₂—Cr₂O₃, ZrO₂—SiO₂—TiO₂—Cr₂O₃, ZrO₂—SiO₂—Y₂O₃—Cr₂O₃, ZrO₂—TiO₂—Cr₂O₃, ZrO₂—TiO₂—Y₂O₃—Cr₂O₃, ZrO₂—Y₂O₃—Cr₂O₃, HfO₂—Al₂O₃—Cr₂O₃, HfO₂—Al₂O₃—Dy₂O₃—Cr₂O₃, HfO₂—Al₂O₃—Nb₂O₅—Cr₂O₃, HfO₂—Al₂O₃—SiO₂—Cr₂O₃, HfO₂—Al₂O₃—TiO₂—Cr₂O₃, HfO₂—Al₂O₃—Y₂O₃—Cr₂O₃, HfO₂—Dy₂O₃—Cr₂O₃, HfO₂—Dy₂O₃—Nb₂O₅—Cr₂O₃, HfO₂—Dy₂O₃—SiO₂—Cr₂O₃, HfO₂—Dy₂O₃—TiO₂—Cr₂O₃, HfO₂—Dy₂O₃—Y₂O₃—Cr₂O₃, HfO₂—Nb₂O₅—Cr₂O₃, HfO₂—Nb₂O₅—SiO₂—Cr₂O₃, HfO₂—Nb₂O₅—TiO₂—Cr₂O₃, HfO₂—Nb₂O₅—Y₂O₃—Cr₂O₃, HfO₂—SiO₂—Cr₂O₃, HfO₂—SiO₂—TiO₂—Cr₂O₃, HfO₂—SiO₂—Y₂O₃—Cr₂O₃, HfO₂—TiO₂—Cr₂O₃, HfO₂—TiO₂—Y₂O₃—Cr₂O₃, HfO₂—Y₂O₃—Cr₂O₃, ZrO₂—HfO₂—Al₂O₃—Cr₂O₃, ZrO₂—HfO₂—Al₂O₃—Dy₂O₃—Cr₂O₃, ZrO₂—HfO₂—Al₂O₃—Nb₂O₅—Cr₂O₃, ZrO₂—HfO₂—Al₂O₃—SiO₂—Cr₂O₃, ZrO₂—HfO₂—Al₂O₃—TiO₂—Cr₂O₃, ZrO₂—HfO₂—Al₂O₃—Y₂O₃—Cr₂O₃, ZrO₂—HfO₂—Dy₂O₃—Cr₂O₃, ZrO₂—HfO₂—Dy₂O₃—Nb₂O₅—Cr₂O₃, ZrO₂—HfO₂—Dy₂O₃—SiO₂—Cr₂O₃, ZrO₂—HfO₂—Dy₂O₃—TiO₂—Cr₂O₃, ZrO₂—HfO₂—Dy₂O₃—Y₂O₃—Cr₂O₃, ZrO₂—HfO₂—Nb₂O—Cr₂O₃, ZrO₂—HfO₂—Nb₂O₅—SiO₂—Cr₂O₃, ZrO₂—HfO₂—Nb₂O₅—TiO₂—Cr₂O₃, ZrO₂—HfO₂—Nb₂O₅—Y₂O₃—Cr₂O₃, ZrO₂—HfO₂—SiO₂—Cr₂O₃, ZrO₂—HfO₂—SiO₂—TiO₂—Cr₂O₃, ZrO₂—HfO₂—SiO₂—Y₂O₃—Cr₂O₃, ZrO₂—HfO₂TiO₂—Cr₂O₃, ZrO₂—HfO₂—TiO₂—Y₂O₃—Cr₂O₃, ZrO₂—HfO₂—Y₂O₃—Cr₂O₃, and the Like. At least a part of ZrO₂—SiO₂ may be present as ZrSiO₄. At least a part of HfO₂—SiO₂ also may be present as HfSiO₄.

It is more preferable that the oxide L contain at least one selected from Al₂O₃, Dy₂O₃, SiO₂, and TiO₂, each having high transparency and satisfying the extinction coefficient requirement of 0.02 or less.

A part of Cr₂O₃ contained in the above materials may be substituted by at least one oxide selected from Ga₂O₃ and In₂O₃, although it costs a little more. For example, ZrO₂—Al₂O₃—Cr₂O₃ may be substituted to be used as ZrO₂—Al₂O₃—Cr₂O₃—Ga₂O₃, ZrO₂—Al₂O₃—Cr₂O₃—In₂O₃, or ZrO₂—Al₂O₃—Cr₂O₃—In₂O₃—Ga₂O₃ instead. ZrO₂—Al₂O₃—SiO₂—Cr₂O₃ may be substituted to be used as ZrO₂—Al₂O₃—SiO₂—Cr₂O₃—Ga₂O₃, ZrO₂—Al₂O₃—SiO₂—Cr₂O₃—In₂O₃, or ZrO₂—Al₂O₃—SiO₂—CnO₃—Ga₂O₃—In₂O₃ instead. As another example, ZrO₂—Al₂O₃—TiO₂—Cr₂O₃ may be substituted to be used as ZrO₂—Al₂O₃—TiO₂—Cr₂O₃—Ga₂O₃, ZrO₂—Al₂O₃—TiO₂—Cr₂O₃—In₂O₃, or ZrO₂—Al₂O₃—TiO₂—Cr₂O₃—Ga₂O₃—In₂O₃ instead. When a part of Cr₂O₃ is substituted by at least one oxide selected from Ga₂O₃ and In₂O₃, the extinction coefficient kb of the interface layer 336 can be reduced to enhance its transparency without decreasing its adhesion and heat resistance. In this case, the total content of Ga₂O₃ and In₂O₃ in the interface layer 336 preferably is 20 mol % or less. This is because if the content of Ga₂O₃ and In₂O₃ is too high, the content of Cr₂O₃ becomes too low, which may cause a decrease in the heat resistance of the interface layer 336 and thereby cause a decrease in the number of repeated rewritings.

More preferably, when the complex refractive indices of the interface layer 334 (dielectric layer a) and the interface layer 336 (dielectric layer b) are denoted as na-ika and nb-ikb respectively, (where na is the refractive index of the interface layer 334, ka is the extinction coefficient of the interface layer 334, nb is the refractive index of the interface layer 336, and kb is the extinction coefficient of the interface layer 336), na<nb holds. When this relationship holds, the reflectance ratio Rc/Ra of the third information layer 330 can be increased further. When this relationship holds particularly in the translucent information layer having a low reflectance, greater effects can be obtained.

Preferably, the thickness of the interface layer 334 is 1 nm or more so that the adhesion to the recording layer 335 can be ensured and atomic diffusion from the other layers to the recording layer 335 can be reduced. Furthermore, the total thickness of the interface layer 334 and the dielectric layer 333 preferably is 30 nm or less, and more preferably 25 nm or less. Since a highly transparent material is used for the interface layer 334, the thickness thereof may be increased up to 30 nm, if it also serves as the dielectric layer 333.

Preferably, the thickness of the interface layer 336 is 1 nm or more so that the adhesion to the recording layer 335 can be ensured and atomic diffusion from the other layers to the recording layer 335 can be reduced. Furthermore, to prevent optical influences, the thickness preferably is reduced as the extinction coefficient kb increases. The total thickness of the interface layer 336 and the dielectric layer 337 preferably is at least 15 nm but not more than 70 nm, and more preferably at least 20 nm but not more than 60 nm.

The compositions of the above-mentioned interface layers 334 and 336 and dielectric layers 333 and 337 can be analyzed by for example, an X-ray microanalyzer (XMA), an electron probe microanalyzer (EPMA), or Rutherford backscattering spectroscopy (RBS). The above-mentioned interface layers 334 and 336 and dielectric layers 333 and 337 formed by sputtering may unavoidably contain rare gases (Ar, Kr, and Xe), moisture (O—H and H), an organic matter (C), and air (N and O), components (metals) of a jig placed in the sputtering chamber, impurities (metals, metalloids, semiconductors, and dielectrics) contained in the sputtering target, etc. that are present in the sputtering atmosphere, and these are detected by any of these analysis methods in some cases. The total content of these components (i.e., components other than the components specified as being contained in the interface layers in the present invention) may be at most 10 atom %, when the sum total of all the atoms contained in the interface layers and the dielectric layers is taken as 100 atom %. In this case, the components of the interface layers, except for the other components, may satisfy the preferable composition ratios as described above. This also applies to interface layers 324, 326, 314, and 316, and dielectric layers 323, 327, 313, and 317 to be described later. This also applies to interface layers 414, 416, 424, 426, 434, 436, 444, 446, 214, 216, 224, 226, 114, and 116, and dielectric layers 413, 417, 423, 427, 433, 437, 443, 447, 213, 217, 223, 227, 113, and 117 to be described in the following embodiments.

The recording layer 335 is formed of a material that undergoes a phase change by irradiation with the laser beam 10. The material contains, for example, at least one selected from Ge-M, Sb—Ge, and Sb—Te. Such a material composition allows information to be recorded on or reproduced from the third information layer 330 with an increased capacity of 33.4 GB, for example. Examples of the material that can be used include a GeTe—Sb₂Te₃ pseudobinary material, a GeTe—Bi₂Te₃ pseudobinary material, an Sb—Te eutectic material, and a Ge—Sb eutectic material. These materials are phase-change recording materials each having a high crystallization rate and a high crystallization temperature, as well as undergoing a large optical change. As stated herein, the crystallization rate is defined as a relative rate of transition from the amorphous phase to the crystalline phase, the optical change is defined as a difference between the complex refractive index in the crystalline phase and that in the amorphous phase, and the crystallization temperature is defined as a temperature at which the amorphous phase changes to the crystalline phase.

The GeTe—Sb₂Te₃ pseudobinary material contains GeTe containing Ge and Te at 1:1, and Sb₂Te₃ containing Sb and Te at 2:3, and its crystalline structure is a rock salt structure. Since the rock salt structure is highly symmetric, the time required for the reversible phase transition between the amorphous phase and the crystalline phase is short, that is, the crystallization rate is high. The more Sb₂Te₃ is contained, the more the crystallization rate increases relatively. The GeTe—Sb₂Te₃ pseudobinary material can be expressed as (Ge_{0.5}Te_{0.5})ₓ(Sb_{0.4}Te_{0.6})₁₀₀₋ₓ in terms of composition ratio (atom %) using x (where x satisfies 0<x<100). Since GeTe undergoes a large optical change, if x≦80 holds, that is, the content of Ge is less than 40 atom % in the above formula, the optical change with respect to the blue-violet laser with a wavelength of about 405 nm is not large enough to obtain adequate signal quality in some cases. Furthermore, if 96<x holds, that is, the content of Ge is more than 48%, the crystallization rate is not high enough to obtain adequate rewriting performance in some cases. Accordingly, the concentration of Ge in the GeTe—Sb₂Te₃ pseudobinary material preferably is at least 40 atom % but not more than 48 atom %.

The GeTe—Bi₂Te₃ pseudobinary material contains GeTe containing Ge and Te at 1:1, and Bi₂Te₃ containing Sb and Te at 2:3, and its crystalline structure also is a rock salt structure. Bi₂Te₃ is still easier to crystallize than Sb₂Te₃, and therefore the GeTe—Bi₂Te₃ pseudobinary material has a higher crystallization rate than the GeTe—Sb₂Te₃ pseudobinary material. The more Bi₂Te₃ is contained, the more the crystallization rate increases relatively. The GeTe—Bi₂Te₃ pseudobinary material can be expressed as (Ge_{0.5}Te_{0.6})_{y}(Bi_{0.4}Te_{0.6})_{100-y} in terms of the composition ratio (atom %) using y (where y satisfies 0<y<100). As with the case described above, if the content of Ge is less than 40 atom %, adequate signal quality cannot be obtained in some cases. Since the crystallization rate of the GeTe—Bi₂Te₃ pseudobinary material is higher, the Ge concentration range becomes wider accordingly. However, if 99<x holds, that is, the content of Ge is more than 49.5%, the crystallization rate is not high enough to obtain adequate rewriting performance in some cases. Accordingly, the concentration of Ge in the GeTe—Bi₂Te₃ pseudobinary material preferably is at least 40 atom % but not more than 49.5 atom %.

In these GeTe—Sb₂Te₃ pseudobinary material and GeTe—Bi₂Te₃ pseudobinary material, a part of Ge may be substituted by Sn to adjust the crystallization rate or improve the archival overwrite characteristics. Alternatively, the GeTe—Sb₂Te₃ pseudobinary material or the GeTe—Bi₂Te₃ pseudobinary material may be stacked on a Sn₅₀Te₅₀ or GeₐSn₅₀₋ₐTe₅₀ layer to form the recording layer 335. Furthermore, in order to improve the archival characteristics, a part of Sb or Bi may be substituted by at least one of Al, Ga, and In, or the GeTe—Sb₂Te₃ pseudobinary material or the GeTe—Bi₂Te₃ pseudobinary material may be stacked on an Al₂Te₃, Ga₂Te₃, or In₂Te₃ layer to form the recording layer 335. The GeTe—Sb₂Te₃ pseudobinary material and the GeTe—Bi₂Te₃ pseudobinary material may be mixed to be used as a GeTe—Sb₂Te₃—Bi₂Te₃ material, or the GeTe—Sb₂Te₃ pseudobinary material and the GeTe—Bi₂Te₃ pseudobinary material may be stacked. These effective factors may be used in combination.

The composition ratio of Sb in the Ge—Sb eutectic material also can be determined arbitrarily within an appropriate composition range, and the Ge—Sb eutectic material has a high crystallization rate as well as a high crystallization temperature. Although Sb itself has such a high crystallinity that it crystallizes in a thin film state even at room temperature, its archival characteristics are poor and it undergoes only a small optical change. Therefore, Ge preferably is added thereto for use. The Ge—Sb eutectic material has relatively higher crystallization rate and crystallization temperature than the Sb—Te eutectic material, and therefore its archival characteristics are excellent. In order to obtain good recording/reproducing performance with respect to the blue-violet laser with a wavelength of about 405 nm, the Sb concentration preferably is 60 atom % or more. If the Sb concentration is less than 60 atom %, the crystallization rate is not high enough to obtain adequate rewriting performance in some cases. If the Sb concentration is more than 90 atom %, the archival characteristics are degraded in some cases. At least one of Ag, In, Te, B, C, Si and Zn may be added thereto at a composition ratio of 15 atom % or less to increase the optical change or to adjust the crystallization rate. When z1 denotes the ratio of the number of Sb atoms to the total number of Sb—Ge atoms as 1, and z2 denotes the atom % of Sb—Ge to the total of a material containing Sb—Ge and M1 added thereto as 100 atom %, the material can be represented by (Sb_{z1}Ge_{1-z1})_{z2}M1_{100-z2}. Preferably M1 is at least one of Ag, In, N, Ge, B, C, Si, and Zn, and 0.6≦z1≦0.9 and 80≦z2<100 are satisfied.

The composition ratio of Sb in the Sb—Th eutectic material can be determined arbitrarily within an appropriate composition range, and the Sb—Te eutectic material, has a high crystallization rate as well as a high crystallization temperature. Although Sb itself has such a high crystallinity that it crystallizes in a thin film state even at room temperature, its archival characteristics are poor and it undergoes only a small optical change. Therefore, Te preferably is added thereto for use. In order to obtain good recording/reproducing performance with respect to the blue-violet laser with a wavelength of about 405 nm, the Sb concentration preferably is 60 atom % or more. If the Sb concentration is less than 60 atom %, the crystallization rate is not high enough to obtain adequate rewriting performance. If the Sb concentration is more than 90 atom %, the archival characteristics are degraded. At least one of Ag, In, and Ge may be added thereto at a composition ratio of 10 atom % or less to increase the crystallization temperature or to ensure the archival characteristics. Alternatively, at least one of B, C, Si and Zn may be added thereto at a composition ratio of 10 atom % or less to ensure the archival overwrite characteristics. These effective factors may be used in combination. When z3 denotes the ratio of the number of Sb atoms to the total number of Sb—Te atoms as 1, and z4 denotes the atom % of Sb—Te to the total of a material containing Sb—Te and M1 added thereto as 100 atom %, the material can be represented by (Sb_{z3}Te_{1z3})_{z4}M1_{100-z4}. Preferably M1 is at least one of Ag, In, N, Ge, B, C, Si, and Zn, and 0.6≦z≦0.9 and 80≦z4<100 are satisfied.

The composition of the recording layer 335 can be analyzed, for example, by high frequency inductively coupled plasma (ICP) emission spectrometry, or with an X-ray microanalyzer (XMA) or an electron probe microanalyzer (EPMA). If the recording layer 335 contains a light element, such as C and B, the XMA or the EPMA, is used suitably.

The recording layer 335 formed by sputtering may unavoidably contain rare gases (Ar, Kr, and Xe), moisture (O—H and H), an organic matter (C), and air (N and O), components (metals) of a jig placed in the sputtering chamber, impurities (metals, metalloids, semiconductors, and dielectrics) contained in the sputtering target, etc. that are present in the sputtering atmosphere, and these are detected by the analysis by ICP emission spectrometry, or with an XMA or an EPMA. The total content of these components (i.e., components other than the components specified above as being contained in the recording layer) may be at most 10 atom %, when the sum total of all the atoms contained in the recording layer is taken as 100 atom %. In this case, the components of the recording layer, except for the other components, may satisfy the preferable composition ratios as described above. This also applies to recording layers 325 and 315 to be described later. This applies also to recording layers 415, 425, 435, 445, 215, 225, and 115 to be described in the following embodiments.

Preferably, the thickness of the recording layer 335 is at least 3 nm but not more than 8 nm. If the thickness is more than 8 nm, the optical transmittance of the third information layer 330 decreases. If the thickness is less than 3 nm, the optical change of the recording layer 335 decreases. Since the crystallization rate of the recording layer decreases as its thickness decreases, the recording layer 335 preferably has a composition ratio that allows it to have a larger crystallization rate than that of the recording layer 325 or the recording layer 315.

Next, the structure of the second information layer 320 is described.

The second information layer 320 is formed by disposing a dielectric layer 321, a reflective layer 322, a dielectric layer 323, an interface layer 324, a recording layer 325, an interface layer 326, and a dielectric layer 327 in this order on one surface of the interlayer 303.

The second information layer 320 is designed to have a high transmittance so that the laser beam 10 can reach the first information layer 310. Specifically, if Tc(%) denotes the optical transmittance of the second information layer 320 when the recording layer 325 is in the crystalline phase, and Ta(%) denotes the optical transmittance of the second information layer 320 when the recording layer 325 is in the amorphous phase, 47%≦(Ta+Tc)/2 preferably holds, and more preferably, 50%≦(Ta+Tc)/2 holds. The second information layer 320 may be designed, for example, to have a transmittance ((Tc+Ta)/2) of 50%, a reflectance Rc of 7%, and a reflectance Ra of 1%. As one example, if (Tc+Ta)/2 is 50%, Tc and Ta may be 49% and 51% respectively. Alternatively, Te and Ta may be 50% and 52% respectively. Tc and Ta preferably are approximate values, but they do not have to be equal to each other.

The dielectric layer 321 has the same functions as those of the dielectric layer 331, and preferable materials therefor also are the same as those of the dielectric layer 331. The thickness of the dielectric layer 321 preferably is at least 10 nm but not more than 30 nm so that the second information layer 320 has a reflectance ratio of at least 4 and a transmittance of at least 47%. The dielectric layer 321 also may be formed of two or more layers.

The reflective layer 322 has the same functions as those of the reflective layer 332, and preferable materials therefor also are the same as those of the reflective layer 332. The thickness of the reflective layer 322 preferably is at least 5 nm but not more than 18 nm. If the thickness is less than 5 nm, the function of diffusing heat deteriorates, which makes it difficult to form marks on the recording layer 325. If the thickness is more than 18 nm, the transmittance of the second information layer 320 decreases to less than 47%.

The dielectric layers 323 and 327 each have a function of adjusting the optical path length nd to adjust the Rc, Ra, Tc, and Ta of the second information layer 320. For example, the optical path length nd of each of the dielectric layer 323 and the dielectric layer 327 can be determined exactly by calculations based on a matrix method so as to satisfy 47%≦(Ta+Tc)/2, 7≦Rc, and Ra≦1.8%. When a dielectric material having a refractive index of 1.5 to 3 is used for the dielectric layers 323 and 327, the thickness of the dielectric layer 327 preferably is at least 10 nm but not more than 70 nm, and more preferably at least 20 nm but not more than 60 nm. The thickness of the dielectric layer 323 preferably is at least 2 nm but not more than 40 nm, and more preferably at least 5 nm but not more than 30 nm.

The material for the dielectric layers 323 and 327 can be selected from among the above-mentioned materials for the dielectric layers 333 and 337.

Like the dielectric layers 333 and 337, the dielectric layers 323 and 327 also may be provided as needed. In the case where the interface layer 324 also has the functions of the dielectric layer 323, the dielectric layer 323 does not necessarily have to be provided. Likewise, in the case where the interface layer 326 also has the functions of the dielectric layer 327, the dielectric layer 327 does not necessarily have to be provided.

The interface layer 324 (dielectric layer a) and the interface layer 326 (dielectric layer b) have the same functions as those of the interface layers 334 and 336, and preferable materials therefor also are the same as those of the interface layers 334 and 336.

Preferably, the thickness of the interface layer 324 is 1 nm or more so that the adhesion to the recording layer 325 can be ensured and atomic diffusion from the other layers to the recording layer 325 can be reduced. Furthermore, the total thickness of the interface layer 324 and the dielectric layer 323 preferably is 50 nm or less, and more preferably 40 nm or less. Since a highly transparent material is used for the interface layer 324, the thickness thereof may be increased up to 50 nm, if it also serves as the dielectric layer 323. Preferably, the thickness of the interface layer 326 is 1 nm or more so that the adhesion to the recording layer 325 can be ensured and atomic diffusion from the other layers to the recording layer 325 can be reduced. Furthermore, to prevent optical influences, the thickness preferably is reduced as the extinction coefficient increases. The total thickness of the interface layer 326 and the dielectric layer 327 preferably is at least 10 nm but not more than 80 nm, and more preferably at least 20 nm but not more than 70 nm.

The recording layer 325 has the same functions as those of the recording layer 335. Since the second information layer 320 is required to have a transmittance of at least 47%, it is preferable that the recording layer 325 have a thickness of at least 3 nm but not more than 9 nm. If the thickness is more than 9 nm, the optical transmittance of the second information layer 320 decreases. If the thickness is less than 3 nm, the optical change of the recording layer 325 decreases. Since the crystallization rate of the recording layer decreases as its thickness decreases, the recording layer 325 preferably has a composition ratio that allows it to have a larger crystallization rate than that of the recording layer 315.

Next, the structure of the first information layer 310 is described.

The first information layer 310 is formed by disposing a reflective layer 312, a dielectric layer 313, an interface layer 314, a recording layer 315, an interface layer 316, and a dielectric layer 317 in this order on one surface of the substrate 301.

Information is recorded on and reproduced from the first information layer 310 by the laser beam 10 that has been attenuated while passing through the third information layer 330 and the second information layer 320. Therefore, the first information layer 310 allows recording to be performed within a range of laser power that can be output, and allows recorded signals to be detected with a reproducing power. Therefore, the first information layer 310 is designed to have a high reflectance and a high optical absorptance, unlike the translucent third information layer 330 and second information layer 320. For example, to obtain an effective Rc-g of at least 1.5%, an Rc-g and an Rc are 19% or more and about 24% or more, respectively.

The reflective layer 312 has the same functions as those of the reflective layer 332. The first information layer 310, however, does not have to be translucent, and therefore the thickness of the reflective layer 312 can be increased and the options for preferable materials also increase. For example, a metal selected from Al, Au, Ag, and Cu, or an alloy of these can be used. In order to enhance the moisture resistance or to adjust the thermal conductivity or the optical properties (such as an optical reflectance, an optical absorptance, and an optical transmittance) of the reflective layer 312, a material obtained by adding another element to the above-mentioned metal or alloy may be used. Preferably, the additive element is at least one selected from Mg, Ca, Sc, Y, Ti, Zr, Hf, V, Nb, Ta, Cr, Mo, W, Mn, Fe, Ru, Os, Co, Rh, Ni, Pd, Pt, Zn, B, Ga, In, C, Si, Ge, Sn, N, Sb, Bi, O, Te, La, Ce, Pr, Nd, Sm, Eu, Gd, Tb, Dy, Ho, Er, Tm, Y, and Lu. In this case, the concentration of the additive element preferably is 3 atom % or less.

Furthermore, the material for the reflective layer 312 preferably has a low optical absorption at the wavelength of the laser beam to be used so as to increase the amount of light to be absorbed into the recording layer 315. The reflective layer 312 containing 97 atom % or more of Ag is used preferably for the first information layer 310 because Ag has a low optical absorption at a wavelength of about 405 nm. Specifically, alloy materials such as Ag—Pd, Ag—Cu, Ag—Bi, Ag—Ga—Cu, Ag—In—Sn, Ag—Pd—Cu, and Ag—Pd—Ti can be used. Among these, Ag—Pd—Cu is used more preferably because it has excellent moisture resistance.

Furthermore, the reflective layer 312 may be formed of two or more layers. In this case, the layer disposed on the side of the substrate 301 may be composed of a dielectric material. The thickness of the reflective layer 312 is adjusted according to the linear velocity of the medium to be used and the composition of the recording layer 315. Preferably, the thickness is at least 40 nm but not more than 300 nm. The reflective layer 312 with a thickness less than 40 nm fails to satisfy the rapid cooling conditions, makes it difficult to diffuse the heat of the recording layer, and thus makes it difficult for the recording layer to become amorphous. The reflective layer 312 with a thickness more than 300 nm goes beyond the rapid cooling conditions, allows the heat of the recording layer 315 to be diffused excessively, and thus the recording sensitivity decreases (that is, a higher laser power is needed).

The dielectric layer 313 and the dielectric layer 317 have the same functions as those of the dielectric layer 333 and the dielectric layer 337, respectively. The preferable materials therefor also are the same. The preferable thicknesses for increasing the Rc to obtain a high Rc/Ra and for increasing the Ac (optical absorptance of the crystalline phase recording layer 315) can be determined by determining accurately the optical path length by, for example, calculations based on a matrix method (see for example, Hiroshi. Kubota, “Wave Optics”, Iwanami Shinsho, 1971, Chapter 3).

In the present embodiment, as one example, the thicknesses of these dielectric layers are determined so that the first information layer 310 satisfies an Rc of 28% and an Ra of 4%. When a dielectric material having a refractive index of 1.5 to 3 is used for the dielectric layer 313 and the dielectric layer 317, the thickness of the dielectric layer 313 preferably is 30 nm or less, and more preferably at least 5 nm but not more than 20 nm. The thickness of the dielectric layer 317 preferably is at least 30 nm but not more than 130 nm, and more preferably at least 30 nm but not more than 100 nm.

Like the dielectric layer 333 and the dielectric layer 337, the dielectric layer 313 and the dielectric layer 317 also can be provided as needed. In the case where the interface layer 314 also has the functions of the dielectric layer 313, the dielectric layer 313 does not necessarily have to be provided. Likewise, in the case where the interface layer 316 also has the functions of the dielectric layer 317, the dielectric layer 317 does not necessarily have to be provided.

The interface layer 314 (dielectric layer a) and the interface layer 316 (dielectric layer b) have the same functions as those of the interface layers 334 and 336, and preferable materials therefor also are the same as those of the interface layers 334 and 336.

Preferably, the thickness of the interface layer 314 is 1 nm or more so that the adhesion to the recording layer 315 can be ensured and atomic diffusion from the other layers to the recording layer 315 can be reduced. Furthermore, the total thickness of the interface layer 314 and the dielectric layer 313 preferably is 40 nm or less, and more preferably at least 5 nm but not more than 30 nm. Since a highly transparent material is used for the interface layer 314, the thickness thereof may be increased up to 40 nm, if it also serves as the dielectric layer 313.

Preferably, the thickness of the interface layer 316 is 1 nm or more so that the adhesion to the recording layer 315 can be ensured and atomic diffusion from the other layers to the recording layer 315 can be reduced. Furthermore, to prevent optical influences, the thickness preferably is reduced as the extinction coefficient increases. The total thickness of the interface layer 316 and the dielectric layer 317 preferably is at least 30 nm but not more than 140 nm, and more preferably at least 30 nm but not more than 110 nm.

The recording layer 315 has the same functions as those of the recording layer 335, and the preferable materials therefor also are the same. Preferably, the thickness of the recording layer 315 is at least 7 nm but not more than 16 nm. If the thickness is more than 16 nm, the heat capacity increases and the laser power required for recording increases. Furthermore, it becomes difficult to diffuse the heat generated in the recording layer 315 toward the reflective layer 312, which makes it difficult to form small recording marks for high density recording. If the thickness is less than 7 nm, the reflectance Ra increases and the Rc/Ra decreases, thereby making it difficult to obtain good read-out signals.

The dielectric layer a and the dielectric layer b of the present invention may be included, in at least one information layer. Preferably, they are included in a translucent information layer. For example, the dielectric layer a and the dielectric layer b of the present invention may be used in all of the information layers included, as in the present embodiment. That is, the interface layers 334, 324, and 314 each may correspond to the dielectric layer a of the present invention, and the interface layers 336, 326, and 316 each may correspond to the dielectric layer b of the present invention. Furthermore, the dielectric layer a and the dielectric layer b are made of a dielectric material having excellent adhesion to a chalcogen-containing recording layer, and can be used together with a (rewritable) recording layer that can undergo a reversible phase change or a (write-once) recording layer that can undergo an irreversible phase change.

Examples of the material for the (rewritable) recording layer that can undergo a reversible phase change include, in addition to the examples shown for the recording layer 335, materials containing compound compositions such as GeTe—SbTe, GeTe—SnTe—SbTe, GeTe—SnTe—SbTe—BiTe, GeTe—SnTe, GeTe—SnTe—BiTe, and GeTe—BiTe, materials such as Ga—Sb and In—Sb containing 50 atom % or more of Sb, and phase-change materials containing 50 atom % or more of Sb.

Examples of the material for the (write-once) recording layer that can undergo an irreversible phase change include oxides containing at least one of Te—O, Sb—O, Ge—O, Sn—O, In—O, Zn—O, Mo—O, and W—O, materials obtaining by stacking two or more layers followed by alloying or reaction at the time of recording, and organic dye-based recording materials.

If the third information layer 330 and the second information layer 320 each include the dielectric layer a and the dielectric layer b of the present invention, the first information layer 310 does not necessarily have to include the dielectric layer a or the dielectric layer b, and it may be a read-only information layer. If the third information layer 330 includes the dielectric layer a and the dielectric layer b of the present invention, the second information layer 320 and the first information layer 310 do not necessarily have to include the dielectric layer a or the dielectric layer b. For example, the second information layer 320 may be a write-once recording layer and the first information layer 310 may be a read-only information layer. In the read-only information layer, a reflective layer made of a material containing at least one of metal elements, metal alloys, dielectrics, dielectric compounds, semiconductor elements, and metalloid elements may be formed on pre-formed recording pits. For example, a reflective layer containing Ag or an Ag alloy may be formed, or the dielectric layer a or the dielectric layer b of the present invention may be formed. Or, a magneto-optical recording layer may be formed in the first information layer 310. Or, the information recording medium may include five or more information layers. The advantageous effects of the present invention can be obtained regardless of how the information recording medium is structured.

The information recording medium 300 can be used in either of the following recording systems: the Constant Linear Velocity (CLV) system; and the Constant Angular Velocity (CANT) system. In the present embodiment, an optical system having an objective lens with a numerical aperture (NA) of 0.85 is used preferably, but an optical system with NA>1 may be used for recording and reproduction. As such an optical system, a solid immersion lens (SIL) or a solid immersion mirror (SIM) can be used. In this case, the interlayer and the transparent layer with a thickness of 5 μm or less may be formed.

Next, the method of producing the information recording medium 300 of the present embodiment will be described.

The information recording medium 300 is obtained by forming the first information layer 310, the interlayer 303, the second information layer 320, the interlayer 304, the third information layer 330, and the transparent layer 302 in this order on the substrate 301. The substrate 301 in which guide grooves (groove surfaces and land surfaces) are formed is placed in a sputtering apparatus. The reflective layer 312, the dielectric layer 313, the interface layer 314, the recording layer 315, the interface layer 316, and the dielectric layer 317 are formed in this order on the surface of the substrate 301 in which the guide grooves are formed. Thus, the first information layer 310 is formed on the substrate 301.

The substrate 301 on which the first information layer 310 has been formed is taken out from the sputtering apparatus, and the interlayer 303 is formed thereon.

The interlayer 303 is formed in the following manner. First, an ultraviolet curable resin is applied onto the surface of the dielectric layer 317, for example, by spin coating. Next, a polycarbonate substrate having a surface on which projections and depressions complementary to the guide grooves to be formed in the interlayer 303 have been formed is prepared, and the surface of the polycarbonate substrate with the projections and depressions is put in contact with the ultraviolet curable resin. The polycarbonate substrate in this state is irradiated with ultraviolet light to cure the resin, and then the substrate with the projections and depressions is removed. As a result, the guide grooves with a complementary shape to the shape of the projections and depressions are formed in the ultraviolet curable resin. Thus, the interlayer 303 having the guide grooves to be formed therein is formed. The shape of the guide grooves formed in the substrate 301 may be the same as or different from the shape of the guide grooves formed in the interlayer 303. As another method for forming the interlayer 303, it is possible to form a layer of an ultraviolet curable resin for protecting the dielectric layer 317 and form thereon a layer having the guide grooves. In this case, the resulting interlayer 303 has a two-layer structure. Or, the interlayer 303 may have a layered structure of three or more layers. Furthermore, the interlayer 303 may be formed by a method other than spin coating, such as printing, ink-jet printing, or casting.

The substrate 301 on which the layers including the interlayer 303 have been formed sequentially is placed in the sputtering apparatus again, and the dielectric layer 321, the reflective layer 322, the dielectric layer 323, the interface layer 324, the recording layer 325, the interface layer 326, and the dielectric layer 327 are formed in this order on the surface of the interlayer 303 having the guide grooves formed therein. Thus, the second information layer 320 is formed on the interlayer 303.

The substrate 301 on which the second information layer 320 has been formed is taken out from the sputtering apparatus, and the interlayer 304 is formed thereon in the same manner as in the case of the interlayer 303.

The substrate 301 on which the layers including the interlayer 304 have been formed sequentially is placed in the sputtering apparatus again, and the dielectric layer 331, the reflective layer 332, the dielectric layer 333, the interface layer 334, the recording layer 335, the interface layer 336, and the dielectric layer 337 are formed in this order on the surface of the interlayer 304 having the guide grooves formed therein. Thus, the third information layer 330 is formed on the interlayer 304.

The substrate 301 on which the layers including the third information layer 330 have been formed is taken out of the sputtering apparatus. Then, the transparent layer 302 is formed on the surface of the dielectric layer 337.

The transparent layer 302 is formed in the following manner. An ultraviolet curable resin is applied onto the surface of the dielectric layer 337, for example, by spin coating, and then irradiated with ultraviolet light to cure the resin. Thus, the transparent layer 302 with a desired thickness can be formed. The transparent layer 302 also can be formed by applying an ultraviolet curable resin onto the surface of the dielectric layer 337 by spin coating, placing a disc-shaped sheet in contact with the applied ultraviolet curable resin, and irradiating the resin with ultraviolet light from the sheet side to cure the resin. The transparent layer 302 also can be formed by placing a disc-shaped sheet having an adhesive layer in contact with the dielectric layer 337.

The transparent layer 302 may be formed of a plurality of layers having different physical properties, and the transparent layer 302 may be formed after another transparent layer is formed on the surface of the dielectric layer 337. Or, after the transparent layer 302 is formed on the surface of the dielectric layer 337, another transparent layer further may be formed on the surface of the transparent layer 302. These transparent layers may have different viscosities, hardnesses, refractive indices, and transparencies. In this way, the transparent layer 302 is formed.

After the formation of the transparent layer 302 is completed, the first information layer 310, the second information layer 320, and the third information layer 330 are initialized, as needed.

The initialization is a step of irradiating the recording layers 315, 325, and 335 in the amorphous state with, for example, a semiconductor laser beam so that the recording layers 315, 325, and 335 are heated to a temperature equal to or higher than their crystallization temperatures and are crystallized. They can be initialized well by optimizing the power of the semiconductor laser, the rotation speed of the information recording medium, the moving speed of the semiconductor laser in the radial direction, the focal point of the laser, etc. The initialization may be performed before or after the transparent layer 302 is formed. It also is possible to perform the initialization of the recording layer 315 after the first information layer 310 is formed and perform the initialization of the recording layer 325 after the interlayer 303 and the second information layer 320 are formed. The advantageous effects of the present invention can be obtained regardless of when the initialization is performed.

The method of forming each layer is described below. In the present embodiment, sputtering is described as an example.

The reflective layers 312, 322, and 332 each are formed by sputtering a sputtering target containing a metal or an alloy constituting the reflective layer. The sputtering may be performed in a rare gas atmosphere or in a mixed gas atmosphere of a rare gas and oxygen gas and/or nitrogen gas, by using a direct current power supply or a high frequency power supply. Any of Ar gas, Kr gas, and Xe gas may be used as the rare gas.

The dielectric layers 313, 317, 321, 323, 327, 331, 333, and 337 each also are formed by sputtering a sputtering target containing an element, a mixture, or a compound constituting the dielectric layer. The sputtering may be performed in a rare gas atmosphere or in a mixed gas atmosphere of a rare gas and oxygen gas and/or nitrogen gas, by using a high frequency power supply. A direct current power supply or a pulse generating type direct current power supply may be used, if possible. Any of Ar gas, Kr gas, and Xe gas may be used as the rare gas. In the case of forming a dielectric layer containing an oxide, oxygen deficiency may occur during sputtering. Therefore, the sputtering may be performed using a sputtering target with which the occurrence of oxygen deficiency can be reduced, or in a mixed gas atmosphere of a rare gas with a small amount (10% or less) of oxygen gas.

The interface layers 314, 316, 324, 326, 334, and 336 each also are formed by sputtering a sputtering target containing an element, a mixture, or a compound constituting the interface layer. The sputtering may be performed in a rare gas atmosphere or in a mixed gas atmosphere of a rare gas and oxygen gas and/or nitrogen gas, by using a high frequency power supply. A direct current power supply or a pulse generating type direct current power supply may be used, if possible. Any of Ar gas, Kr gas, and Xe gas may be used as the rare gas.

The material and the composition of the sputtering target are determined so that the interface layers can be formed of the materials of the dielectric layer a and the dielectric layer b of the present invention. In some sputtering apparatuses used, the composition of the sputtering target may not be the same as that of the interface layer to be formed. In this case, the composition of the sputtering target can be adjusted to obtain the interface layer with a desired composition. Oxides are susceptible to oxygen deficiency during sputtering. Therefore, the sputtering may be performed using a sputtering target with which the occurrence of oxygen deficiency can be reduced, or in a mixed gas atmosphere of a rare gas with a small amount (10% or less) of oxygen gas. For example, in the case where the interface layer represented by (Al₂O₃)₇₀(Cr₂O₃)₃₀ (mol %) is formed, the sputtering may be performed in a rare gas atmosphere or in a mixed gas atmosphere of a rare gas and a small amount of oxygen gas, by using a sputtering target represented by (Al₂O₃)₇₀(Cr₂O₃)₃₀ (mol %).

The interface layer also can be formed by using a plurality of power supplies to perform simultaneous sputtering (co-sputtering) of sputtering targets, each made of a single compound. The interface layer also can be formed by using a plurality of power supplies to perform simultaneous sputtering of binary sputtering targets, ternary sputtering targets, etc., each made of a combination of at least two compounds. When these sputtering targets are used, the sputtering may be performed in a rare gas atmosphere or in a mixed gas atmosphere of a rare gas and oxygen gas and/or nitrogen gas.

The recording layers 315, 325, and 335 each are formed by sputtering a sputtering target containing the material constituting the recording layer. The sputtering may be performed in a rare gas atmosphere or in a mixed gas atmosphere of a rare gas and oxygen gas and/or nitrogen gas, by using a direct current power supply, a high frequency power supply, or a pulse generating type direct current power supply. Any of Ar gas, Kr gas, and Xe gas may be used as the rare gas. In some sputtering apparatus used, the composition of the sputtering target may not be the same as that of the recording layer to be formed. In this case, the composition of the sputtering target can be adjusted to obtain the recording layer with a desired composition. When simultaneous sputtering of a plurality of sputtering targets is performed, the output from each of the power supplies is adjusted to control the composition, so that the recording layer with a desired composition can be obtained. In the case of reactive sputtering, the flow rates and pressures of oxygen gas and nitrogen gas, and the flow rate ratios and the pressure ratios of oxygen gas and nitrogen gas with respect to those of the rare gas are adjusted in addition to the adjustments of the sputtering target composition and the power supply output, so that the recording layer with a desired composition can be obtained.

In the present embodiment, sputtering is used as a method of forming each layer, but the method is not limited to sputtering. Vacuum vapor deposition, ion plating, chemical vapor deposition (CVD), or molecular beam epitaxy MBE), etc. also can be used.

In this way, the information recording medium 300 of the first embodiment can be produced.

The advantageous effects of the present invention can be obtained regardless of how the information recording medium of the present invention is structured, as long as the dielectric layer a and the dielectric layer b of the present invention are used for the layers adjacent to the recording layers. For example, the structure of the present invention also can be applied to the structure obtained by forming the third information layer 330, the interlayer 304, the second information layer 320, the interlayer 303, and the first information layer 310 in this order on the transparent layer 302 as a transparent supporting substrate and finally bonding the substrate 312 thereon with an ultraviolet curable resin or the like. The substrate may be bonded at the position of any of the interlayers. The same applies to the following second to fourth embodiments.

### Second Embodiment

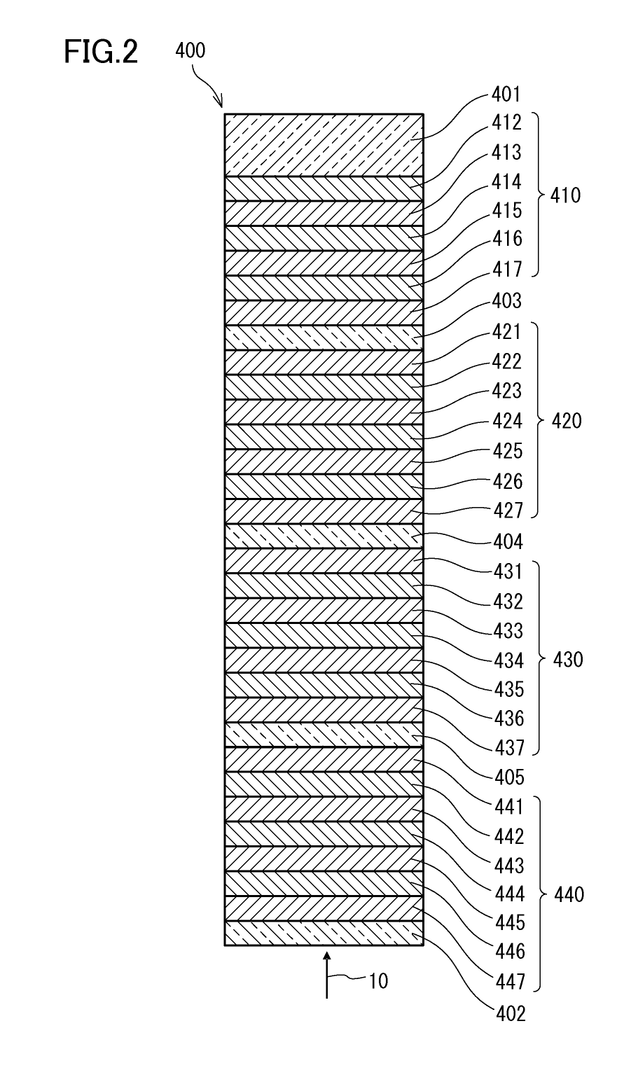

An example of the information recording medium will be described as the second embodiment of the present invention. FIG. 2 shows a partial sectional view of the information recording medium 400. The information recording medium 400 is formed by disposing a first information layer 410, an interlayer 403, a second information layer 420, an interlayer 404, a third information layer 430, an interlayer 405, a fourth information layer 440, and a transparent layer 402 in this order on a substrate 401. That is, the information recording medium 400 according to the present embodiment is an information recording medium including N (where N is an integer of 2 or more) information layers, and N is 4 in this case. In the present embodiment, since the dielectric layer a and the dielectric layer b of the present invention are used in all the first to fourth information layers 410 to 440, all of these information layers correspond to the L-th information layer of the information recording medium of the present invention. But the present invention is not limited to this, and at least one of the first to fourth information layers 410 to 430 may correspond to the L-th information layer.

The first information layer 410 is formed by disposing a reflective layer 412, a dielectric layer 413, an interface layer 414, a recording layer 415, an interface layer 416, and a dielectric layer 417 in this order on one surface of the substrate 401. The second information layer 420 is formed by disposing a dielectric layer 421, a reflective layer 422, a dielectric layer 423, an interface layer 424, a recording layer 425, an interface layer 426, and a dielectric layer 427 in this order on one surface of the interlayer 403. The third information layer 430 is formed by disposing a dielectric layer 431, a reflective layer 432, a dielectric layer 433, an interface layer 434, a recording layer 435, an interface layer 436, and a dielectric layer 437 in this order on one surface of the interlayer 404. The fourth information layer 440 is formed by disposing a dielectric layer 441, a reflective layer 442, a dielectric layer 443, an interface layer 444, a recording layer 445, an interface layer 446, and a dielectric layer 447 in this order on one surface of the interlayer 405.

The first information layer 410 to the third information layer 430 correspond to the first information layer 310 to the third information layer 330 of the first embodiment. Each of the information layers 410 to 430 includes layers that are disposed in the same order as in the corresponding information layer, and the functions and materials of the included layers also are the same as those in the corresponding information layer. The fourth information layer 440 also corresponds to the third information layer 330 of the first embodiment. The information layer 440 includes layers that are disposed in the same order as in the corresponding information layer, and the functions and materials of the included layers also are the same as those in the corresponding information layer. The thickness of each of the layers may be optimized to satisfy a desired effective reflectance. During recording and reproduction, the thicknesses of the interlayer 403, 404, and 405 are optimized in the same manner as in the first embodiment to prevent interference between the information layers.

The dielectric layer a of the present invention corresponds to the interface layers 414, 424, 434, and 444, and the dielectric layer b of the present invention corresponds to the interface layers 416, 426, 436, and 446. Even with an increased number of information layers, the resulting advantageous effects of the present invention are the same as described in the first embodiment.

Also in the present embodiment, the laser beam 10 is allowed to be incident on the transparent layer 402 side. Information is recorded on and reproduced from the first information layer 410 by the laser beam 10 that has passed through the fourth information layer 440, the third information layer 430, and the second information layer 420. In the information recording medium 400, information can be recorded on each of the four recording layers. For example, when a laser beam with a wavelength of about 405 nm in the blue-violet region is used for recording and reproduction, an information recording medium having a capacity of 133 GB, which is approximately 1.3 times larger than the capacity obtained in the above first embodiment, can be obtained. The information recording medium 400 also may be used according to the CLV or CAV system.

In the present embodiment, the structure, in which the dielectric layer a and the dielectric layer b of the present invention are used in all the first to fourth information layers 410 to 440, has been described. But the present invention is not limited to this structure, and the dielectric layer a and the dielectric layer b in the present invention may be used in at least one information layer, as in the case of the first embodiment. Preferably, they are used in a translucent information layer.

### Third Embodiment

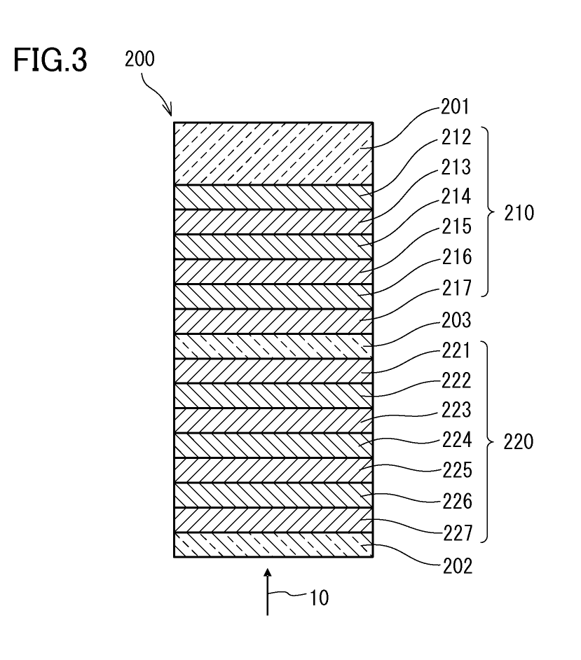

An example of the information recording medium will be described as the third embodiment of the present invention. FIG. 3 shows a partial sectional view of the information recording medium 200. The information recording medium 200 is formed by disposing a first information layer 210, an interlayer 203, a second information layer 220, and a transparent layer 202 in this order on a substrate 201. That is, the information recording medium 200 according to the present embodiment is an information recording medium including N (where N is an integer of 2 or more) information layers, and N is 2 in this case. In the present embodiment, since the dielectric layer a and the dielectric layer b of the present invention are used in both of the first information layers 210 and the second information layers 220, all of the information layers correspond to the L-th information layer of the information recording medium of the present invention. But the present invention is not limited to this, and at least one of the first second information layer 210 and the second information layer 220 may correspond to the L-th information layer.

The first information layer 210 is formed by disposing a reflective layer 212, a dielectric layer 213, an interface layer 214, a recording layer 215, an interface layer 216, and a dielectric layer 217 in this order on one surface of the substrate 201. The second information layer 220 is formed by disposing a dielectric layer 221, a reflective layer 222, a dielectric layer 223, an interface layer 224, a recording layer 225, an interface layer 226, and a dielectric layer 227 in this order on one surface of the interlayer 203.

The first information layer 210 and the second information layer 220 correspond to the first information layer 310 and the second information layer 320 of the first embodiment. Each of the information layers 210 and 220 includes layers that are disposed in the same order as in the corresponding information layer, and the functions and materials of the included, layers also are the same as those in the corresponding information layer. The thickness of each of the layers may be optimized to satisfy a desired effective reflectance. During recording and reproduction, the thickness of the interlayer 203 is optimized in the same manner as in the first embodiment to prevent interference between the information layers.

The dielectric layer a of the present invention corresponds to the interface layers 214 and 224, and the dielectric layer b of the present invention corresponds to the interface layers 216 and 226. Even with a decreased number of information layers, the resulting advantageous effects of the present invention are the same as described in the first embodiment.

Also in the present embodiment, the laser beam 10 is allowed to be incident on the transparent layer 202 side. Information is recorded on and reproduced from the first information layer 210 by the laser beam 10 that has passed through the second information layer 220. In the information recording medium 200, information can be recorded on each of the two recording layers. For example, when a laser beam with a wavelength of about 405 nm in the blue-violet region is used for recording and reproduction, an information recording medium having a capacity of 67 GB, which is approximately 0.67 times smaller than the capacity obtained in the above first embodiment, can be obtained. The information recording medium 200 also may be used according to the CLV or CAV system.

In the present embodiment, the structure, in which the dielectric layer a and the dielectric layer b of the present invention are included in the first information layer 210 and the second information layer 220, has been described. But the present invention is not limited to this structure, and the dielectric layer a and the dielectric layer b of the present invention may be included in at least one information layer, as in the case of the first embodiment. Preferably, they are included in the second information layer 220 that is a translucent information layer.

### Fourth Embodiment

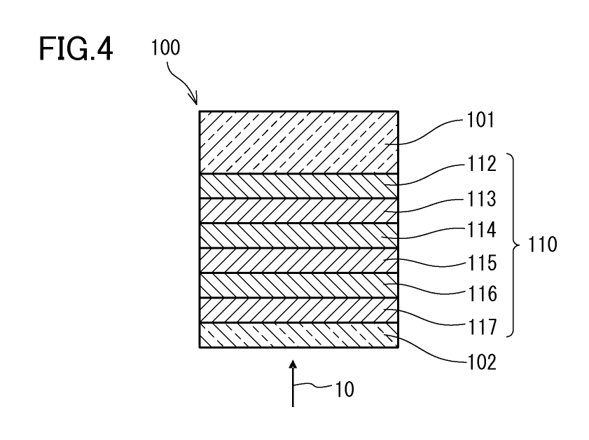

An example of the information recording medium will be described as the fourth embodiment of the present invention. FIG. 4 shows a partial sectional view of the information recording medium 100. The information recording medium 100 is formed by disposing an information layer 110 and a transparent layer 102 in this order on a substrate 101. Furthermore, the first information layer 110 is formed by disposing a reflective layer 112, a dielectric layer 113, an interface layer 114, a recording layer 115, an interface layer 116, and a dielectric layer 117 in this order on one surface of the substrate 101.

The information recording medium 100 can be used as, for example, a Blu-ray Disc having a capacity of 25 GB or more, for recording and reproducing information by the laser beam 10 with a wavelength of about 405 nm in the blue-violet region. The laser beam 10 is incident on the information recording medium 100 thus structured from the transparent layer 102 side, and thereby, the recording and reproduction of information can be performed.

The information layer 110 corresponds to the first information layer 310 of the first embodiment. The information layer 110 includes layers that are disposed in the same order as in the corresponding information layer, and the functions and materials of the included layers also are the same as those in the corresponding information layer. The thickness of each of the layers may be optimized to satisfy a desired effective reflectance. The dielectric layer a of the present invention corresponds to the interlayer 114, and the dielectric layer b of the present invention corresponds to the interface layer 116. Even in the information recording medium including one information layer, the resulting advantageous effects of the present invention are the same as described in the first embodiment.

### EXAMPLES

Next, the present invention will be described in detail by way of examples.

### Example 1

In Example 1, the optical constants (complex refractive indices) (dielectric layer a: na-ika (na: refractive index, ka: extinction coefficient), dielectric layer b: nb-ikb (nb: refractive index, kb: extinction coefficient)) of the materials used for the dielectric layer a and the dielectric layer b were examined experimentally by light with a wavelength of 405 nm. Samples used for the calculations of the optical constants were each prepared by forming a dielectric layer with a thickness of about 20 nm on a quartz substrate. The thicknesses needed for the calculations of the optical constants were measured by the stylus method, and the optical constants were calculated by ellipsometry. The samples No. 1-1 to 1-10 are the materials for the dielectric layer a, and the samples No. 1-11 to 1-25 are the materials for the dielectric layer b. As a comparative example, a sample with a composition of (ZrO₂)₂₀(Cr₂O₃)₈₀ was prepared.

The production method of each sample is described. Sputtering targets represented by the same composition formulas as those of the dielectric layers shown in Tables 1-1 to 1-3 were used. As the sample 1-1, for example, a dielectric layer a represented by (Al₂O₃)₈₀(Cr₂O₃)₂O (mol %) was formed by sputtering a sputtering target represented by (Al₂O₃)₈₀(Cr₂O₃)₂₀ (mol %). Each sputtering target was 200 mm in diameter and 6 mm in thickness, and it was mounted on the cathode of an RF (radio-frequency) power supply in a sputtering apparatus. A quartz substrate (12 mm×18 mm×1.1 mm thick) was set on a jig, and the jig was mounted to face the sputtering target in a vacuum chamber. The sputtering target was sputtered in an Ar gas atmosphere with a pressure of 0.13 Pa at a power of 3 kW. Thus, each dielectric layer was deposited on the quartz substrate.

The calculation results of the optical constants are shown in Table 1-1, Table 1-2, and Table 1-3.

Table 1-1 shows the results of the materials used for the dielectric layer a. The compositions represented by (D)ₕ(Cr₂O₃)₁₀₀₋ₕ (mol %) were converted into the compositions represented by M_{c}Cr_{d}O_{100-c-d} (atom %), and both of these compositions are shown in Table 1-1. For example, in the case where (Al₂O₃)₈₀(Cr₂O₃)₂₀ (mol %) was converted into atom %, 160 Al atoms, 40 Cr atoms, and 300 O atoms were added up to 500 atoms, and the percentage of the atoms of each element, Al, Cr, and O in the total 500 atoms was calculated. As a result, Al: 160×100/500=32, Cr: 40×100/500=8, and O: 300×100/500=60 were obtained.

Table 1-2 shows the results of the materials used for the dielectric layer b. The compositions represented by (AO₂)ⱼ(Cr₂O₃)₁₀₀₋ⱼ (mol %) were converted into the compositions represented by A_{f}Cr_{g}O_{100-f-g} (atom %), and both of these compositions are shown in Table 1-2.

Table 1-3 shows the results of the materials containing the oxide L used for the dielectric layer b. The compositions represented by (AO₂)ₚ(Cr₂O₃)ₜ(L)₁₀₀₋ₚ₋ₜ (mol %) were converted into the compositions represented by AₖCrₘXₙO₁₀₀₋ₖ₋ₘ₋ₙ (atom %), and both of these compositions are shown in Table 1-3.

TABLE 1-1

| | Dielectric layer a | | Complex refractive index |
|---|---|---|---|
| Sample No. | (D)ₕ(Cr₂O₃)₁₀₀₋ₕ (mol %) | M_{c}Cr_{d}O_{100-c-d} (atom %) | na-ika |
| 1-1 | (Al₂O₃)₈₀(Cr₂O₃)₂₀ | Al₃₂Cr₈O₆₀ | 1.87-i0.02 |
| 1-2 | (Dy₂O₃)₈₀(Cr₂O₃)₂₀ | Dy₃₂Cr₈O₆₀ | 2.18-i0.03 |
| 1-3 | (Nb₂O₅)₈₀(Cr₂O₃)₂₀ | Nb_{24.2}Cr_{6.1}O_{69.7} | 2.55-i0.03 |
| 1-4 | (SiO₂)₈₀(Cr₂O₃)₂₀ | Si_{23.5}Cr_{11.8}O_{64.7} | 1.72-i0.02 |
| 1-5 | (TiO₂)₈₀(Cr₂O₃)₂₀ | Ti_{23.5}Cr_{11.8}O_{64.7} | 2.69-i0.03 |
| 1-6 | (Y₂O₃)₈₀(Cr₂O₃)₂₀ | Y₃₂Cr₈O₆₀ | 2.10-i0.03 |
| 1-7 | (Al₆Si₂O₁₃)₈₀(Cr₂O₃)₂₀ | Al_{27.0}Si_{9.0}Cr_{2.2}O_{61.8} | 1.81-i0.02 |
| 1-8 | (Al₂TiO₅)₈₀(Cr₂O₃)₂₀ | Al_{21.6}Ti_{10.8}Cr_{5.4}O_{62.2} | 2.28-i0.03 |
| 1-9 | (Al₂O₃)₈₀(Cr₂O₃)₁₀(In₂O₃)₁₀ | Al₃₂Cr₄In₄O₆₀ | 1.81-i0.01 |
| 1-10 | (Al₂O₃)₈₀(Cr₂O₃)₁₀(Ga₂O₃)₁₀ | Al₃₂Cr₄Ga₄O₆₀ | 1.79-i0.01 |
| Comparative | (ZrO₂)₂₀(Cr₂O₃)₈₀ | Zr_{4.3}Cr_{34.8}O_{60.9} | 2.60-i0.13 |
| Example 1 | | | |

As shown in Table 1-1, the samples Nos. 1-1 to 1-8 satisfied ka≦0.03. A comparison with the sample of Comparative Example shows that when Al₂O₃, Dy₂O₃, Nb₂O₅, SiO₂, TiO₂, Y₂O₃, Al₆Si₂O₁₃, and Al₂TiO₅ having better adhesion to the recording layer than ZrO₂ were used, the content of Cr₂O₃ added could be reduced, resulting in reductions of extinction coefficients to 0.03 or less. Furthermore, as shown in the results of the samples No. 1-9 and No. 1-10, when a part of Cr₂O₃ was substituted by In₂O₃ or Ga₂O₃, ka values decreased to 0.01.

TABLE 1-2

| | Dielectric layer b | | Complex refractive index |
|---|---|---|---|
| Sample No. | (AO₂)ⱼ(Cr₂O₃)₁₀₀₋ⱼ (mol %) | A_{f}Cr_{g}O_{100-f-g} (atom %) | nb-ikb |
| 1-11 | (ZrO₂)₅₀(Cr₂O₃)₅₀ | Zr_{12.5}Cr₂₅O_{62.5} | 2.44-i0.08 |
| 1-12 | (HfO₂)₅₀(Cr₂O₃)₅₀ | Hf_{12.5}Cr₂₅O_{62.5} | 2.42-i0.07 |
| 1-13 | (ZrO₂)₂₅(HfO₂)₂₅(Cr₂O₃)₅₀ | Zr_{6.3}Hf_{6.3}Cr₂₅O_{62.4} | 2.43-i0.07 |
| 1-14 | (ZrO₂)₅₀(Cr₂O₃)₃₀(In₂O₃)₂₀ | Zr_{12.5}Cr₁₅In₁₀O_{62.5} | 2.32-i0.05 |
| 1-15 | (ZrO₂)₅₀(Cr₂O₃)₃₀(Ga₂O₃)₂₀ | Zr_{12.5}Cr₁₅Ga₁₀O_{62.5} | 2.29-i0.04 |

As shown in Table 1-2, the samples No. 1-11 to No. 1-15 satisfied kb≦0.08.

The samples No. 1-12 to No. 1-15 that satisfied kb≦0.07 were preferable materials. As shown in the results of the samples No. 1-12 and No. 1-13, the materials containing HfO₂ had slightly reduced kb values. Furthermore, as shown in the results of the samples No. 1-14 and No. 1-15, when a part of Cr₂O₃ was substituted by In₂O₃ or Ga₂O₃, kb values further decreased to 0.05 or less.

TABLE 1-3

| | Dielectric layer b | | Complex refractive index |
|---|---|---|---|
| Sample No. | (AO₂)ₚ(Cr₂O₃)ₜ(L)₁₀₀₋ₚ₋ₜ (mol %) | AₖCrₘXₙO₁₀₀₋ₖ₋ₘ₋ₙ (atom %) | nb-ikb |
| 1-16 | (ZrO₂)₂₅(Cr₂O₃)₅₀(Al₂O₃)₂₅ | Zr_{5.6}Cr_{22.2}Al_{11.1}O_{61.1} | 2.31-i0.06 |
| 1-17 | (ZrO₂)₂₅(Cr₂O₃)₅₀(Dy₂O₃)₂₅ | Zr_{5.6}Cr_{22.2}Dy_{11.1}O_{61.1} | 2.41-i0.07 |
| 1-18 | (ZrO₂)₂₅(Cr₂O₃)₅₀(Nb₂O₅)₂₅ | Zr₅Cr₂₀Nb₁₀O₆₅ | 2.52-i0.07 |
| 1-19 | (ZrO₂)₂₅(Cr₂O₃)₅₀(SiO₂)₂₅ | Zr_{6.3}Cr₂₅Si_{6.3}O_{62.4} | 2.26-i0.06 |
| 1-20 | (ZrO₂)₂₅(Cr₂O₃)₅₀(TiO₂)₂₅ | Zr_{6.3}Cr₂₅Ti_{6.3}O_{62.4} | 2.57-i0.07 |
| 1-21 | (ZrO₂)₂₅(Cr₂O₃)₅₀(Y₂O₃)₂₅ | Zr_{6.6}Cr_{22.2}Y_{11.1}O_{61.1} | 2.38-i0.07 |
| 1-22 | (ZrO₂)₂₅(Cr₂O₃)₅₀(Al₆Si₂O₁₃)₂₅ | Zr_{2.9}Cr_{11.8}Al_{17.6}Si_{6.9}O_{61.8} | 2.29-i0.06 |
| 1-23 | (ZrO₂)₂₅(Cr₂O₃)₅₀(Al₂TiO₅)₂₅ | Zr_{4.8}Cr₁₉Al_{9.5}Ti_{4.8}O_{61.9} | 2.44-i0.07 |
| 1-24 | (HfO₂)₂₅(Cr₂O₃)₅₀(Al₂O₃)₂₅ | Hf_{5.6}Cr_{22.2}Al_{11.1}O_{61.1} | 2.30-i0.06 |
| 1-25 | (ZrO₂)₁₅(HfO₂)₁₀(Cr₂O₃)₅₀(Al₂O₃)₂₅ | Zr_{3.3}Hf_{2.2}Cr_{22.2}Al_{11.1}O_{61.2} | 2.31-i0.06 |

As shown in Table 1-3, the samples No. 1-16 to No. 1-25 satisfied kb≦0.07.

Among them, the kb values of the samples No. 1-16, No. 1-24, and No. 1-25 containing Al₂O₃, the sample No. 1-19 containing SiO₂, and the sample No. 1-22 containing Al₆Si₂O₁₃ decreased to 0.06 or less.

Since the dielectric layer b is required to have high heat resistance in addition to excellent adhesion to the recording layer, it contains Cr, O, and at least one element A selected from Zr and Hf. Since the dielectric layer b having this composition has a higher Cr concentration than the dielectric layer a, the extinction coefficient of the dielectric layer b is greater than that of the dielectric layer a.

To increase the Rc/Ra of the information recording medium as much as possible, it is effective to (1) decrease the extinction coefficients of the dielectric layer a and the dielectric layer b as much as possible, or (2) make the refractive index nb of the dielectric layer b higher than the refractive index na of the dielectric layer a. It is better if both of (1) and (2) are achieved. Effective combinations of the dielectric layer a and the dielectric layer b can be obtained based on the results of this example. For example, since the sample No. 1-1 has a low refractive index na, if it is combined with any of the samples No. 1-11 to No. 1-25, a high Rc/Ra value can be obtained. Since the samples No. 1-3 and No. 1-5 have high refractive indices na, if they are combined with the sample No. 1-18 or No. 1-20, the effect of a low ka value can be obtained.

### Example 2

In Example 2, the information recording medium 300 of FIG. 1 was produced, and the relationship between the materials for the interface layer 324 (dielectric layer a) of the second information layer 320 and the adhesion to the recording layer 325 was examined. (ZrO₂)₅₀(Cr₂O₃)₅₀ (mol %) having excellent adhesion to the recording layer 325 was used for the interface layer 326 corresponding to the dielectric layer b, and (Al₂O₃)ₕ(Cr₂O₃)₁₀₀₋ₕ (mol %) was used for the interface layer 324.

Hereinafter, the present example is described specifically. First, the production method of the information recording medium 300 is described.

The material and the thickness of each layer are described. As the substrate 301, a polycarbonate substrate (120 mm in diameter and 1.1 mm in thickness) with guide grooves (20 nm in depth and 0.32 μm in groove-to-groove distance) formed therein was prepared, and mounted in a sputtering apparatus. On the surface of the substrate 301 in which the guide grooves had been formed, a 100-nm-thick Ag—Cu alloy layer serving as the reflective layer 312, a 20-nm-thick (ZrO₂)₄₀(SiO₂)₄₀(Cr₂O₃)₂₀ (mol %) layer serving as the dielectric layer 313, a 5-nm-thick (ZrO₂)₅₀(Cr₂O₃)₅₀ (mol %) layer serving as the interface layer 314, a 12-nm-thick Ge₄₅Sb₄Te₅₁ (atom %) layer serving as the recording layer 315, a 5-nm-thick (ZrO₂)₅₀(Cr₂O₃)₅₀ (mol %) layer serving as the interface layer 316, and a 60-nm-thick (ZnS)₈₀(SiO₂)₂₀ (mol %) layer serving as the dielectric layer 317 were formed in this order. Thus, the first information layer 310 was formed.

Next, the interlayer 303 having guide grooves was formed with a thickness of 25 μm on the surface of the dielectric layer 317. On the surface of the interlayer 303 in which the guide grooves had been formed, a 20-nm-thick Bi₄Ti₃O₁₂ layer serving as the dielectric layer 321, a 9-nm-thick Ag—Pd—Cu alloy layer serving as the reflective layer 322, a 10-nm-thick Al₂O₃ layer serving as the second dielectric layer 323, a 5-nm-thick interface layer 324, a 7-nm-thick Ge₄₅Sb₃In₁Te₅₁ layer serving as the recording layer 325, a 5-nm-thick (ZrO₂)₅₀(Cr₂O₃)₅₀ (mol %) layer serving as the interface layer 326, and a 40-nm-thick (ZnS)₈₀(SiO₂)₂₀ (mol %) layer serving as the dielectric layer 327 were formed in this order. Thus, the second information layer 320 was formed.

The interface layers 324 were fabricated using the materials shown in the rows of medium samples No. 2-1 to No. 2-7 of Table 2. For the samples of Comparative Examples 2 to 4, the materials shown in Table 2 were used.

Next, the interlayer 304 having guide grooves was formed with a thickness of 18 μm on the surface of the dielectric layer 327. On the surface of the interlayer 304 in which the guide grooves had been formed, a 15-nm-thick Bi₄Ti₃O₁₂ layer serving as the dielectric layer 331, a 8-nm-thick Ag—Pd—Cu alloy layer serving as the reflective layer 332, a 6-nm-thick Al₂O₃ layer serving as the dielectric layer 333, a 5-nm-thick (ZrO₂)₅₀(Cr₂O₃)₅₀ (mol %) layer serving as the interface layer 334, a 6-nm-thick Ge₄₅Sb₃In₁Te₅₁ layer serving as the recording layer 335, a 5-nm-thick (ZrO₂)₅₀(Cr₂O₃)₅₀ (mol %) layer serving as the interface layer 336, and a 35-nm-thick (ZnS)₈₀(SiO₂)₂₀ (mol %) layer serving as the dielectric layer 337 were formed in this order. Thus, the third information layer 330 was formed.

The sputtering conditions for each layer are described. All of the sputtering targets used had a round shape, and were 200 mm in diameter and 6 mm in thickness.

The dielectric layers 321 and 331 were formed by sputtering a Bi₄Ti₃O₁₂ target in a mixed gas atmosphere of Ar gas and O₂ gas with a volume ratio of 973 at a pressure of 0.13 Pa using a high frequency power supply with an output power of 2 kW.

The reflective layer 312 was formed by sputtering an Ag—Pd—Cu alloy target in an Ar gas atmosphere at a pressure of 0.2 Pa using a direct current power supply with an output power of 2 kW. The reflective layers 322 and 332 were each formed by sputtering an Ag—Pd—Cu alloy target in an Ar gas atmosphere at a pressure of 0.2 Pa using a direct current power supply with an output power of 200 W.

The dielectric layer 313 was formed by sputtering a (ZrO₂)₄₀(SiO₂)₄₀(Cr₂O₃)₂₀ (mol %) target in art Ar gas atmosphere at a pressure of 0.13 Pa using a high frequency power supply with an output power of 3 kW.

The dielectric layers 317, 327, and 337 were each formed by sputtering a (ZnS)₈₀(SiO₂)₂₀ (mol %) target in an Ar gas atmosphere at a pressure of 0.13 Pa using a high frequency power supply with an output power of 2.5 kW.

The interface layers 314, 316, 326, 334, and 336 were each formed by sputtering a (ZrO₂)₅₀(Cr₂O₃)₅O (mol %) target in an Ar gas atmosphere at a pressure of 0.13 Pa using a high frequency power supply with an output power of 3 kW.

The interface layer 324 was formed by sputtering a sputtering target represented by the same composition formula as that of the interface layer 324 shown in Table 2 in an Ar gas atmosphere at a pressure of 0.13 Pa using a high frequency power supply with an output power of 3 kW. Likewise, the interface layers 324 of Comparative Examples 2 to 4 were formed by sputtering an Al₂O₃ target, a Cr₂O₃ target, and a (ZrO₂)₂₀(Cr₂O₃)₈₀ (mol %) target at an output power of 2 kW, 3 kW, and 3 kW, respectively.

The recording layer 315 was formed by sputtering a Ge—Sb—Te alloy target in an Ar gas atmosphere at a pressure of 0.13 Pa using a pulse generating type direct current power supply with an output power of 200 W. The recording layer 325 was formed by sputtering a Ge—Sb—In—Te alloy target in an Ar gas atmosphere at a pressure of 0.13 Pa using a pulse generating type direct current power supply with an output power of 200 W. The recording layer 335 was formed by sputtering a Ge—Bi—In—Te alloy target in an Ar gas atmosphere at a pressure of 0.13 Pa using a pulse generating type direct current power supply with an output power of 200 W.

The substrate 301 including the third information layer 330 that had been formed on the interlayer 304 in the manner as mentioned above was taken out of the sputtering apparatus. Then, an ultraviolet curable resin was applied with a thickness of 57 μm onto the surface of the dielectric layer 337 by spin coating, and was irradiated with ultraviolet light and cured. Thus, the transparent layer 302 was formed.

After the transparent layer 302 was formed, the initialization was performed. Almost the entire surface of the circular region with a radius of 22 to 60 mm of each of the recording layers 315, 325, and 335 of the information recording medium 300 was crystallized using a semiconductor laser with a wavelength of 810 nm.

The interlayer 303 was formed in the following manner. First, an ultraviolet curable resin was applied onto the surface of the dielectric layer 317 by spin coating. Next, a polycarbonate substrate having a surface on which projections and depressions (with a depth of 20 nm, and a groove-to-groove distance of 0.32 μm) complementary to the guide grooves to be formed in the interlayer 303 had been formed was prepared, and the surface of the polycarbonate substrate with the projections and depressions was put in contact with the ultraviolet curable resin. The ultraviolet curable resin in this state was irradiated with ultraviolet light to cure the resin, and then the substrate with the projections and depressions was removed. As a result, the guide grooves having the same shape as that of the grooves of the substrate 301 were formed on the surface of the interlayer 303. The interlayer 304 was formed on the surface of the dielectric layer 327 in the same manner.

Next, the method for evaluating the information recording medium is described. The adhesion of the interface layer 324 in the second information layer 320 of the information recording medium 300 was evaluated based on whether the interface layer 324 had peeling or not under the high temperature and high moisture conditions. Specifically, the initialized information recording medium 300 was allowed to stand in a constant temperature and humidity chamber at a temperature of 85° C. and a relative humidity of 85%. Then, the medium 300 was taken out of the chamber 50 hours later, 100 hours later, 200 hours later, and 300 hours later, respectively, and was observed visually with an optical microscope. When the interface layer 324 was observed, with reflected light, through the third information layer 330 from the transparent layer 302 side, the peeling was seen as circular or elliptical interference fringes. As might be expected, an unpeeled sample was evaluated as good in adhesion, and a peeled sample was evaluated as poor in adhesion.

Furthermore, the complex refractive indices of the interface layers 324 used in the medium samples No. 2-1 to No. 2-7 and the samples of Comparative Examples 2 to 4 were calculated in the same manner as in Example 1.

Table 2 shows the results of the adhesion test and the complex refractive indices.

TABLE 2

| | Interface layer 324 | | | | | | | | |
|---|---|---|---|---|---|---|---|---|---|
| Medium | (Dielectric layer a) | Accelerated adhesion test | | | | | Complex refractive index | | Compre- |
| Sample | (D)ₕ(Cr₂O₃)₁₀₀₋ₕ | Standing time (hours) at 85° C. and 85% | | | | | (wavelength of 405 nm) | | hensive |
| No. | (mol %) | 50 | 100 | 200 | 300 | Evaluation | na-ika | Evaluation | evaluation |
| 2-1 | (Al₂O₃)₄₀(Cr₂O₃)₆₀ | ◯ | ◯ | ◯ | ◯ | [symbol] | 2.28-i0.09 | Δ | Δ |
| 2-2 | (Al₂O₃)₅₀(Cr₂O₃)₅₀ | ◯ | ◯ | ◯ | ◯ | [symbol] | 2.18-i0.07 | ◯ | ◯ |
| 2-3 | (Al₂O₃)₆₀(Cr₂O₃)₄₀ | ◯ | ◯ | ◯ | ◯ | [symbol] | 2.08-i0.05 | ◯ | ◯ |
| 2-4 | (Al₂O₃)₇₀(Cr₂O₃)₃₀ | ◯ | ◯ | ◯ | ◯ | [symbol] | 1.97-i0.03 | [symbol] | ◯ |
| 2-5 | (Al₂O₃)₈₀(Cr₂O₃)₂₀ | ◯ | ◯ | ◯ | X | ◯ | 1.87-i0.02 | [symbol] | ◯ |
| 2-6 | (Al₂O₃)₉₀(Cr₂O₃)₁₀ | ◯ | ◯ | X | X | Δ | 1.76-i0.01 | [symbol] | Δ |
| 2-7 | (Al₂O₃)₉₅(Cr₂O₃)₅ | ◯ | X | X | X | Δ | 1.71-i0.00 | [symbol] | Δ |
| Comparative | Al₂O₃ | X | X | X | X | X | 1.66-i0.00 | [symbol] | X |
| Example 2 | | | | | | | | | |
| Comparative | Cr₂O₃ | ◯ | ◯ | ◯ | ◯ | [symbol] | 2.70-i0.20 | X | X |
| Example 3 | | | | | | | | | |
| Comparative | (ZrO₂)₂₀(Cr₂O₃)₈₀ | ◯ | ◯ | ◯ | ◯ | [symbol] | 2.60-i0.13 | X | X |
| Example 4 | | | | | | | | | |

In this table, in each column of the standing time (hours) of the adhesion test, ∘ indicates that no peeling was observed, and x indicates that peeling was observed. The ratings x, Δ, ∘, and [symbol] in the evaluation column indicate that peeling occurred within 50 hours, no peeling occurred within 100 hours (but peeling occurred within 200 hours), no peeling occurred within 200 hours (but peeling occurred within 300 hours), and no peeling occurred for 300 hours or more, respectively. A sample in which no peeling occurs within 200 hours is good enough for practical use. A sample in which peeling occurs within less than 50 hours is not good enough for practical use. A sample in which no peeling occurs within 50 hours but peeling occurs within 200 hours can be used in indoor environments.

As shown in Table 2, in the sample of Comparative Example 2 in which only Al₂O₃ was used, peeling occurred within 50 hours, but in the sample in which 5 mol % of Cr₂O₃ was added to Al₂O₃, no peeling occurred within 50 hours, as shown in the result of the sample No, 2-7. In the samples No. 2-1 and No. 2-4 in which the content of Cr₂O₃ was 30 mol % or more, no peeling occurred within 300 hours. Thus, these samples were proved to have excellent adhesion. Based on the results shown in Table 2, it is preferable that the content of Cr₂O₃ be at least 5 mmol %, and more preferably at least 20 mol %.

As for the complex refractive index, since the interface layer 324 (dielectric layer a) is required to have high transparency, its extinction coefficient ka preferably is 0.07 or less, and more preferably 0.04 or less. The extinction coefficient of more than 0.1 is not preferable because the effect of increasing the Rc/Ra cannot be obtained. Accordingly, the ratings x, Δ, ∘, and [symbol] in the evaluation column indicate that 0.1<ka, 0.07<ka≦0.1, 0.04<ka≦0.07, and ka≦0.04, respectively.

As shown in this table, in the sample of Comparative Example 3 in which Cr₂O₃ was used and the sample of Comparative Example 4 in which (ZrO₂)₂₀(Cr₂O₃)₈₀ (mol %) was used, their ka values were more than 0.1, but in the samples in which the content of Al₂O₃ was 50 mol % or more, the ka values of 0.07 or less were obtained, as shown in the results of the samples No. 2-2 to No. 2-7. Furthermore, as shown in the results of the samples No. 2-4 to No. 2-7, when the content of Al₂O₃ was 70 mol % or more, the resulting ka values were 0.03 or less.

Comprehensive evaluation was conducted based on the results of the adhesion test and the complex refractive indices. The ratings x, Δ, and ∘ in the comprehensive evaluation column indicate that either the adhesion or the complex refractive index was rated x, either the adhesion or the complex refractive index was rated Δ, and both of the adhesion and the complex refractive index were rated ∘ or [symbol] , respectively. The compositions rated Δ or ∘ in the comprehensive evaluation can be used practically. The compositions rated ∘ are more preferable for the interface layer 324. The compositions rated x are not good enough for practical use. Accordingly, it is preferable that 50≦h<100 holds in (Al₂O₃)ₕ(Cr₂O₃)₁₀₀₋ₕ (mol %) (if a greater emphasis is placed on the evaluation of the complex refractive indices). More preferably, 50≦h≦80 holds.

### Example 3

In Example 3, the information recording medium 300 of FIG. 1 was produced, and the relationship between the materials for the interface layer 326 (dielectric layer b) of the second information layer 320 and the adhesion to the recording layer 325 was examined. The information recording medium 300 was produced in the same manner as in Example 2, except for the interface layer 324 and the interface layer 326. In order to examine the adhesion between the interface layer 326 and the recording layer 325 precisely, (ZrO₂)₅₀(Cr₂O₃)₅₀(mol %) having excellent adhesion to the recording layer 325 was used, on purpose, for the interface layer 324 corresponding to the dielectric layer a, and (ZrO₂)ⱼ(Cr₂O₃)₁₀₀₋ⱼ (mol %) was used for the interface layer 326. Both of the dielectric layers a and b had a thickness of 5 nm.

The interface layer 324 was formed by sputtering a (ZrO₂)₅₀(Cr₂O₃)₅₀ (mol %) target in an Ar gas atmosphere at a pressure of 0.13 Pa using a high frequency power supply with an output power of 3 kW.

The interface layers 326 were fabricated using the materials shown in the rows of medium samples No. 3-1 to No. 3-7 of Table 3. For the samples of Comparative Examples 5 and 6, the materials shown in Table 3 were used. These interface layers 326 were each formed by sputtering a sputtering target represented by the same composition formula as that of the interface layer 326 in an Ar gas atmosphere at a pressure of 0.13 Pa using a high frequency power supply with an output power of 3 kW. The interface layers 326 of Comparative Examples also were formed under the same sputtering conditions.

Also in the present example, the adhesion was evaluated according to the adhesion evaluation method in Example 1. The complex refractive indices also were calculated in the same manner as in Example 1.

Table 3 shows the results of the adhesion test and the complex refractive indices.

TABLE 3

| | Interface layer 326 | | | | | | | | |
|---|---|---|---|---|---|---|---|---|---|
| Medium | (Dielectric layer b) | Accelerated adhesion test | | | | | Complex refractive index | | Compre- |
| Sample | (AO₂)ⱼ(Cr₂O₃)₁₀₀₋ⱼ | Standing time (hours) at 85° C. and 85% | | | | | (wavelength of 40.5 nm) | | hensive |
| No. | (mol %) | 50 | 100 | 200 | 300 | Evaluation | nb-ikb | Evaluation | evaluation |
| 3-1 | (ZrO₂)₁₀(Cr₂O₃)₉₀ | ◯ | ◯ | ◯ | ◯ | [symbol] | 2.65-i0.15 | Δ | Δ |
| 3-2 | (ZrO₂)₂₀(Cr₂O₃)₈₀ | ◯ | ◯ | ◯ | ◯ | [symbol] | 2.60-i0.13 | Δ | Δ |
| 3-3 | (ZrO₂)₃₀(Cr₂O₃)₇₀ | ◯ | ◯ | ◯ | ◯ | [symbol] | 2.54-i0.11 | Δ | Δ |
| 3-4 | (ZrO₂)₄₀(Cr₂O₃)₆₀ | ◯ | ◯ | ◯ | ◯ | [symbol] | 2.49-i0.09 | ◯ | ◯ |
| 3-5 | (ZrO₂)₅₀(Cr₂O₃)₅₀ | ◯ | ◯ | ◯ | ◯ | [symbol] | 2.44-i0.07 | ◯ | ◯ |
| 3-6 | (ZrO₂)₆₀(Cr₂O₃)₄₀ | ◯ | ◯ | ◯ | X | ◯ | 2.39-i0.05 | [symbol] | ◯ |
| 3-7 | (ZrO₂)₇₀(Cr₂O₃)₃₀ | ◯ | ◯ | X | X | Δ | 2.34-i0.04 | [symbol] | Δ |
| Comparative | ZrO₂ | X | X | X | X | X | 2.18-i0.01 | [symbol] | X |
| Example 5 | | | | | | | | | |
| Comparative | Cr₂O₃ | ◯ | ◯ | ◯ | ◯ | [symbol] | 2.70-i0.20 | X | X |
| Example 6 | | | | | | | | | |

In this table, the definitions of the ratings x and ∘ in the standing time (hours) columns of the adhesion test and the ratings x, Δ, ∘, and [symbol] in the evaluation column of the adhesion test are the same as those in Example 2. As described also in Example 1, the interface layer 326 (dielectric layer b) has a slightly greater extinction coefficient than the interface layer 324 (dielectric layer a). Therefore, the definitions of the ratings of complex refractive indices are different from those in Example 2, and the ratings x, Δ, ∘, and [symbol] indicate 0.15<kb, 0.10<kb≦0.15, 0.05<kb≦0.10, and kb≦0.05, respectively. The definitions of the ratings x, Δ, and ∘ in the comprehensive evaluation are the same as those in Example 2.

As shown in this table, in the sample of Comparative Example 5 in which only ZrO₂ was used, peeling occurred within 50 hours, but in the sample in which 30 mol % of Cr₂O₃ was added to ZrO₂ so that the content of ZrO₂ was 70 mol %, no peeling occurred within 100 hours, as shown in the result of the sample No. 3-7, In the samples No. 3-1 to No. 3-5 in which the content of Cr₂O₃ was 50 mol % or more, no peeling occurred within 300 hours. Thus, these samples were proved to have excellent adhesion. It was confirmed that the content of ZrO₂ preferably is 70 mol % or less, and more preferably 60 mol % or less.

As for the complex refractive indices, the samples in which the content of ZrO₂ was 30 mol % or less had extinction coefficients k of more than 0.1, and thus were rated Δ.

Comprehensive evaluation was conducted based on the results of the adhesion test and the complex refractive indices. The samples in which the content of ZrO₂ was at least 10 mol % but not more than 70 mol % were rated Δ or ∘ in the comprehensive evaluation. Accordingly; it is preferable that 10≦j≦70 holds in (ZrO₂)ⱼ(Cr₂O₃)₁₀₀₋ⱼ (mol %).

### Example 4

In Example 4, the information recording medium 300 of FIG. 1 was produced, and the relationship between the materials for the interface layer 326 (dielectric layer b) of the second information layer 320 and the adhesion to the recording layer 325 was examined. The information recording medium 300 was produced in the same manner as in Example 3, except for the interface layer 326. (AO₂)ₚ(Cr₂O₂)ₜ(L)₁₀₀₋ₚ₋ₜ (mol %) was used for the interface layer 326. The thickness thereof was 5 nm.

The interface layers 326 were fabricated using the materials shown in the rows of medium samples No. 4-1 to No. 4-19 of Table 4. These interface layers 326 were each formed by sputtering a sputtering target represented by the same composition formula as that of the interface layer 326 in an Ar gas atmosphere at a pressure of 0.13 Pa using a high frequency power supply with an output power of 3 kW. Also in the present example, the adhesion was evaluated according to the adhesion evaluation method in Example 1. The complex refractive indices also were calculated in the same manner as in Example 1. Table 4 shows the results of the adhesion test and the complex refractive indices.

TABLE 4

| | Interface layer 326 | | | | | | | | |
|---|---|---|---|---|---|---|---|---|---|
| Medium | (Dielectric layer b) | Accelerated adhesion test | | | | | Complex refractive index | | Compre- |
| Sample | (AO₂)ₚ(Cr₂O₃)ₜ(L)₁₀₀₋ₚ₋ₜ | Standing time (hours) at 85° C. and 85% | | | | | (wavelength of 405 nm) | | hensive |
| No. | (mol %) | 50 | 100 | 200 | 300 | Evaluation | nb-ikb | Evaluation | evaluation |
| 4-1 | (ZrO₂)₂₀(Cr₂O₃)₇₅(TiO₂)₅ | ◯ | ◯ | ◯ | ◯ | [symbol] | 2.60-i0.12 | Δ | ◯ |
| 4-2 | (ZrO₂)₂₀(Cr₂O₃)₇₀(TiO₂)₁₀ | ◯ | ◯ | ◯ | ◯ | [symbol] | 2.59-i0.11 | Δ | ◯ |
| 4-3 | (ZrO₂)₂₀(Cr₂O₃)₄₀(TiO₂)₄₀ | ◯ | ◯ | ◯ | ◯ | [symbol] | 2.59-i0.06 | ◯ | ◯ |
| 4-4 | (ZrO₂)₃₀(Cr₂O₃)₆₀(TiO₂)₁₀ | ◯ | ◯ | ◯ | ◯ | [symbol] | 2.54-i0.09 | ◯ | ◯ |
| 4-5 | (ZrO₂)₃₀(Cr₂O₃)₃₀(TiO₂)₄₀ | ◯ | ◯ | ◯ | X | ◯ | 2.54-i0.04 | [symbol] | ◯ |
| 4-6 | (ZrO₂)₄₀(Cr₂O₃)₅₀(TiO₂)₁₀ | ◯ | ◯ | ◯ | ◯ | [symbol] | 2.49-i0.07 | ◯ | ◯ |
| 4-7 | (ZrO₂)₄₀(Cr₂O₃)₂₀(TiO₂)₄₀ | ◯ | ◯ | X | X | Δ | 2.48-i0.02 | [symbol] | ◯ |
| 4-8 | (ZrO₂)₅₀(Cr₂O₃)₄₀(TiO₂)₁₀ | ◯ | ◯ | ◯ | ◯ | [symbol] | 2.44-i0.06 | ◯ | ◯ |
| 4-9 | (ZrO₂)₅₀(Cr₂O₃)₂₀(TiO₂)₃₀ | ◯ | ◯ | X | X | Δ | 2.43-i0.02 | [symbol] | ◯ |
| 4-10 | (ZrO₂)₆₀(Cr₂O₃)₃₀(TiO₂)₁₀ | ◯ | ◯ | ◯ | X | ◯ | 2.39-i0.04 | [symbol] | ◯ |
| 4-11 | (ZrO₂)₆₀(Cr₂O₃)₂₀(TiO₂)₂₀ | ◯ | ◯ | X | X | Δ | 2.38-i0.02 | [symbol] | ◯ |
| 4-12 | (ZrO₂)₃₀(Cr₂O₃)₅₀(Al₂O₃)₂₀ | ◯ | ◯ | ◯ | ◯ | [symbol] | 2.34-i0.07 | ◯ | ◯ |
| 4-13 | (ZrO₂)₃₀(Cr₂O₃)₅₀(Dy₂O₃)₂₀ | ◯ | ◯ | ◯ | ◯ | [symbol] | 2.41-i0.07 | ◯ | ◯ |
| 4-14 | (ZrO₂)₃₀(Cr₂O₃)₅₀(Nb₂O₅)₂₀ | ◯ | ◯ | ◯ | ◯ | [symbol] | 2.51-i0.07 | ◯ | ◯ |
| 4-15 | (ZrO₂)₃₀(Cr₂O₃)₅₀(SiO₂)₂₀ | ◯ | ◯ | ◯ | ◯ | [symbol] | 2.30-i0.07 | ◯ | ◯ |
| 4-16 | (ZrO₂)₃₀(Cr₂O₃)₅₀(TiO₂)₂₀ | ◯ | ◯ | ◯ | ◯ | [symbol] | 2.54-i0.07 | ◯ | ◯ |
| 4-17 | (ZrO₂)₃₀(Cr₂O₃)₅₀(Y₂O₃)₂₀ | ◯ | ◯ | ◯ | ◯ | [symbol] | 2.39-i0.07 | ◯ | ◯ |
| 4-18 | (ZrO₂)₃₀(Cr₂O₃)₅₀(Al₅Si₂O₁₃)₂₀ | ◯ | ◯ | ◯ | ◯ | [symbol] | 2.32-i0.07 | ◯ | ◯ |
| 4-19 | (ZrO₂)₃₀(Cr₂O₃)₅₀(Al₂TiO₅)₂₀ | ◯ | ◯ | ◯ | ◯ | [symbol] | 2.44-i0.07 | ◯ | ◯ |

In this table, the definitions of the ratings x and ∘ in the standing time (hours) columns of the adhesion test and the ratings x, ∘, and [symbol] in the evaluation column of the adhesion test are the same as those in Example 3. The definitions of the ratings x, Δ, ∘, and [symbol] in the evaluation column of the complex refractive indices and the ratings x, Δ, and ∘ in the comprehensive evaluation column are the same as those in Example 3.

In medium samples No. 4-1 to No. 4-11, the materials having compositions represented by (ZrO₂)ₚ(Cr₂O₃)ₜ(TiO₂)₁₀₀₋ₚ₋ₜ (mol %) were used for the interface layers 326. In the medium samples No. 4-1 to No. 4-3, compositions corresponding to p=20, 40≦t≦75, and 60≦(p+t)≦95 were used. In the medium samples No. 4-4 and No. 4-5, compositions corresponding to p=30, 30≦t≦60, and 60≦(p+t)≦90 were used. In the medium samples No. 4-6 and No. 4-7, compositions corresponding to p=40, 20≦t≦50, and 60≦(p+t)≦90 were used. In the medium samples No. 4-8 and No. 4-9, compositions corresponding to p=50, 20≦t≦40, and 70≦(p+t)≦90 were used. In the medium samples No. 4-10 and No. 4-11, compositions corresponding to p=60, 20≦t≦30, and 80≦(p+t)≦90 were used.

In the medium samples No. 4-12 to No. 4-19, materials having compositions represented by (ZrO₂)₃₀(Cr₂O₃)₅₀(L)₂₀ (mol %), where L was Al₂O₃, Dy₂O₃, Nb₂O₅, SiO₂, TiO₂, Y₂O₃, Al₆Si₂O₁₃, and Al₂TiO₅, respectively, were used.

It was found from the results of the adhesion test of the medium samples No. 4-7, No. 4-9, and No. 4-9 that no peeling occurred within 100 hours when 20 mol % of Cr₂O₃ was contained. It was found from the results of the medium samples No. 4-5 and No. 4-10 that no peeling occurred within 200 hours when 30 mol % of Cr₂O₃ was contained. It was found from the results of the medium samples No. 4-3 and No. 4-8 that no peeling occurred within 300 hours when 40 mol % of Cr₂O₃ was contained. If the content of ZrO₂ is reduced by adding the oxide L, the adhesion is improved, and thus the content of Cr₂O₃ can be reduced. As a result, it becomes easier to achieve both a high adhesion and a low extinction coefficient. For example, the medium sample No. 3-7 in Example 3 was compared to the medium samples No. 4-5 and 4-10 of the present example. As a result, peeling occurred within 200 hours in the medium sample No. 3-7, while no peeling occurred within 200 hours in the medium samples No. 4-5 and No. 4-10, although all these medium samples had the same Cr₂O₃ content of 30 mol % and extinction coefficient of 0.04.

Furthermore, the results of the medium samples No. 4-12 to No. 4-19 showed that the materials having the compositions represented by (ZrO₂)₃₀(Cr₂O₃)₅₀(L)₂O (mol %), where the oxide L was Al₂O₃, Dy₂O₃, Nb₂O₅, SiO₂, TiO₂, Y₂O₃, Al₆Si₂O₁₃, and Al₂TiO₅, respectively, were rated a in the comprehensive evaluation.

It was confirmed from the results of the comprehensive evaluation in this example that p and t satisfied preferably 20≦p≦60, 20≦t<80, and 60≦(p+t)<100 in the compositions represented by (AO₂)ₚ(Cr₂O₃)ₜ(L)₁₀₀₋ₚ₋ₜ.

### Example 5

In Example 5, the information recording medium 300 of FIG. 1 was produced, and the optical properties and the recording/reproducing properties thereof were examined for the structures in which the materials for the interface layer 324 (dielectric layer a) in the second information layer 320 and the materials for the interface layer 326 (dielectric layer b) therein were used in combination to satisfy na<nb (where na was the refractive index of the dielectric layer a, and nb was the refractive index of the dielectric layer b). The information recording medium 300 was produced in the same manner as in Example 2, except for the interface layer 324 and the interface layer 326.

In the medium samples No. 5-1-1 to No. 5-1-15, the medium samples No. 5-2-1 to 5-2-3, the medium sample No. 5-3-1, the medium sample No, 5-4-1, and the medium samples No. 5-5-1 to No. 5-5-5 shown in Tables 5-1 to 5-5, the interface layers 324 and the interface layers 326 respectively were fabricated using the materials shown in these tables. In the samples of Comparative Examples 7 to 10, the materials shown in Table 5-6 were used for the interface layers 324 and the interface layers 326 respectively. These interface layers 324 and the interface layers 326 were each formed by sputtering a sputtering target represented by the same composition formula as that of the interface layer 324 or 326 in an Ar gas atmosphere at a pressure of 0.13 Pa using a high frequency power supply with an output power of 3 kW. Also in the samples of Comparative Examples 7 to 10, the interface layers 324 and 326 were formed under the same sputtering conditions. The material for the interface layer 324 and the material for the interface layer 326 in each medium sample are described below.

In the medium samples No. 5-1-1 to No. 5-1-9 shown in Table 5-1, (ZrO₂)₅₀(Cr₂O₃)₅₀ (mol %) was used for all the interface layers 326 but different materials were used for the interface layers 324. In the medium samples No. 5-1-1, and No. 5-1-10 to No. 5-1-15, (Al₂O₃)₈₀(Cr₂O₂)₂₀ was used for the interface layers 324 but different materials were used for the interface layers 326.

Specifically, in the medium samples No. 5-1-1 to No. 5-1-7, (ZrO₂)₅₀(Cr₂O₃)₅₀ (mol %) was used for the interface layers 326, and materials each containing 20 mol % of Cr₂O₃ and 80 mol % of at least one oxide D selected from Al₂O₃, Dy₂O₃, Nb₂O₅, SiO₂, TiO₂, and Y₂O₃ were used for the interface layers 324. In the medium samples No. 5-1-8 and No. 5-1-9, (ZrO₂)₅₀(Cr₂O₃)₅₀ (mol %) was used for the interface layers 326, and materials each in which a part of Cr₂O₃ in (Al₂O₃)₈₀(Cr₂O₃)₂₀ (mol %) was substituted by In₂O₃ or Ga₂O₃ were used.

In the medium samples No. 5-1-10 to No. 5-1-15, (Al₂O₃)₈₀(Cr₂O₃)₂₀ (mol %) was used for the interface layers 324, and materials each containing 25 mol % of ZrO₂, 50 mol % of Cr₂O₃, and 25 mol. % of at least one oxide L selected from Al₂O₃, Dy₂O₃, Nb₂O₅, SiO₂, TiO₂, and Y₂O₃ were used for the interface layers 326.

In the medium samples No. 5-2-1 to No. 5-2-3 shown in Table 5-2, (ZrO₂)₂₅(HfO₂)₂₅(Cr₂O₃)₅₀ (mol %) was used for the interface layers 326, and materials each in which a part of Cr₂O₃ in (Al₂O₃)ⱼ(Cr₂O₃)₁₀₀₋ⱼ (mol %) was substituted by Ga₂O₃ were used for the interface layers 324.

In the medium sample No. 5-3-1 shown in Table 5-3, (Al₆Si₂O₁₃)₈₀(Cr₂O₃)₂₀ (mol %) was used for the interface layer 324, and (ZrO₂)₂₅(Cr₂O₃)₅₀(Al₂TiO₅)₂₅ (mol %) was used for the interface layer 326.

In the medium sample No. 5-4-1 shown in Table 5-4, (Al₂O₃)₅₀(Cr₂O₃)₁₀(In₂O₃)₁₀ (mol %) was used for the interface layer 324, and (ZrO₂)₂₅(Cr₂O₃)₅₀(Al₂O₃)₂₅ (mol %) was used for the interface layer 326.

In the medium samples No. 5-5-1 to No. 5-5-5 shown in Table 5-5, (Al₂O₃)₇₀(Cr₂O₃)₃₀ (mol %) was used for the interface layers 324, and different materials were used for the interface layers 326. Specifically, in the medium sample No. 5-5-1, (Al₂O₃)₇₀(Cr₂O₃)₃₀ (mol %) was used for the interface layer 324, and (ZrO₂)₂₅(Cr₂O₃)₅₀(TiO₂)₂₅ (mol %) was used for the interface layer 326. In the medium samples No. 5-5-2 to No. 5-5-5, (Al₂O₃)₇₀(Cr₂O₃)₃₀ (mol %) was used for the interface layers 324, and materials each in which a part of Cr₂O₃ in (ZrO₂)₄₀(Cr₂O₃)₆₀ (mol %) was substituted by In₂O₃ or Ga₂O₃, or materials each in which a part of Cr₂O₃ in (ZrO₂)₃₀(Cr₂O₃)₅₀(L)₂₀ (mol %) was substituted by In₂O₃ or Ga₂O₃ were used for the interface layers 326.

In each of the medium samples No. 5-1-1 to No. 5-1-15, the medium samples No. 5-2-1 to 5-2-3, the medium sample No. 5-3-1, the medium sample No. 5-4-1, and the medium samples No. 5-5-1 to 5-5-5, combinations of the dielectric layer a and the dielectric layer bin the information recording medium of the present invention. Combinations that satisfied na<nb were used.

Next, the method of evaluating recording and reproduction with respect to the information recording medium 300 is described. For the evaluation of recording and reproduction, a recording/reproducing apparatus with a common configuration including a spindle motor for rotating the information recording medium 300, an optical head provided with a semiconductor laser that emits the laser beam 10, and an objective lens for focusing the laser beam 10 on the recording layer of the information recording medium 300 was used. In the present example, information was recorded on the recording layer 325 of the second information layer 320 in the information recording medium 300.

In the evaluation of the information recording medium 300, 33.4 GB-equivalent information was recorded using a 405 nm-wavelength semiconductor laser and an objective lens with a numerical aperture of 0.85. The recording was performed at a racial position of 40 mm under the condition of a linear velocity of 7.4 m/sec. The reproduction of the recorded signals was evaluated under the condition of a linear velocity of 7.4 m/sec under irradiation with a 1.0 mW laser beam.

The recording and reproduction were evaluated by measuring a carrier-to-noise ratio (CNR). First, the method of measuring the CNR is described. The laser beam 10 was applied to the information recording medium 300 while its power was being modulated between a recording power (high level power) (mW) and an erasing power (low level power) (mW). Thereby, a single signal of 3T (with a mark length of 0.168 μm) and a single signal of 8T (with a mark length of 0.446 μm) were recorded alternately 11 times in total on a groove surface. The waveform of the pulse used for recording was a multi-pulse waveform. After the 11th 3T signal was recorded, the amplitudes of the carrier (C) (dBm) and the noise (N) (dBm) were measured with a spectrum analyzer so as to obtain the CNR (dB) based on the difference therebetween.

When the CNR obtained after repeating alternate rewriting of the 3T signal and the 8T signal decreased by 3 (dB) from the CNR of the 11th recorded 3T signal, the number of rewritings at that time was defined as the repeated rewriting performance.

The adhesion was evaluated according to the adhesion evaluation method in Example 1. The criteria of the evaluation in the tables were as follows: the samples in which peeling occurred within 50 hours were rated x, the samples in which no peeling occurred within 50 hours (but peeling occurred within 200 hours) were rated Δ, and the samples in which no peeling occurred within 200 hours were rated ∘.

A medium for measurement including the substrate 301 (having not only the groove portions but also the mirror surface portions), and the second information layer 320 and the transparent layer 302 formed on the substrate 301 was prepared, and the reflectance ratio and the transmittance of that second information layer 320 were measured. Only half of the surface of the substrate 301 was initialized. The transmittance was measured with a spectrophotometer at a wavelength of 405 nm. Since the transmittance Tc (transmittance when the recording layer is in the crystalline phase) is lower than the transmittance Ta (transmittance when the recording layer is in the amorphous phase), the measurement values of only the Tc are shown in Table 5-1 to Table 5-6. The Rc of the initialized mirror surface portion and the Ra of the mirror surface portion on the boundary between the initialized area and the uninitialized area were measured using the recording/reproducing apparatus so as to obtain the reflectance ratio Rc/Ra (where Rc was the specular reflectance when the recording layer was in the crystalline phase, and Ra was the specular reflectance when the recording layer was in the amorphous phase).

Table 5-1 to Table 5-6 show the evaluation results of the Rc/Ra, Tc, adhesion, CNR, and repeated rewriting performance of each medium sample.

TABLE 5-1

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 5-1-1 | 324 | (Al₂O₃)₈₀(Cr₂O₃)₂₀ | 1.87-i0.02 | 7.05 | 0.93 | 7.6 | 50.3 | ◯ | 50.6 | 10000< | ◯ |
| | 326 | (ZrO₂)₅₀(Cr₂O₃)₆₀ | 2.44-i0.07 | | | | | | | | |
| 5-1-2 | 324 | (Dy₂O₃)₈₀(Cr₂O₃)₂₀ | 2.18-i0.03 | 6.83 | 0.96 | 7.1 | 49.5 | ◯ | 50.0 | 10000< | ◯ |
| | 326 | (ZrO₂)₅₀(Cr₂O₃)₆₀ | 2.44-i0.07 | | | | | | | | |
| 5-1-3 | 324 | (SiO₂)₈₀(Cr₂O₃)₂₀ | 1.72-i0.02 | 7.00 | 0.85 | 8.2 | 50.3 | ◯ | 51.3 | 10000< | ◯ |
| | 326 | (ZrO₂)₅₀(Cr₂O₃)₆₀ | 2.44-i0.07 | | | | | | | | |
| 5-1-4 | 324 | (Y₂O₃)₈₀(Cr₂O₃)₂₀ | 2.10-i0.03 | 6.91 | 0.95 | 7.3 | 49.6 | ◯ | 50.3 | 10000< | ◯ |
| | 326 | (ZrO₂)₅₀(Cr₂O₃)₆₀ | 2.44-i0.07 | | | | | | | | |
| 5-1-5 | 324 | (Al₆Si₂O₁₃)₈₀(Cr₂O₃)₂₀ | 1.81-i0.02 | 6.87 | 0.88 | 7.8 | 50.1 | ◯ | 50.8 | 10000< | ◯ |
| | 326 | (ZrO₂)₅₀(Cr₂O₃)₆₀ | 2.44-i0.07 | | | | | | | | |
| 5-1-6 | 324 | (Al₂TiO₆)₈₀(Cr₂O₃)₂₀ | 2.28-i0.03 | 6.96 | 0.99 | 7.0 | 49.0 | ◯ | 50.0 | 10000< | ◯ |
| | 326 | (ZrO₂)₅₀(Cr₂O₃)₆₀ | 2.44-i0.07 | | | | | | | | |
| 5-1-7 | 324 | (Al₂O₃)₄₀(Nb₂O₅)₄₀(Cr₂O₃)₂₀ | 2.21-i0.02 | 6.80 | 0.96 | 7.1 | 49.5 | ◯ | 50.0 | 10000< | ◯ |
| | 326 | (ZrO₂)₅₀(Cr₂O₃)₆₀ | 2.44-i0.07 | | | | | | | | |
| 5-1-8 | 324 | (Al₂O₃)₈₀(Cr₂O₃)₁₀(In₂O₃)₁₀ | 1.81-i0.01 | 7.11 | 0.91 | 7.8 | 50.4 | ◯ | 50.8 | 10000< | ◯ |
| | 326 | (ZrO₂)₅₀(Cr₂O₃)₆₀ | 2.44-i0.07 | | | | | | | | |
| 5-1-9 | 324 | (Al₂O₃)₈₀(Cr₂O₃)₁₀(Ga₂O₃)₁₀ | 1.79-i0.01 | 7.03 | 0.94 | 7.8 | 50.5 | ◯ | 50.8 | 10000< | ◯ |
| | 326 | (ZrO₂)₅₀(Cr₂O₃)₆₀ | 2.44-i0.07 | | | | | | | | |
| 5-1-10 | 324 | (Al₂O₃)₈₀(Cr₂O₃)₂₀ | 1.87-i0.02 | 6.94 | 0.93 | 7.5 | 50.2 | ◯ | 50.5 | 10000< | ◯ |
| | 326 | (ZrO₂)₂₅(Cr₂O₃)₆₀(Al₂O₃)₂₅ | 2.31-i0.06 | | | | | | | | |
| 5-1-11 | 324 | (Al₂O₃)₈₀(Cr₂O₃)₂₀ | 1.87-i0.02 | 7.07 | 0.96 | 7.4 | 49.3 | ◯ | 50.4 | 10000< | ◯ |
| | 326 | (ZrO₂)₂₅(Cr₂O₃)₆₀(SiO₂)₂₅ | 2.26-i0.07 | | | | | | | | |
| 5-1-12 | 324 | (Al₂O₃)₈₀(Cr₂O₃)₂₀ | 1.87-i0.02 | 6.85 | 0.90 | 7.6 | 49.4 | ◯ | 50.6 | 10000< | ◯ |
| | 326 | (ZrO₂)₂₅(Cr₂O₃)₆₀(Y₂O₃)₂₅ | 2.38-i0.07 | | | | | | | | |
| 5-1-13 | 324 | (Al₂O₃)₈₀(Cr₂O₃)₂₀ | 1.87-i0.02 | 7.10 | 0.91 | 7.6 | 49.5 | ◯ | 50.6 | 10000< | ◯ |
| | 326 | (ZrO₂)₂₅(Cr₂O₃)₆₀(Dy₂O₃)₂₅ | 2.41-i0.07 | | | | | | | | |
| 5-1-14 | 324 | (Al₂O₃)₈₀(Cr₂O₃)₂₀ | 1.87-i0.02 | 6.85 | 0.85 | 8.1 | 49.4 | ◯ | 51.2 | 10000< | ◯ |
| | 326 | (ZrO₂)₂₅(Cr₂O₃)₆₀(TiO₂)₂₅ | 2.57-i0.07 | | | | | | | | |
| 5-1-15 | 324 | (Al₂O₃)₈₀(Cr₂O₃)₂₀ | 1.87-i0.02 | 6.90 | 0.86 | 8.0 | 49.5 | ◯ | 51.0 | 10000< | ◯ |
| | 326 | (ZrO₂)₂₅(Cr₂O₃)₆₀(Nb₂O₅)₂₅ | 2.52-i0.07 | | | | | | | | |

TABLE 5-2

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 5-2-1 | 324 | (Al₂O₃)₈₀(Cr₂O₃)₁₀(Ga₂O₃)₁₀ | 1.79-i0.01 | 6.97 | 0.91 | 7.7 | 50.5 | ◯ | 50.8 | 10000< | ◯ |
| | 326 | (ZrO₂)₂₅(HfO₂)₂₅(Cr₂O₃)₅₀ | 2.43-i0.07 | | | | | | | | |
| 5-2-2 | 324 | (Al₂O₃)₇₀(Cr₂O₃)₁₀(Ga₂O₃)₂₀ | 1.82-i0.01 | 7.10 | 0.96 | 7.4 | 49.0 | ◯ | 50.4 | 10000< | ◯ |
| | 326 | (ZrO₂)₂₅(HfO₂)₂₅(Cr₂O₃)₅₀ | 2.43-i0.07 | | | | | | | | |
| 5-2-3 | 324 | (Al₂O₃)₆₀(Cr₂O₃)₁₀(Ga₂O₃)₃₀ | 1.85-i0.01 | 6.99 | 0.94 | 7.4 | 48.5 | ◯ | 50.4 | 10000< | ◯ |
| | 326 | (ZrO₂)₂₅(HfO₂)₂₅(Cr₂O₃)₅₀ | 2.43-i0.07 | | | | | | | | |

TABLE 5-3

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 5-3-1 | 324 | (Al₆Si₂O₁₃)₈₀(Cr₂O₃)₂₀ | 1.81-i0.02 | 6.96 | 0.92 | 7.6 | 50.1 | ◯ | 50.6 | 10000< | ◯ |
| | 326 | (ZrO₂)₂₆(Cr₂O₃)₅₀(Al₂TiO₅)₂₅ | 2.44-i0.07 | | | | | | | | |

TABLE 5-4

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 5-4-1 | 324 | (Al₂O₃)₈₀(Cr₂O₃)₁₀(In₂O₃)₁₀ | 1.81-i0.01 | 7.02 | 0.91 | 7.7 | 50.0 | ◯ | 50.8 | 10000< | ◯ |
| | 326 | (ZrO₂)₂₅(Cr₂O₃)₅₀(Al₂O₃)₂₅ | 2.31-i0.06 | | | | | | | | |

TABLE 5-5

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 5-5-1 | 324 | (Al₂O₃)₇₀(Cr₂O₃)₃₀ | 1.97-i0.03 | 6.95 | 0.93 | 7.5 | 50.3 | ◯ | 50.5 | 10000< | ◯ |
| | 326 | (ZrO₂)₂₅(Cr₂O₃)₅₀(TiO₂)₂₅ | 2.57-i0.07 | | | | | | | | |
| 5-5-2 | 324 | (Al₂O₃)₇₀(Cr₂O₃)₃₀ | 1.97-i0.03 | 7.06 | 0.97 | 7.3 | 49.1 | ◯ | 50.3 | 10000< | ◯ |
| | 326 | (ZrO₂)₄₀(Cr₂O₃)₄₀(In₂O₃)₂₀ | 2.38-i0.07 | | | | | | | | |
| 5-5-3 | 324 | (Al₂O₃)₇₀(Cr₂O₃)₃₀ | 1.97-i0.03 | 6.95 | 0.97 | 7.2 | 50.3 | ◯ | 50.1 | 10000< | ◯ |
| | 326 | (ZrO₂)₃₀(Cr₂O₃)₃₀(Al₂O₃)₂₀(In₂O₃)₂₀ | 2.22-i0.05 | | | | | | | | |
| 5-5-4 | 324 | (Al₂O₃)₇₀(Cr₂O₃)₃₀ | 1.97-i0.03 | 6.97 | 0.95 | 7.3 | 49.2 | ◯ | 50.3 | 10000< | ◯ |
| | 326 | (ZrO₂)₄₀(Cr₂O₃)₄₀(Ga₂O₃)₂₀ | 2.38-i0.07 | | | | | | | | |
| 5-5-5 | 324 | (Al₂O₃)₇₀(Cr₂O₃)₃₀ | 1.97-i0.03 | 6.88 | 0.96 | 7.2 | 51.0 | ◯ | 50.1 | 10000< | ◯ |
| | 326 | (ZrO₂)₃₀(Cr₂O₃)₃₀(Dy₂O₃)₂₀(Ga₂O₃)₂₀ | 2.26-i0.04 | | | | | | | | |

TABLE 5-6

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| Comparative | 324 | (ZrO₂)₅₀(Cr₂O₃)₅₀ | 2.44-i.0.07 | 7.02 | 1.35 | 5.2 | 48.6 | ◯ | 47.3 | 10000< | X |
| Example 7 | 326 | (ZrO₂)₅₀(Cr₂O₃)₅₀ | 2.44-i0.07 | | | | | | | | |
| Comparative | 324 | (Al₂O₃)₈₀(Cr₂O₃)₂₀ | 1.87-i0.02 | 7.04 | 0.93 | 7.6 | 50.4 | ◯ | 50.6 | 500 | X |
| Example 8 | 326 | (TiO₂)₈₀(Cr₂O₃)₂₀ | 2.69-i0.03 | | | | | | | | |
| Comparative | 324 | (ZrO₂)₅₀(Cr₂O₃)₅₀ | 2.44-i0.07 | 6.95 | 1.74 | 4.0 | 49.0 | ◯ | 45.0 | 1000 | X |
| Example 9 | 326 | (Al₂O₃)₈₀(Cr₂O₃)₂₀ | 1.87-i0.02 | | | | | | | | |
| Comparative | 324 | (Al₂O₃)₈₀(Cr₂O₃)₂₀ | 1.87-i0.02 | 7.08 | 1.00 | 7.1 | 50.1 | ◯ | 50.0 | 800 | X |
| Example 10 | 326 | (ZrO₂)₅₀(Ga₂O₃)₅₀ | 2.06-i0.01 | | | | | | | | |

Preferably, the reflectance ratio Rc/Ra is 7 or more as a target value at which the 3T CNR of 50 (dB) or more can be obtained (in the present example, the design value of Rc was determined to be 7%, but the Rc/Ra can be increased further as the design value is reduced to 6%, 5%, or less. Also in this case, the same advantageous effects of the present invention can be obtained). The transmittance Tc preferably is 46% or more as a target value. Since Ta of 48% or more can be obtained when Tc is 46% or more, 47%≦(Ta+Tc)/2 can be satisfied.

In all the samples shown in Table 5-1 to Table 5-5, the Rc/Ra values of 7 or more were obtained, and accordingly, 3T CNR values of 50 dB or more were obtained. The Tc values of 46% or more were obtained. As for the adhesion, no peeling occurred within 200 hours. As for the number of repeated rewritings, when the interface layers 326 containing Cr, O, and at least one element selected from Zr and Hf were used, excellent results of 10000 times or more were achieved.

The criteria of the comprehensive evaluation were as follows. The samples that satisfied all the conditions of Rc/Ra≧7, Tc≧46%, not peeled within 200 hours, and the number of repeated rewritings ≧10000 were rated ∘, the samples that satisfied at least one of the conditions of 5.6≦Rc/Ra<7, not peeled within 50 hours but peeled within 200 hours, and 1000≦the number of repeated rewritings<10000 were rated Δ, and the samples that satisfied at least one of the conditions of Rc/Ra<5.6, Tc<46%, peeled within 50 hours, and the number of repeated rewritings <1000 were rated x. As a result, all the samples shown in Table 5-1 to Table 5-5 were rated ∘ in the comprehensive evaluation.

In all the medium samples shown in Table 5-1 to Table 5-5, the recording power levels (through the third information layer 330) were about 23 mW, and the erasing power levels were about 7 mW.

A comparison between the interface layer 324 of the medium sample No. 5-1-1 and the interface layers 324 of the medium samples No. 5-1-8 and No. 5-1-9 showed that when a part of Cr₂O₃ was substituted by In₂O₃ or Ga₂O₃, the extinction coefficient decreased, which made the interface layer itself more transparent without degrading other performances.

In Comparative Example 7, since the interface layer 324 had a large extinction coefficient of 0.07 at na=nb, the Rc/Ra value was as small as 5.2. In Comparative Example 7, the 3T CNR value also was as low as 47.3 (dB).

In Comparative Example 8, the interface layer 326 was formed of the material containing Ti instead of at least one element selected from Zr and Hf. Therefore, the heat resistance was not high enough, which resulted in only 500 repeated rewritings. The medium of Comparative Example 8 satisfied na<nb and had high Rc/Ra and CNR, but unfortunately its heat resistance was not high enough and thus its repetition performance was poor.

On the other hand, in Comparative Example 9, na<nb was satisfied but the Rc/Ra value was as small as 4. In addition, since (Al₂O₃)₈₀(Cr₂O₃)₂₀ (mol %) was used for the interface layer 326, the heat resistance was not high enough, which resulted in only 1000 repeated rewritings. Likewise, in Comparative Example 10, since (ZrO₂)₅₀(Ga₂O₃)₅₀ was used for the interface layer 326, the heat resistance was not high enough, which resulted in only 800 repeated rewritings.

As is clear from the above results, when the materials for the dielectric layer a and the dielectric layer b that are the features of the information recording medium of the present invention were used in combination for the interface layers disposed in contact with the recording layer, the resulting information layer, particularly a translucent information layer in an information recording medium including three or more information layers, achieved higher performance than conventional information recording media.

### Example 6

In Example 6, the information recording medium 300 of FIG. 1 was produced in the same manner as in Example 5, and the optical properties and the recording/reproducing properties thereof were examined for the structures in which the materials for the interface layer 324 (dielectric layer a) in the second information layer 320 and the materials for the interface layer 326 (dielectric layer 17) therein were used in combination to satisfy na<nb (where na was the refractive index of the dielectric layer a, and nb was the refractive index of the dielectric layer b). The information recording medium 300 was produced in the same manner as in Example 5, except for the interface layer 324 and the interface layer 326.

In the medium samples No. 6-1 to No. 6-7 shown in Table 6, the interface layers 324 and the interface layers 326 were fabricated using the materials shown in this table. (Al₂O₃)₈₀(Cr₂O₃)₂₀ (mol %) was used for the interface layers 324, and (ZrO₂)ⱼ(Cr₂O₃)₁₀₀₋ⱼ (mol %) was used for the interface layers 326.

TABLE 6

| | | | | Substrate 301/Second | | | | Information recording medium 300 | | | |
|---|---|---|---|---|---|---|---|---|---|---|---|
| Medium | Inter- | | | information layer 320/ | | | | | | Number of | Compre- |
| Sample | face | | | Transparent layer 302 | | | | | CNR | repeated | hensive |
| No. | layer | Material (mol %) | n-ik | Rc(%) | Ra(%) | Rc/Ra | Tc(%) | Adhesion | (dB) | rewritings | evaluation |
| 6-1 | 324 | (Al₂O₃)₈₀(Cr₂O₃)₂₀ | 1.87-i0.02 | 6.96 | 0.83 | 8.4 | 45.1 | ◯ | 51.5 | 10000< | Δ |
| | 326 | (ZrO₂)₁₀(Cr₂O₃)₉₀ | 2.65-i0.15 | | | | | | | | |
| 6-2 | 324 | (Al₂O₃)₈₀(Cr₂O₃)₂₀ | 1.87-i0.02 | 6.89 | 0.86 | 8.0 | 46.0 | ◯ | 51.0 | 10000< | ◯ |
| | 326 | (ZrO₂)₂₀(Cr₂O₃)₈₀ | 2.60-i0.13 | | | | | | | | |
| 6-3 | 324 | (Al₂O₃)₈₀(Cr₂O₃)₂₀ | 1.87-i0.02 | 6.94 | 0.89 | 7.8 | 47.6 | ◯ | 50.8 | 10000< | ◯ |
| | 326 | (ZrO₂)₃₀(Cr₂O₃)₇₀ | 2.54-i0.11 | | | | | | | | |
| 6-4 | 324 | (Al₂O₃)₈₀(Cr₂O₃)₂₀ | 1.87-i0.02 | 7.00 | 0.91 | 7.7 | 48.9 | ◯ | 50.7 | 10000< | ◯ |
| | 326 | (ZrO₂)₄₀(Cr₂O₃)₆₀ | 2.49-i0.09 | | | | | | | | |
| 6-5 | 324 | (Al₂O₃)₈₀(Cr₂O₃)₂₀ | 1.87-i0.02 | 7.05 | 0.93 | 7.6 | 50.3 | ◯ | 50.6 | 10000< | ◯ |
| | 326 | (ZrO₂)₅₀(Cr₂O₃)₅₀ | 2.44-i0.07 | | | | | | | | |
| 6-6 | 324 | (Al₂O₃)₈₀(Cr₂O₃)₂₀ | 1.87-i0.02 | 6.98 | 0.92 | 7.6 | 51.0 | ◯ | 50.6 | 10000< | ◯ |
| | 326 | (ZrO₂)₆₀(Cr₂O₃)₄₀ | 2.39-i0.05 | | | | | | | | |
| 6-7 | 324 | (Al₂O₃)₈₀(Cr₂O₃)₂₀ | 1.87-i0.02 | 7.02 | 0.94 | 7.5 | 51.6 | Δ | 50.5 | 10000< | Δ |
| | 326 | (ZrO₂)₇₀(Cr₂O₃)₃₀ | 2.34-i0.04 | | | | | | | | |
| Comparative | 324 | Al₂O₃ | 1.66-i0.00 | 6.92 | 0.81 | 8.5 | 50.8 | X | 51.6 | 10000< | X |
| Example 11 | 326 | (ZrO₂)₅₀(Cr₂O₃)₅₀ | 2.44-i0.07 | | | | | | | | |
| Comparative | 324 | (Al₂O₃)₈₀(Cr₂O₃)₂₀ | 1.87-i0.02 | 6.85 | 0.98 | 7.0 | 53.2 | X | 50.0 | 10000< | X |
| Example 12 | 326 | ZrO₂ | 2.18-i0.01 | | | | | | | | |

The adhesion was rated according to the same criteria as those in Example 5. The comprehensive evaluation was conducted according to the same criteria as those in Example 5. As a result, the samples that satisfied 20≦j≦60 in the materials (ZrO₂)ⱼ(Cr₂O₃)₁₀₀₋ⱼ (mol %) for the interface layers 326 were rated a in the comprehensive evaluation, that is, higher performances were obtained.

A comparison between the results of Comparative Examples 11 and 12 and the results of the medium samples No. 6-1 to no. No. 6-7 showed that high adhesion could not be obtained unless the interface layer 324 and the interface layer 326 contained Cr₂O₃.

### Example 7

In Example 7, the information recording medium 300 of FIG. 1 was produced, and the materials for the dielectric layer a and the dielectric layer b of the present invention were used for all the interface layers included in the first information layer 310, the second information layer 320, and the third information layer 330.

In the present example, the medium sample was designed so that the first information layer 310 had an Rc of about 28%, the second information layer 320 had an Rc of about 6% and a (Tc+Ta)/2 of about 48%, and the third information layer 330 had an Rc of about 3% and a (Tc+Ta)/2 of about 59%.

In the first information layer 310, (Al₂O₃)₇₀(Cr₂O₃)₃₀(mol %) was used for the interface layer 314, and (ZrO₂)₉₅(Cr₂O₃)₅₀(SiO₂)₂₅ (mol %) was used for the interface layer 316. Both of the interface layers 314 and 316 were formed with a thickness of 5 nm. The materials and thicknesses of the layers other than these interface layers were the same as those in Example 5.

In the second information layer 320, (Al₂O₃)₈₀(Cr₂O₃)₂₀ (mol %) was used for the interface layer 324, and (ZrO₂)₂₅(Cr₂O₃)₅₀(SiO₂)₂₅ (mol %) was used for the interface layer 326. Both of the interface layers 324 and 326 were formed with a thickness of 5 nm. Furthermore, (ZnS)₈₀(SiO₂)₂₀ (mol %) was used to form the dielectric layer 327 with a thickness of 38 nm. The materials and thicknesses of the layers other than these interface layers and the dielectric layer were the same as those in Example 5.

In the third information layer 330, Bi₄Ti₃O₁₂ was used to form the dielectric layer 331 with a thickness of 18 nm. (Al₂O₃)₈₀(Cr₂O₃)₂₀ (mol %) was used for the interface layer 334, and (ZrO₂)₂₅(Cr₂O₃)₅₀(SiO₂)₂₅ (mol %) was used for the interface layer 336. Both of these interface layers were formed with a thickness of 5 nm. (Zns)₈₀(SiO₂)₂₀ (mol. %) was used to form the dielectric layer 337 with a thickness of 37 nm. The materials and thicknesses of the layers other than these interface layers and the dielectric layer were the same as those in Example 5.

Thus, the information recording medium of Example 7 was fabricated.

The reflectances (Rc and Ra), the reflectance ratio (Rc/Ra), the transmittances (Te and Ta), and the average transmittance ((Tc+Ta)/2) of each of the information layers of the information recording medium of the present example were measured, Media for measurement each including the substrate 301, and the information layer to be measured and the transparent layer 302 formed on the substrate 301 were prepared, and the measurement was performed in the same manner as in Example 5. Furthermore, the complex refractive indices of the interface layers of each information layer also were calculated in the same manner as in Example 1. Table 7-1 shows these results.

Furthermore, the effective Rc and the effective Ra of each information layer of the information recording medium of the present example were measured to obtain a ratio of the effective Rc to the effective Ra. For the measurement of the effective Rc and the effective Ra, a recording/reproducing apparatus provided with a 405 nm-wavelength semiconductor laser and an objective lens with a numerical aperture of 0.85 was used as in Example 5. The laser beam was brought to focus on the recording layer of the information layer to be measured of the information recording medium 300, and the effective Rc of the initialized mirror surface portion was measured and the effective Ra of the mirror surface portion on the boundary between the initialized area and the uninitialized area was measured. The effective Rc and the effective Ra of the first information layer 310 were obtained in the following manner. The first information layer 310 was irradiated with the laser beam 10 that had passed through the transparent layer 302, the third information layer 330, the interlayer 304, the second information layer 320, and the interlayer 303, and the reflected laser beam that had been reflected on the first information layer 310 and had passed through the interlayer 303, the second information layer 320, the interlayer 304, the third information layer 330, and the transparent layer 302 was detected. Thus, the effective Rc and the effective Ra of the first information layer 310 were obtained. Likewise, the second information layer 320 was irradiated with the laser beam that had passed through the transparent layer 302, the third information layer 330, and the interlayer 304, and the reflected laser beam that had been reflected on the second information layer 320 and had passed through the interlayer 304, the third information layer 330, and the transparent layer 302 was detected. Thus, the effective Rc and the effective Ra of the second information layer 320 were obtained. The third information layer 330 was irradiated with the laser beam that had passed through the transparent layer 302, and the reflected laser beam that had been reflected on the third information layer 330 and had passed through the transparent layer 302 was detected. Thus, the effective Rc and the effective Ra of the third information layer 330 were obtained.

The adhesion of the interface layers to the recording layer in each information layer, and the CNR and the number of repeated rewritings of each information layer were measured in the same manner as in Example 5. The comprehensive evaluation was conducted according to the same criteria as those in Example 5. Table 7-2 shows these results.

TABLE 7-1

| | Infor- | Inter- | | | Substrate 301/Each information layer/ | | | | | |
|---|---|---|---|---|---|---|---|---|---|---|
| Exam- | mation | face | | | Transparent layer 302 | | | | | |
| ple | layer | layer | Material (mol %) | n-ik | Rc(%) | Ra(%) | Rc/Ra | Tc(%) | Ta(%) | Tave(%) |
| 7 | 310 | 314 | (Al₂O₃)₇₀(Cr₂O₃)₃₀ | 1.97-i0.03 | 27.5 | 3.06 | 9.0 | 0.0 | 0.0 | 0.0 |
| | | 316 | (ZrO₂)₂₅(Cr₂O₃)₅₀(SiO₂)₂₅ | 2.26-i0.07 | | | | | | |
| | 320 | 324 | (Al₂O₃)₈₀(Cr₂O₃)₂₀ | 1.87-i0.02 | 6.43 | 0.56 | 11.5 | 47.0 | 49.5 | 48.3 |
| | | 326 | (ZrO₂)₂₅(Cr₂O₃)₅₀(SiO₂)₂₅ | 2.26-i0.07 | | | | | | |
| | 330 | 334 | (Al₂O₃)₈₀(Cr₂O₃)₂₀ | 1.87-i0.02 | 2.61 | <0.2 | 13< | 57.8 | 59.3 | 58.6 |
| | | 336 | (ZrO₂)₂₅(Cr₂O₃)₅₀(SiO₂)₂₅ | 2.26-i0.07 | | | | | | |

TABLE 7-2

| | | | | | Information recording medium 300 | | | | | | |
|---|---|---|---|---|---|---|---|---|---|---|---|
| | Infor- | Inter- | | | | | | | | Number of | Compre- |
| Exam- | mation | face | | | Effective | Effective | | | CNR | repeated | hensive |
| ple | layer | layer | Material (mol %) | n-ik | Rc(%) | Ra(%) | Rc/Ra | Adhesion | (dB) | rewritings | evaluation |
| 7 | 310 | 314 | (Al₂O₃)₇₀(Cr₂O₃)₃₀ | 1.97-i0.03 | 2.20 | 0.25 | 8.8 | ◯ | 53.0 | 10000< | ◯ |
| | | 316 | (ZrO₂)₂₅(Cr₂O₃)₅₀(SiO₂)₂₅ | 2.26-i0.07 | | | | | | | |
| | 320 | 324 | (Al₂O₃)₈₀(Cr₂O₃)₂₀ | 1.87-i0.02 | 2.21 | <0.2 | 11.5 | ◯ | 54.2 | 10000< | ◯ |
| | | 326 | (ZrO₂)₂₅(Cr₂O₃)₅₀(SiO₂)₂₅ | 2.26-i0.07 | | | | | | | |
| | 330 | 334 | (Al₂O₃)₈₀(Cr₂O₃)₂₀ | 1.87-i0.02 | 2.61 | <0.2 | 13< | ◯ | 54.5 | 10000< | ◯ |
| | | 336 | (ZrO₂)₂₅(Cr₂O₃)₅₀(SiO₂)₂₅ | 2.26-i0.07 | | | | | | | |

The effective Ra of the second information layer 320 and the effective Ra of the third information layer 330 were less than 0.2%, and their accurate values could not be measured due to unstable servo performance of an evaluation instrument.

When the reflectance Rc of the second information layer 320 was reduced to about 6%, the Rc/Ra exceeded 10. As a result of using the dielectric layer a and the dielectric layer b of the present invention for the interface layers of the first to third information layers 310 to 330, high reflectance ratios Rc/Ra, high transmittances, excellent adhesions, high CNR values, large numbers of repetitions of more than 10000 times were achieved. In particular, the Rc/Ra values of the translucent second information layer 320 and third information layer 330 were more than 11.

As has been described by way of various examples, according to the information recording medium of the present invention including the dielectric layer a having both high transparency and excellent adhesion to the recording layer and the dielectric layer b having both high heat resistance and excellent adhesion to the recording layer, a translucent information layer having a high reflectance ratio, a high transmittance, and high repeated rewriting performance was obtained. This translucent information layer makes it possible to obtain an information recording medium with a high capacity of 100 GB or more.

### INDUSTRIAL APPLICABILITY

The information recording medium of the present invention is, as a high-capacity optical information recording medium that is obtained by providing excellent dielectric layers, useful for rewritable multilayer Blu-ray discs, write-once multilayer Blu-ray discs, etc. The information recording medium of the present invention is, as a high-capacity optical information recording medium, useful for next generation rewritable information recording media or next generation rewritable multilayer information recording media in which recording and reproduction can be performed by means of an optical system with a NA of more than 1, such as SIL (Solid Immersion Lens), or SIM (Solid Immersion Mirror).

1. An information recording medium on or from which information can be recorded or reproduced by irradiation with an optical beam, the medium comprising a dielectric layer b, a recording layer, and a dielectric layer a in this order from an optical beam incident side, wherein
the dielectric layer a contains Cr, O, and at least one element M selected from Al, Dy, Nb, Si, Ti, and Y,
the dielectric layer b contains Cr, O, and at least one element A selected from Zr and Hf, and
the dielectric layer a and the dielectric layer b are disposed in contact with the recording layer.

2. The information recording medium according to claim 1, wherein the dielectric layer a contains a material, represented by the following formula:
M_{c}Cr_{d}O_{100-c-d} (atom %) (1)
where subscripts c, d, and 100-c-d denote composition ratios of M, Cr, and O in atom %, respectively, and c and d satisfy 12<c<40, 0<d≦25, and 20<(c+d)<50.

3. The information recording medium according to claim 1, wherein the element M is at least one element selected from Al, Si, and Ti.

4. The information recording medium according to claim 1, wherein a part of Cr contained in the dielectric layer a is substituted by at least one element selected from Ga and In.

5. The information recording medium according to claim 2, wherein the dielectric layer a contains a material composed of Cr₂O₃ and at least one oxide D selected from Al₂O₃, Dy₂O₃, Nb₂O₅, SiO₂, TiO₂, and Y₂O₃ and represented by the following formula:
(D)ₕ(Cr₂O₃)₁₀₀₋ₕ (mol %) (2)
where subscripts h and 100-h denote composition ratios of D and Cr₂O₃ in mol %, respectively, and h satisfies 50≦h<100.

6. The information recording medium according to claim 5, wherein the oxide D is at least one oxide selected from Al₂O₃, SiO₂, and TiO₂.

7. The information recording medium according to claim 5, wherein a part of Cr₂O₃ contained in the dielectric layer a is substituted by at least one oxide selected from Ga₂O₃ and In₂O₃.

8. The information recording medium according to claim 7, wherein a total content of Ga₂O₃ and In₂O₃ in the dielectric layer a is 30 mol % or less.

9. The information recording medium according to claim 1, wherein the dielectric layer b contains a material represented by the following formula:
A_{f}Cr_{g}O_{100-f-g} (atom %) (3)
where subscripts f, g, and 100-f-g denote composition ratios of A, Cr, and O in atom %, respectively, and f and g satisfy 4<f<16, 21<g<35, and 30<(f+g)<50.

10. The information recording medium according to claim 9, wherein the dielectric layer b contains a material composed of Cr₂O₃ and at least one oxide AO₂ selected from ZrO₂ and HfO₂ and represented by the following formula:
(AO₂)ⱼ(Cr₂O₃)₁₀₀₋ⱼ (mol %) (4)
where subscripts j and 100-j denote composition ratios of AO₂ and Cr₂O₃ in mol %, respectively, and j satisfies 20≦j≦60.

11. The information recording medium according to claim 9, wherein the dielectric layer b further contains at least one element X selected from Al, Dy, Nb, Si, Ti, and Y, and the material is represented by the following formula:
AₖCrₘXₙO₁₀₀₋ₘ₋ₙ (atom %) (5)
where subscripts k, m, n, and 100-k-m-n denote composition ratios of A, Cr, X, and O in atom %, respectively, and k, m, and n satisfy 1<k<18, 3<m<35, 0<n<31, and 25<(k+m+n)<50.

12. The information recording medium according to claim 11, wherein the element X is at least one element selected from Al, Dy, Si, and Ti.

13. The information recording medium according to claim 1, wherein a part of Cr contained in the dielectric layer b is substituted by at least one element selected from Ga and In.

14. The information recording medium according to claim 10, wherein the dielectric layer b further contains at least one oxide L selected from Al₂O₃, Dy₂O₃, Nb₂O₅, SiO₂, TiO₂, and Y₂O₃, and the material is represented by the following formula:
(AO₂)ₚ(Cr₂O₃)ₜ(L)₁₀₀₋ₚ₋ₜ (mol %) (6)
where subscripts p, t, and 100-p-t denote composition ratios of AO₂, Cr₂O₃, and L in mol %, respectively, and p and t satisfy 20≦p≦60, 20≦t<80, and 60≦(p+t)<100.

15. The information recording medium according to claim 1, wherein the element A is Zr.

16. The information recording medium according to claim 14, wherein the ode L is at least one oxide selected from Al₂O₃, Dy₂O₃, SiO₂ and TiO₂.

17. The information recording medium according to claim 10, wherein a part of Cr₂O₃ contained in the dielectric layer b is substituted by at least one oxide selected from Ga₂O₃ and In₂O₃.

18. The information recording medium according to claim 17, wherein a total content of Ga₂O₃ and In₂O₃ in the dielectric layer b is 20 mol % or less.

19. The information recording medium according to claim 1, wherein when a refractive index of the dielectric layer a and a refractive index of the dielectric layer b are denoted as na and nb respectively, na<nb holds.

20. The information recording medium according to claim 1, comprising N information layers, where N is an integer of 2 or more, wherein
when the N information layers are referred to as a first information layer to an N-th information layer sequentially from a side opposite to the optical beam incident side, an L-th information layer (where L is at least one integer that satisfies 1≦L≦N) included in the N information layers includes the dielectric layer b, the recording layer, and the dielectric layer a in this order from the optical beam incident side.

21. The information recording medium according to claim 20, wherein the N is 3.

22. The information recording medium according to claim 1, wherein the recording layer is formed of a material that undergoes a phase change by irradiation with the optical beam.

23. The information recording medium according to claim 22, wherein the recording layer contains Ge—Te, and contains 40 atom % or more of Ge.

24. The information recording medium according to claim 22, wherein the recording layer contains at least one material selected from Sb—Ge and Sb—Te, and contains 70 atom % or more of Sb.
